(19) United States
(12) Patent Application Publication
(10) Pub. No.: US 2024/0183961 A1
(43) Pub. Date: Jun. 6, 2024

(54) PREDICTIVE MAINTENANCE LIDAR

(71) Applicant: OSRAM GmbH, Munich (DE)

(72) Inventors: Bernhard SIESSEGGER, Unterschleissheim (DE); Gerhard Maierbacher, Munich (DE)

(21) Appl. No.: 18/554,798

(22) PCT Filed: Mar. 28, 2022
(86) PCT No.: PCT/EP2022/058124

§ 371 Date: Oct. 11, 2023

(30) Foreign Application Priority Data
Apr. 13, 2021 (DE) 10 2021 109 178.0

(51) Int. Cl. G01S 7/497

(52) U.S. Cl. CPC G01S 7/497

(57) ABSTRACT

According to various aspects a LIDAR module is provided, the LIDAR module including: one or more processors configured to: determine an estimate of a remaining lifetime of the LIDAR module as a function of aging data representative of aging events associated with one or more components of the LIDAR module.

### RELATED APPLICATION(S)

This application is a US National This application is Stage Application of International Application PCT/EP2022/058124, filed on 28 Mar. 2022, and claims priority under 35 U.S.C. § 119 (a) and 35 U.S.C. § 365 (b) from German Application 10 2021 109 178.0, filed on 13 Apr. 2021, the contents of which are incorporated herein by reference in their entirety.

### FIELD

This present disclosure relates to LIDAR (“Light Detection and Ranging”) modules and methods thereof.

### BACKGROUND

Light detection and ranging is a sensing technique that is used, for example, in the field of autonomous driving for providing detailed information about the surrounding of an automated or partially automated vehicle. Light is used to scan a scene and determine the properties (e.g., the location, the speed, the direction of motion, and the like) of the objects present therein. A LIDAR system typically uses the time-of-flight (ToF) of the emitted light to measure the distance to an object. In general, a LIDAR system is designed with the aim of ensuring that the system can continue to function for a desired lifetime period even under the most severe operating conditions. This aim results in an overdesigned system (illustratively, a system with an over-conservative design), in particular considering the (non-severe) typical operating conditions in which the vast majority of customers actually makes use of the product. Thus, in view of the overdesign considerations, the vast majority of customers pay a higher price for the product compared to the price that the product may have if designed for typical operating conditions.

Various aspects are related to a predictive maintenance strategy based on the (e.g., periodic or on-demand) evaluation of a remaining lifetime of a LIDAR module (e.g., of one or more of its components) to assist in determining when or how to intervene for repairing (or replacing) the LIDAR module. The predictive maintenance described herein eliminates the need for an “a priori” overly conservative design of the LIDAR module, providing instead a dynamic monitoring of a state of the module (and its components), which allows a timely implementation of corrective measures to prevent the risk of failures. The remaining lifetime of the LIDAR module may be estimated based on the occurrences of aging events affecting the LIDAR module (e.g., affecting its components), thus providing a simple approach for monitoring the wearing of the module.

Despite of the fact that a LIDAR system is typically a highly complex system, the customers demand low cost and long lifetime, which leads to trade-offs being made when designing a LIDAR system with a conventional approach. Various aspects described herein are based on providing an understanding of how a LIDAR system has been used in the past (a usage analysis), and how it is used right now (monitoring), thus enabling a (complete) system, sub-system, or component exchange before system failure (predictive maintenance). The strategy described herein may provide estimating the remaining system/product life, and in some aspects also a prediction of which component or sub-system will fail first. The approach described herein allows to reduce design costs, while ensuring a low number of failures in the field and thus a high customer satisfaction.

The term “lifetime” may be understood as commonly used in the art, e.g. to describe a period of time over which a module (e.g., a LIDAR module) 4 component of a module may operate at a satisfactory performance level, illustratively at a performance level that fulfills one or more predefined conditions. By way of example, a satisfactory performance level may include a power of emitted light in a target power range, a detection of received light in a target sensitivity range, a scanning speed of a field of view in a target scanning speed range, and the like. Illustratively, the term “lifetime” may describe the period of time for which a module or component may be used to successfully carry out the operation for which it is designed. It is understood that the definition of a target performance for a module or component may be arbitrary, and thus the definition of “lifetime” may vary depending on the circumstances in which a module or component operates (e.g., a light source operated to emit light pulses in a narrow power range may have a reduced lifetime compared to the same light source operated to emit light pulses in a broader power range, in view of the stricter requirements in the former scenario). The product's life may be deemed to be over when the product doesn't provide its functionality with an acceptable performance (any more). In case of a LIDAR module, for example, the ranging functionality may require a minimal accuracy, in a minimal (e.g., specified) field of view and a minimal range (illustratively, a minimal distance between module and objects). The term “remaining lifetime” may be used herein to describe a determined (e.g., predicted, calculated, or estimated) period of time left in which the module or component can continue to operate at the respective satisfactory performance level.

The term “failure” may be used herein to describe a condition in which a module or a component is no longer capable of performing the operation for which it was designed. In some aspects, the term “failure” may be used to describe a hard failure, e.g. a condition in which the module or component has (completely) stopped working, e.g. a condition in which a replacement of the entire module or component may be provided. In some aspects, the term “failure” may be used to describe a soft failure, e.g. a condition in which a performance of the module or component has degraded but the module or component is still working, e.g. a condition in which the module or component may still perform its function but at a reduced performance level (for example, below a satisfactory performance level). As an example, a soft failure of a LIDAR module may include the LIDAR module being capable of detecting objects only within a range that is less than the range for which the LIDAR module was designed, e.g. only within 75% of the range or 50% of the range (for example due to a degradation of the laser diodes).

The term “LIDAR module” may be used herein to describe a device configured for LIDAR applications. A “LIDAR module” as used herein may be configured to carry out monitoring of a scene based on a LIDAR approach. A “module” may be understood as an entity including a plurality of parts (e.g., a plurality of components) that together define the function of the module. Illustratively, a module may be understood as an entity configured to carry out a complex function that requires the contribution of a plurality of parts interacting together. A “LIDAR module” may also be referred to herein as “LIDAR system”, “LIDAR product”, or simply “system” or “product”.

A “component” of a LIDAR module (also referred to herein as “element” of a LIDAR module) may be understood as a single part that individually contributes to the operation of a larger entity (e.g., of a module). A component may be understood as a single part configured to carry out a simple (e.g., general purpose) function, e.g. with a limited scope. A component may itself include a plurality of components (sub-elements, or sub-components) that provide the simple function of the component. A component including a plurality of sub-components may be understood as a sub-module (also referred to herein sub-system), e.g. configured to implement a more complex functionality compared to an individual component (via the interaction of the sub-components). As an example, a component may be an array of laser diodes, and the individual laser diodes may be the sub-components of the array. As another example, a laser diode itself may be understood as a component, and the individual parts forming the laser diode (e.g., a semiconductor substrate, the electrical connections, etc.) may be understood as sub-components of the laser diode. In the following, references to a sub-system or sub-module may be understood to apply to a component including a plurality of sub-components.

The term “aging event” may be used herein to describe an event that causes a wearing of a module or component. An “aging event” may describe the occurrence of a condition that has an impact on the lifetime of the module or component. Illustratively, an “aging event” may be understood as an event or condition that increases (e.g., accelerates) the aging of the module or component, e.g. an event or condition that may reduce a remaining lifetime of the module or component. In some aspects, an “aging event” may be associated with an “aging factor” and/or with an “aging mechanism”. An “aging mechanism” may describe a process leading to a degradation of the performance of a module or component. An “aging factor” as used herein may describe a parameter relevant for one or more aging mechanisms associated with a module or component. Illustratively, an aging factor may describe a quantity that directly or indirectly influences the aging of the module or component by leading to the progression of one or more of the associated aging mechanisms. As an illustrative example, an aging mechanism for a photo diode may be the deterioration of the processes inside the semiconductor, an aging factor may be the temperature at which the photo diode operates (which influences the deterioration, e.g. the speed of the deterioration), and an aging event may be a light pulse received with the photo diode at a certain temperature.

Two basic types of aging mechanisms for a component (and/or for a module) may be distinguished. A first type of aging mechanism may include the continuous degradation of the component, so that under the same operating conditions the component parameters (illustratively, its performance) slowly drift or change. The rate at which the degradation occurs may be strongly impacted by the operating conditions. A second type of aging mechanism may lead to a catastrophic failure (a hard failure) of the component, for example the breaking of a mechanical axle, which results in the component not performing its function at all anymore and thereby rendering the component and often the entire system, like the car in case of the broken axle, unusable from that moment on. Depending on the type and the structure of a component, one or more (e.g., multiple) aging mechanisms of the first type and in addition one or more (e.g., several other) aging mechanisms of the second type may be considered for estimating the overall lifetime or remaining lifetime of the overall product.

Both the first type and the second type of aging mechanism may show a statistical distribution. Not every component (of a same type) degrade with the same rate (in case of the first type of aging mechanism), nor do all components (of the same type) break at the same time (in case of the second type of aging mechanism). A spread of aging-impacted parameters over the individual components occurs. In case aging has been properly analyzed before fabrication of an individual component, sub-system or module (e.g., by the research and development team) and aging mechanisms are properly selected, then aging mechanisms may be considered (in very good approximation) to be independent of one other.

As an example, three (most relevant) aging mechanisms may be identified for the aging of a laser diode in a LIDAR module. A first aging mechanism may include the aging of the die, i.e. the aging of processes inside the semiconductor. This is an aging of the first type, and may lead to gradual changes in forward voltage and light output. The change in forward voltage may be neglected, as the driver and power electronics may be able to compensate it, if designed properly. The change in light output may be relevant for the operation of the LIDAR module, as may lead to a continuous reduction of laser light output. The rate of degradation may increase with increasing operating temperature and pulse current amplitude. A second aging mechanism may include the aging of the optical components (e.g., lens material, package material, and compound material) of the laser diode. This may be an aging of the first type, and may lead to the optical components absorbing more and more light with aging, also causing a reduction in laser light output. The rate of degradation may increase with increasing (storage) temperature. A third aging mechanism may include the aging of the electrical connections between the die and the outer contacts of the package (pins). This may be an aging of the second type. Even though there may be more than one electrical connection, primarily the bond wire itself or the bond connections may break thereby rendering the entire laser diode non-functional. The main (aging) factors that may impact the aging of the electrical connections may be the number of temperature cycles and the magnitude of the temperature cycles (e.g., the amount of temperature swings, the magnitude of temperature delta).

Further aging mechanisms and aging factors associated with a LIDAR module and with one or more components of the LIDAR module will be described in further detail below, e.g. in relation to FIG. 1A and FIG. 1B. It is understood that the aging mechanisms, aging factors, and aging events described herein are exemplary to illustrate the principles of the predictive maintenance strategy, and additional, less, or alternative aging mechanisms, factors, and events may be considered to determine the remaining lifetime of a module or component.

In various aspects, as described in further detail below, a model for at least one (e.g., each) relevant aging mechanism, including its distribution type (Gaussian, etc.), and the parameters defining the distribution (e.g., mean and variance in case of a Gaussian distribution) may be included in one or more processors of a LIDAR module (e.g., in the software of a control circuit of the LIDAR module). As the operating conditions may depend on the use by the customer, a large variation in operating conditions may be considered. This may include taking into account a number of a wide range of operating different aging mechanisms over conditions.

According to various aspects, a LIDAR module may include: one or more processors configured to: determine an estimate of a remaining lifetime of the LIDAR module based on aging data representative of aging events associated with one or more components of the LIDAR module. In various aspects, the one or more processors may be further configured to provide a message indicative of the estimated remaining lifetime of the LIDAR module. In various aspects, the one or more processors may be further configured, additionally or alternatively, to provide a message indicative of the estimated remaining lifetime of the LIDAR module falling below a predefined threshold (illustratively, a warn signal to prompt maintenance of the LIDAR module).

According to various aspects, a method of estimating a remaining lifetime of a LIDAR module may be provided, the method including: estimating a remaining lifetime of the LIDAR module based on aging data representative of aging events associated with one or more components of the LIDAR module. In various aspects, the method may further include providing a message indicative of the estimated remaining lifetime of the LIDAR module. In some aspects, the method may be a computer-implemented method. In various aspects, the method may further include, additionally or alternatively, providing a message indicative of the estimated remaining lifetime of the LIDAR module falling below a predefined threshold.

According to various aspects, a LIDAR module may include: a memory storing data representative of the occurrences of an event associated with an aging mechanism of a component of the LIDAR module.

Various aspects may be related to a strategy for recording aging events affecting a LIDAR module (and/or its components). The recording strategy described herein may provide accumulating information suitable for the estimation of the remaining lifetime of the LIDAR module, without an excessive occupation of memory space. The strategy is based on a so-called “bucket approach”, which will be described in further detail below (see for example FIG. 3A to FIG. 3G).

According to various aspects, a LIDAR module may include: one or more processors configured to: receive an indication that an aging event associated with a component of the LIDAR module has occurred, the aging event being related to a first aging mechanism of one or more aging mechanisms associated with the component; update (e.g., increase or decrease) a counter value associated with the first aging mechanism; and estimate a remaining lifetime of the component based on the counter values associated with the one or more aging mechanisms associated with the component.

In the context of the present description, reference may be made to implementations for automotive applications (e.g., in case the LIDAR module is installed or to be installed in a vehicle). The approach described herein may provide a reliable operation of a LIDAR module for use in an at least partially autonomous vehicle. It is however understood that the applications of a LIDAR module are not limited to the automotive context, and a LIDAR module may be applied in other applications and markets such as professional, industrial, consumer, etc.

The term “processor” as used herein may be understood as any kind of technological entity that allows handling of data. The data may be handled according to one or more specific functions executed by the processor. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor or logic circuit. It is understood that any two (or more) of the processors or logic circuits detailed herein may be realized as a single entity with equivalent functionality or the like, and conversely that any single processor or logic circuit detailed herein may be realized as two (or more) separate entities with equivalent functionality or the like.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). The term “calculate” as used herein encompasses both ‘direct’ calculation via a mathematical expression/formula/relationship and ‘indirect’ calculation via lookup or hash tables and other array indexing or searching operations.

As used herein, “memory” or “memory device” is understood as a computer-readable medium (e.g., a non-transitory computer-readable medium) in which data or information can be stored for retrieval. References to “memory” or “memory device” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, may also be embraced herein by the term “memory” or “memory device”. The term “software” refers to any type of executable instruction, including firmware.

The term “optical power” may be used herein to describe the power (in Watts) flowing into an optical component (in other words, an optical element). The term “irradiation” may be used herein to describe the optical power per (in Watts/m²). Depending on the optical element some (hopefully the very most, e.g. more than 50%, more than 758, or more than 90%) of the power may leave the optical element (either in the same direction as it came into the element (reflection) or in other directions) and the remainder of the power may be absorbed inside the optical element.

The term “throttling” may be used herein to describe a controlled reduction of the performance of a module or component. “Throttling” may be understood as intentionally controlling a module or component in such a way that it operates not at its full capability. In some aspects, “throttling” may include controlling the module or component in such a way that a maximum achievable output is not provided, but rather the output is intentionally kept at a lower output level (e.g., a light pulse is emitted at a lower power, a field of view is scanned at a lower scanning speed, and the like).

### BRIEF DESCRIPTION OF THE DRAWINGS

In the drawings, like reference characters generally refer to the same parts throughout the different views. The drawings are not necessarily to scale, emphasis instead generally being placed upon illustrating the principles disclosed herein. In the following description, various aspects disclosed herein are described with reference to the following drawings, in which:

FIG. 1A and FIG. 1B each shows a LIDAR module in a schematic view according to various aspects;

FIG. 2A shows beam steering stage for use in a LIDAR module in a schematic view according to various aspects;

FIG. 2B to FIG. 2G each shows a liquid crystal polarization grating in a schematic view according to various aspects;

FIG. 3A shows a memory portion associated with a component of a LIDAR module in a schematic view according to various aspects;

FIG. 3B shows a memory portion associated with a component of a LIDAR module in a schematic view according to various aspects;

FIG. 3C and FIG. 3D each shows a respective graph illustrating the division of an intensity range for an aging factor;

FIG. 3E shows a plurality of memory portions associated with a component of a LIDAR module in a schematic view according to various aspects;

FIG. 3F shows a plurality of memory portions associated with a laser diode in a schematic view according to various aspects;

FIG. 3G shows a memory portion associated with a laser diode in a schematic view according to various aspects;

FIG. 4 (represented as FIG. 4A and FIG. 4B) shows a plurality of memory portions associated with a component of a LIDAR module in a schematic view according to various aspects;

FIG. 5A, FIG. 5B, and FIG. 50 each shows a memory block in a schematic view according to various aspects;

FIG. 5D, FIG. 5E, and FIG. 5F each shows a memory block of a first type and a memory block of a second type in a schematic view according to various aspects;

FIG. 5G, FIG. 5H, and FIG. 5I each shows a memory block of a first memory type, a memory block of a second memory type, and a memory block of a third memory type in a schematic view according to various aspects;

FIG. 6 shows a memory portion in a schematic view according to various aspects;

FIG. 7A shows respective memory portions associated with an optical component of a LIDAR module;

FIG. 7B, shows a look-up table associated with an optical component of a LIDAR module;

FIG. 7C, shows a plurality of memory portions associated with an optical component of a LIDAR module;

FIG. 7D (represented as FIG. 7DA, FIG. 7DB, and FIG. 7DC), shows an updating of the content of a memory sub-portion in a schematic view according to various aspects;

FIG. 8 shows a subsampling process for the recording of aging events in a schematic view according to various aspects;

FIG. 9A shows a graph related to the remaining lifetime associated with an aging aspect according to various aspects;

FIG. 9B shows a graph related to a correction factor for an aging aspect according to various aspects;

FIG. 9C shows a graph related to the remaining lifetime associated with an aging aspect according to various aspects;

FIG. 9D shows a graph related to different linear extrapolations of the remaining lifetime; and

FIG. 10A and FIG. 10B each shows a respective graph illustrating a smart derating functionality according to various aspects.

### DETAILED DESCRIPTION

The following detailed description refers to the accompanying drawings that show, by way of illustration, specific details and implementations in which the aspects disclosed herein may be practiced. These aspects are described in sufficient detail to enable those skilled in the art to practice the disclosed implementations. Other aspects may be utilized and structural, logical, and electrical changes may be made without departing from the scope of the disclosed implementations. The various aspects are not necessarily mutually exclusive, as some aspects may be combined with one or more other aspects to form new aspects. Various aspects are described in connection with methods and various aspects are described in connection with devices (e.g., a LIDAR module, one or more processors, a component of a LIDAR module, etc.). However, it is understood that aspects described in connection with methods may similarly apply to the devices, and vice versa.

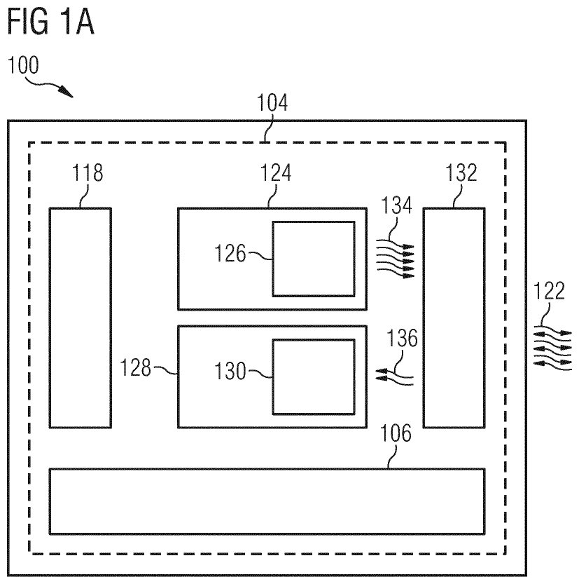

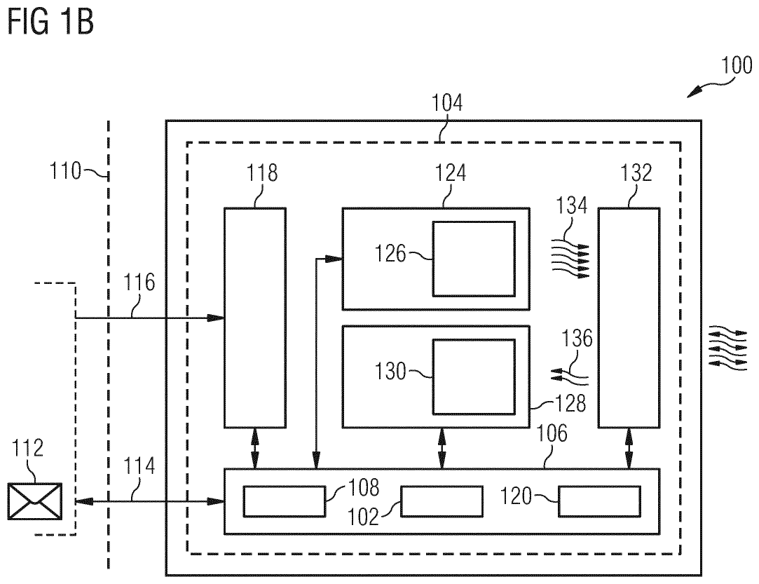

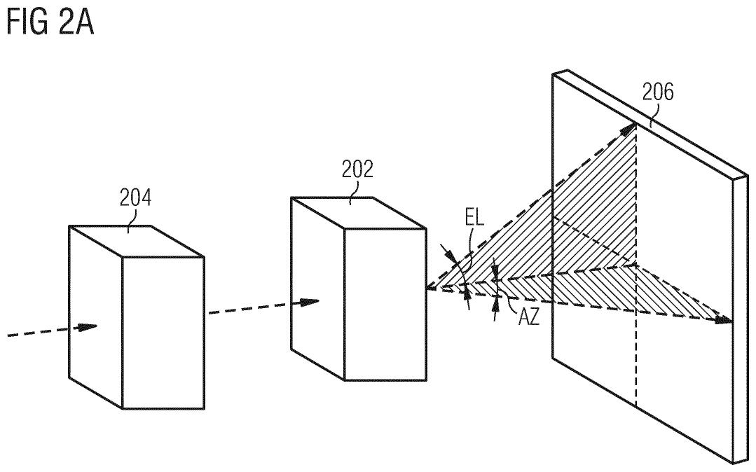

FIG. 1A and FIG. 1B each shows a LIDAR module 100 in a schematic view according to various aspects. As an example, a vehicle (e.g., an at least partially automated vehicle, for example an electric car) may include one or more LIDAR modules 100. As another example, a smart farming or an indoor monitoring system may include one or more LIDAR modules 100.

In some aspects, the LIDAR module 100 may be a solid state LIDAR module, e.g. a Flash LIDAR or a Non-Flash LIDAR. In other aspects, the LIDAR module may include mechanically moving parts. The LIDAR module 100 may be a direct time-of-flight or an indirect time-of-flight LIDAR module.

The LIDAR module 100 may include one or more processors 102 (see FIG. 1B) configured to control an operation of the LIDAR module 100. The one or more processors 102 may be configured to manage exchange of data from and to the LIDAR module 100. The one or more processors 102 may be configured to provide instructions to one or more (other) components 104 of the LIDAR module 100, to control an operation thereof. In various aspects, the one or more processors 102 may be understood as part of a control circuit 106 (also referred to as control unit) of the LIDAR module 100.

The one or more components 104 of the LIDAR module 100 may be configured to enable the operation of the LIDAR module 100, e.g. may be configured to enable the monitoring of a scene (e.g., an environment surrounding a vehicle). The one or more components 104 may include one or more sensing systems configured to provide an understanding of the scene, e.g. data describing the scene. By way of example, the LIDAR module 100 may include a light-based sensing system, as shown in FIG. 1A and FIG. 1B, and as described in further detail below. As other examples (not shown), the LIDAR module 100 may include a brightness sensor, a presence sensor, an optical camera, a RADAR sensing system, and an ultrasonic sensing system. In various aspects, the one or more processors 102 may be configured to process the data provided by the sensor(s) and/or sensing system(s) of the LIDAR module 100 to analyze the scene (e.g., the field of view of the LIDAR module 100). The one or more processors 102 may be configured to carry out object recognition, object tracking, and/or object classification based on the received data, to analyze the object(s) present in the monitored scene. It is understood that the one or more components 104 described herein in relation to the LIDAR module 100 are exemplary. It is also understood that the LIDAR module 100 may include additional, less, or alternative components with respect to those shown.

The LIDAR module 100 (e.g., the one or more components 104) may include one or more actuators for adjusting the environmental surveillance conditions, e.g. one or more actuators for adapting the emission direction of light, for adapting the orientation of an optical camera, for adapting the emission direction of ultrasonic waves, and the like.

In various aspects, the LIDAR module 100 (e.g., as part of the control circuit 106) may include one or more memory devices 108 storing information and instructions, such as the sensed data, the determined object information, instructions on how to operate the sensors, aging data, and the like. The one or more memory devices 108 may include volatile and/or non-volatile memories, such as random access memory (RAM), one time programmable (OTP) memory, read-only memory (ROM), electrically erasable programmable read-only memory (EEPROM), a FLASH memory, as examples.

In various aspects, the LIDAR module 100 may include one or more communication interfaces 110 (see FIG. 1B) to communicate with other systems or modules (e.g., other modules of a same vehicle, or another LIDAR module of another vehicle, as examples), e.g. configured for wired- and/or wireless communication. The one or more communication interfaces 110 may include at least one of a wired communication interface, a radio-based communication interface, and/or an optical communication interface (e.g., based on light-based communication via the light-based sensing system of the LIDAR module 100, using emitted/received light 122, e.g. laser light). Only as an example, the one or more communication interfaces 110 may include a communication bus 114 (e.g., a controller area network (CAN) bus) via a wired connection using a single connector (e.g., part of a car wire harness).

The one or more communication interfaces 110 may include one or more interaction paths between the LIDAR module 100 (e.g., the one or more components 104) and the outside of the LIDAR module 100. As an example, the one or more communication interfaces 110 may include a power distribution 116, e.g. coupled to a power supply 118 of the LIDAR module 100. The communication over the power distribution 116 may be one-directional or bi-directional (e.g., it may be bi-directional in case the power distribution 116 includes a power line communication (PLC)).

The one or more communication interfaces 110 may be bi-directional, so that the LIDAR module 100 may transmit and receive data via the one or more communication interfaces 110.

In various aspects, the LIDAR module 100 (e.g., as part of the control circuit 106) may include a clock 120 (e.g., a clock generator). By having its own clock the LIDAR module 100 may perform the desired tasks without depending on external clock information. The clock 120 may be configured to operate independently of whether the LIDAR module 100 is operating. For example, the clock 120 may include (or may be connected to) an energy source, such as a battery, so that it may provide accurate date and time without the need for time-adjustments even in case the module is not supplied with power (e.g., via the power distribution 116) for potentially long periods of time. Illustratively, the clock 120 may operate when the module 100 is powered, and, via the power provided by the energy source, also when the module 100 is not powered.

As an example, the clock 120 may include a real-time clock (RTC). The real-time clock may include a crystal clock and an energy source (e.g., a battery). In the case that the clock 120 includes an RTC, the time when the module is powered may be counted separately in addition to the “normal” time, so that with or without an RTC present on the module the operating time (e.g., the operating hours of the module 100) may be counted.

The operating time of the LIDAR module 100 may be stored, for example, as a counter in one of the memory devices 108 (e.g., in a non-volatile memory). The counter may be updated (e.g., increased) on a regular basis to record the operating time of the module.

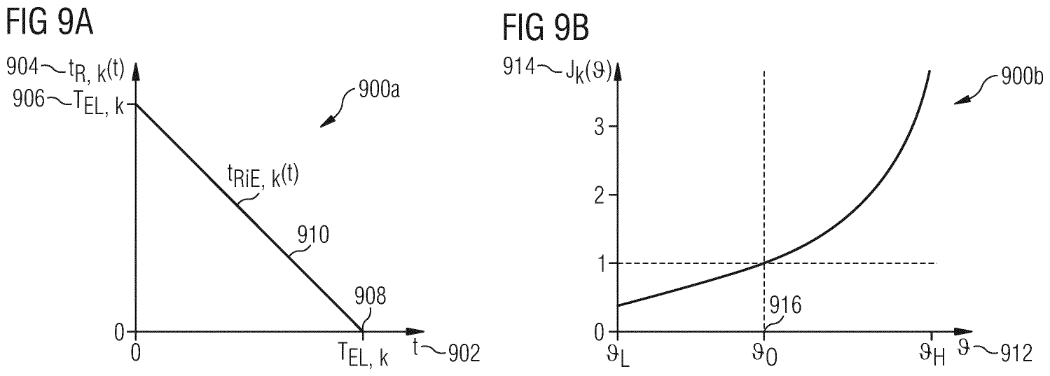

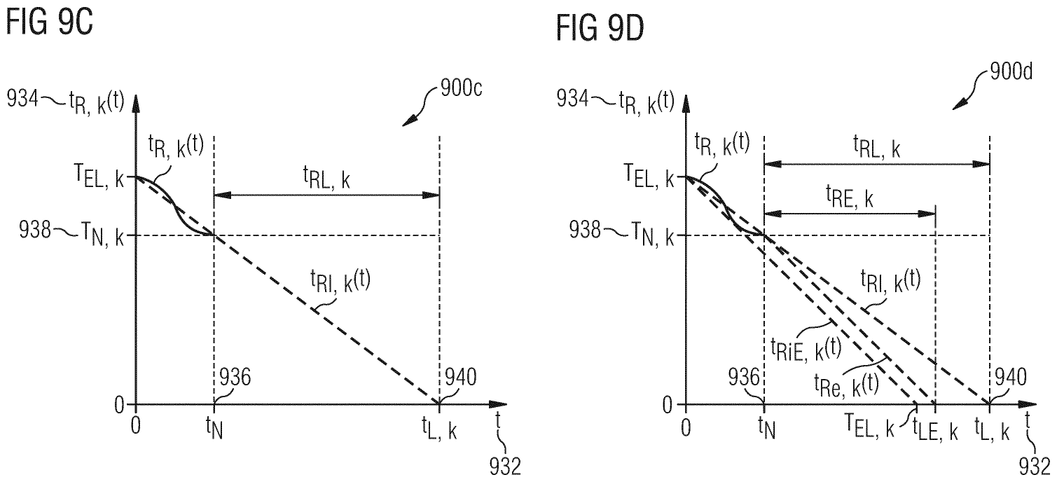

In various aspects, the one or more processors 102 may be configured to determine (e.g., to calculate) an estimate of a remaining lifetime of the LIDAR module 100, based on aging data representative of aging events associated with the one or more components 104 of the LIDAR module 100. The one or more processors 102 may be configured to implement the predictive maintenance strategy described herein. A more detailed description of the estimation of the remaining lifetime of the LIDAR module 100 will be provided below (see, for example, FIG. 9A to FIG. 9D). Illustratively, the one or more processors 102 may be configured to analyze aging events (e.g., which and how many) that occurred to the LIDAR module 100 (e.g., to the one or more components 104), and provide an estimation of a remaining lifetime of the LIDAR module 100 based on the result of the analysis. The estimation may include determining the overall effect of the aging events on the performance of the LIDAR module 100 (e.g., of the one or more components 104). As an illustrative example, the one or more processors 102 may be configured to determine the remaining lifetime of the LIDAR module 100 by considering how many light pulses have been emitted or received, by considering the temperature at which the LIDAR module 100 is or was operated, by considering the number of operating hours, by considering the voltages or currents used to operate the components 104, etc.

The remaining lifetime of the LIDAR module 100 may include a remaining lifetime of the one or more components 104 of the LIDAR module 100 (e.g., of at least one of the one or more components 104). Illustratively, the one or more processors 102 may be configured to determine (e.g., to calculate) an estimate of a remaining lifetime of at least one component (e.g., of some, or all components) of the one or more components 104, as described in further detail below (see, for example, FIG. 9A to FIG. 9D). The one or more processors 102 may be configured to determine the estimate of the remaining lifetime of the LIDAR module 100 based on the estimated remaining lifetimes of the one or more components 104.

In various aspects, a subset of components may be considered. A subset of components may include one or more (but not all) components of the one or more components 104. A subset of components may include the relevant components for the operation of the LIDAR module 100. Illustratively, the LIDAR module 100 may include components that contribute more to the operation (e.g., to ranging), such as a light source, a detector, etc., and may include components that contribute less to the operation, such as internal sensors. In some aspects, the estimation of the lifetime of the LIDAR module 100 may be based on the remaining lifetime of the more relevant components (e.g., to preserve computational power and memory space).

The one or more processors 102 may be configured to provide a message 112 indicative of the estimated remaining lifetime of the LIDAR module 100. As an example, the one or more processors 102 may be configured to transmit the message 112 via the one or more communication interfaces 110 (e.g., to another module or system external to the LIDAR module 100, e.g. to a central processing circuit of a vehicle). In addition or in alternative, the message 112 may include (may be indicative of) an estimate of the remaining lifetime of at least one component of the one or more components 104 (or of some of the components, e.g. of a subset of components 104, or of all the components 104).

The message 112 may include the results of the estimation, e.g. a dataset indicative of the remaining lifetime (and/or a predicted failure) of the LIDAR module 100 and/or of at least one component of the one or more components 104. The information included in the message 112 may assist in deciding when or how to repair or replace the LIDAR module 100 or one of its components 104 to minimize or eliminate a risk of (abrupt) failure.

The one or more processors 102 may be configured to transmit the message 112 in response to a (external) request, as described below, and/or independently, e.g. at periodic time intervals or in response to an event. As an example, the one or more processors 102 may be configured to transmit the message 112 in case the estimated remaining lifetime of the LIDAR module 100 is below a predefined threshold (e.g., less than 6 months, or less than 1 month, as examples). In some aspects, the message 112 may include information indicating that the estimated remaining lifetime of the LIDAR module 100 has fallen below the predefined threshold (e.g., the message 112 may be or may include a warn signal to alert a user that maintenance should be provided).

Only as an example, the LIDAR module 100 (e.g., the one or more processors 102) may inform a car that a laser module's lifetime is close to the end, and may provide a message inviting a user to exchange the laser module and/or describing a reduced performance of the laser module (e.g., to inform the user that until the laser module is exchanged, the LIDAR range is reduced by a certain amount of meters, e.g. by 10 m or by 30 m). Illustratively, the message 112 (or another message provided by the one or more processors 102 may include an indication of a “soft failure” of the LIDAR module 100, e.g. an indication of a reduced performance, for example below a satisfactory level). Based on the received information the car may take some actions, e.g. may adjust its autonomous driving.

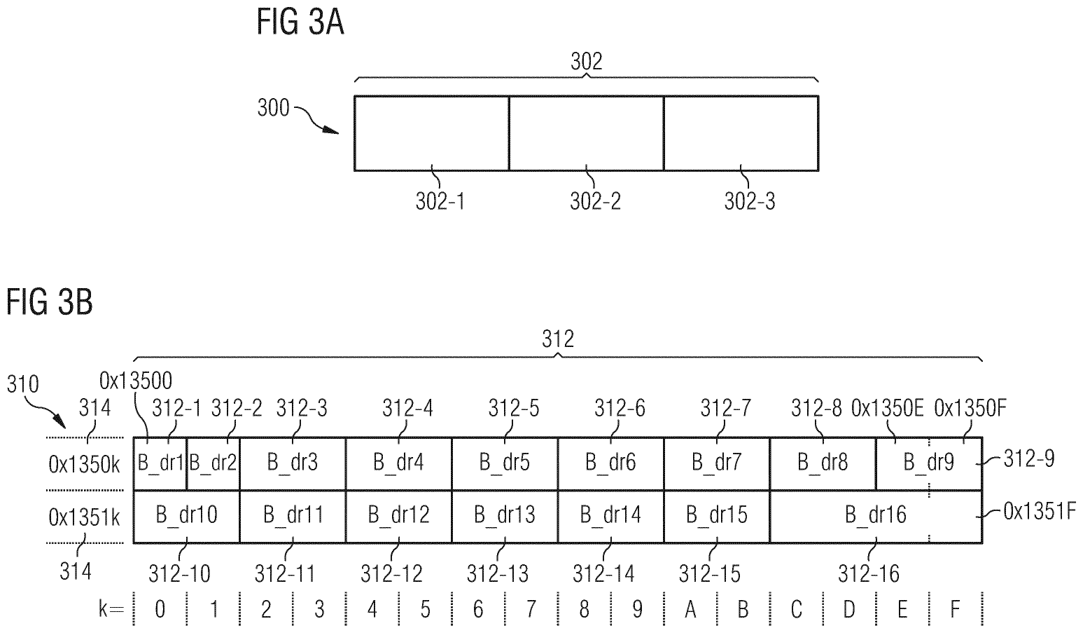

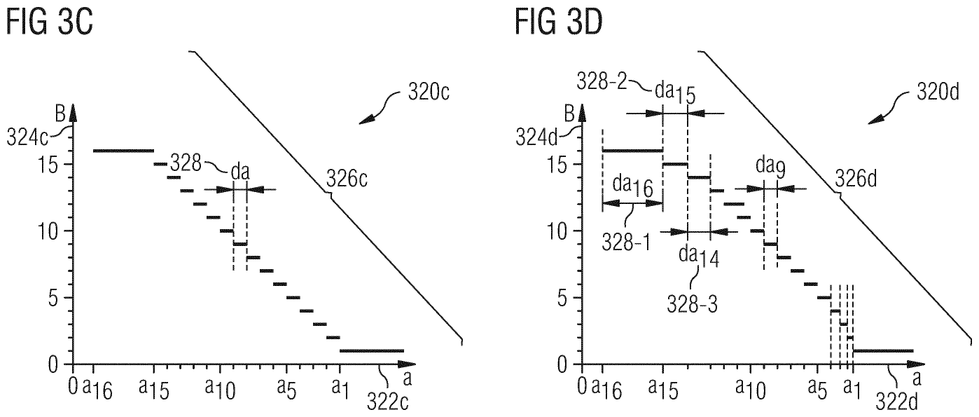

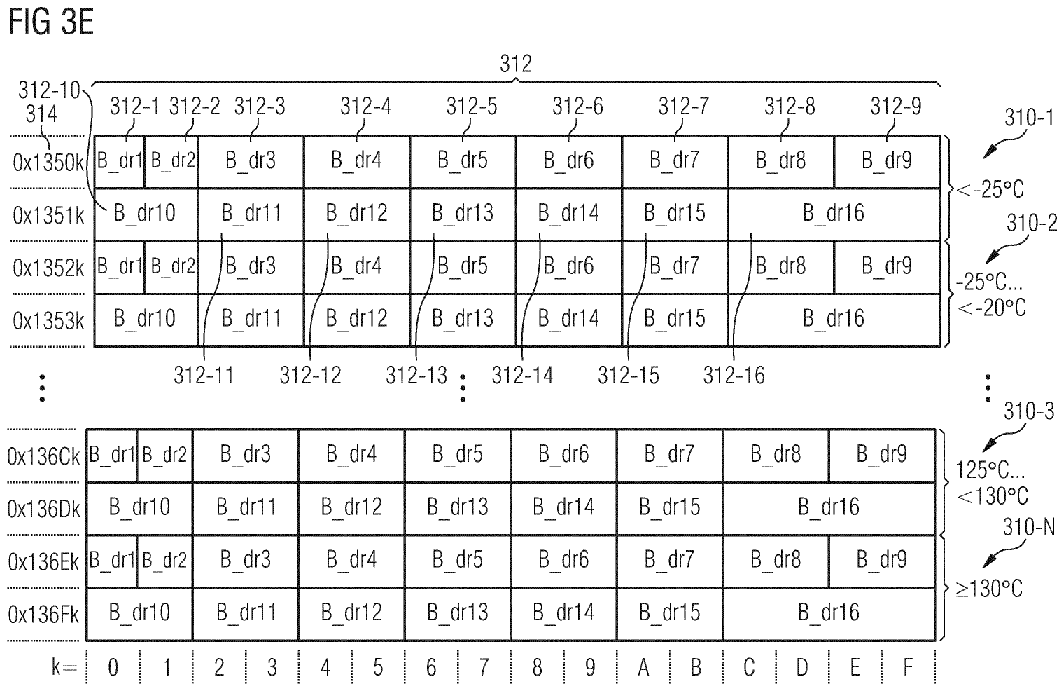

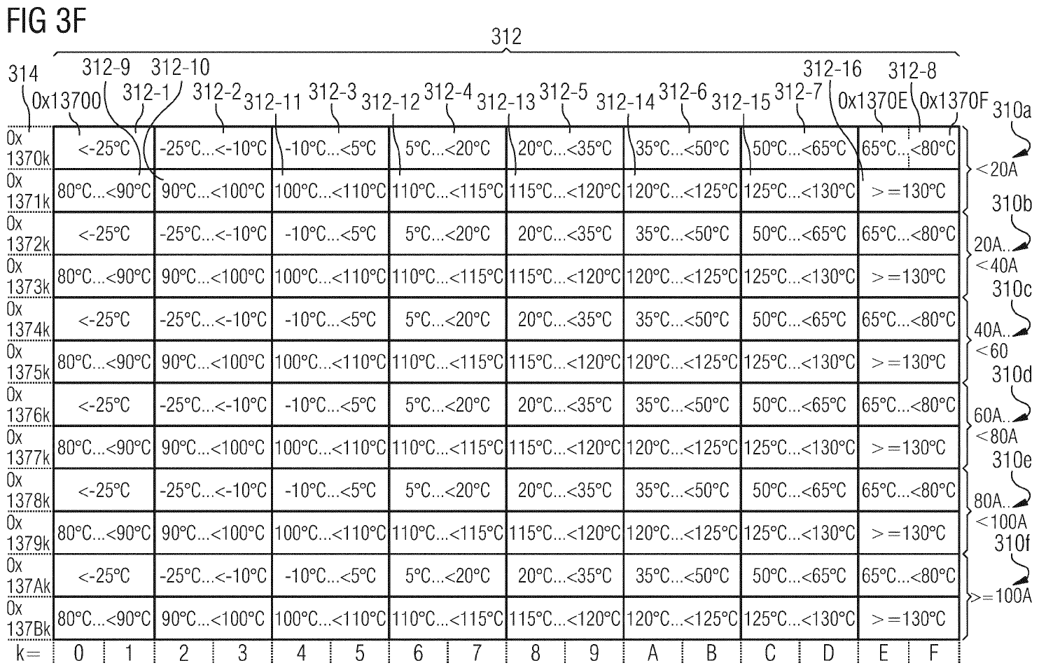

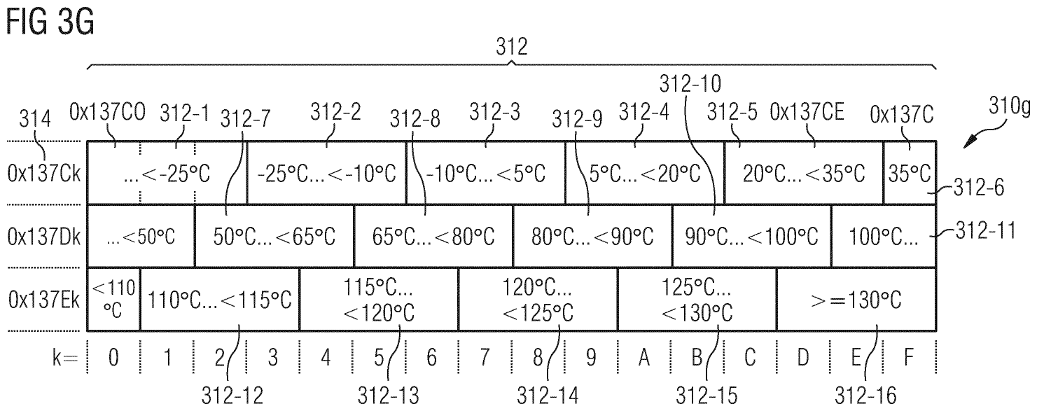

Each component of the one or more components 104 may have one or more aging mechanisms (e.g., of the first type and/or of the second type) associated therewith, as described in further detail below for some exemplary components. The respective aging data associated with each component may be representative of the aging events related to at least one of the one or more aging mechanisms associated with that component (in some aspects, related to each of the one or more aging mechanisms associated with that component). Illustratively, the aging data associated with a component may represent events (e.g., which, and how many) that cause or may have caused an aging (e.g., a decrease in the performance) of the component based on (at least one of) the relevant aging mechanisms for that component. As described in further detail below, see for example FIG. 3A to FIG. 3G, the aging events related to an aging mechanism may be categorized based according to one or more aging factors relevant for that aging mechanism.

The one or more processors 102 may be configured to estimate the remaining lifetime of a component of the one or more components 104 based on the aging events related to at least one of the one or more aging mechanisms associated with that component (in some aspects, related to each of the one or more aging mechanisms associated with that component). The estimation of the remaining lifetime may take into account the different aspects that may lead to a (e.g., continuous or abrupt) aging (and failure) of the component, as will be described in further detail below (see, for example, FIG. 9A to FIG. 9D).

In various aspects, the one or more processors 102 may be configured to estimate the remaining lifetime of a component in accordance with a respective aging model for at least one of the one or more aging mechanisms associated with that component (in some aspects, in accordance with a respective aging model for each of the one or more aging mechanisms with that component). At least one memory device 108 of the LIDAR module 100 may store one or more aging models, e.g. one aging model for each aging mechanism of a component. The one or more aging models may be predefined (e.g., upon fabrication of the LIDAR module 100) and may be upgradeable to take into account additional or alternative parameters for estimating the remaining lifetime of a component, as described below. The one or more processors 102 may be communicatively connected with the one or more memory devices 108 of the LIDAR module 100 (e.g., as part of the same control circuit 106), e.g. with the memory device storing the aging models, and may be configured to retrieve therefrom the aging model(s) associated with the component of interest.

An aging model (see also FIG. 9A to FIG. 9D) may describe how to take into account the aging events and/or aging factors for the estimation of lifetime the remaining of a component. Illustratively, an aging model may describe how to calculate or estimate the remaining lifetime by using the information provided by the aging data associated with that component. In the following, an example of an aging model will be provided. It is however understood that the aging model described herein is an example to illustrate a possible implementation of the predictive maintenance strategy, but other aging models (e.g., based on a different adjustment of the parameters, based on different formulas, etc.) may be provided.

In various aspects, the one or more processors 102 may be configured to predict a failure of the LIDAR module 100 based on the estimate of the remaining lifetime of the LIDAR module 100. Illustratively, the one or more processors 102 may be configured to associate the estimated remaining lifetime with a predicted time point at which the LIDAR module 100 will no longer be able to guarantee a satisfactory performance.

The failure of the LIDAR module 100 may include a failure of at least one component of the one or more components 104. The one or more processors 102 may be configured to predict a failure of at least one component based on the estimate of the remaining lifetime of that component (in some aspects, of each component or of a subset of components based on the respective estimate of the remaining lifetime). In various aspects, the one or more processors 102 may be configured to predict the failure of the LIDAR module 100 based on a predicted failure of one or more of the components 104 (e.g., the LIDAR module 100 will have a failure as soon as one of the components 104 will have a failure, e.g. the earliest time point predicted for a failure of one of the components may be the time point for the failure of the LIDAR module 100). As described above, the failure may be a hard failure or a soft failure. Illustratively, the one or more processors 102 may be configured to determine (e.g., calculate or estimate) a degradation in the performance of the LIDAR module 100 as a function of the remaining lifetime of the LIDAR module 100. The one or more processors 102 may be configured to determine degradation in the performance of a component as a function of the remaining lifetime of that component (and the degradation of the performance of the LIDAR module 100 based on the respective degraded performances of the components).

In various aspects, the one or more processors 102 may be configured to receive a request for information on the remaining lifetime of the LIDAR module 100 and/or of a component of the one or more components 104 (for example, via the one or more communication interfaces 110). The request may be, for example, from a central processing circuit of a car, or from an external service station. The request may prompt the one or more processors 102 to determine the requested information, e.g. the remaining lifetime of the LIDAR module 100 and/or of a component. The one or more processors 102 may be configured to carry out the estimation in response to the received request. In other aspects, the one or more processors 102 may be configured to carry out the estimation independently of the request, e.g. at periodic time intervals (as examples, every day, or every week), or in response to a predefined type of aging event (e.g., after a high temperature or a strong mechanical shock experienced by the LIDAR module 100).

The one or more processors 102 may be configured to transmit the message 112 in response to the received request. In response to the request, the one or more processors 102 may be configured to carry out the estimation and to transmit the estimated remaining lifetime of the LIDAR module 100 and/or the estimated remaining lifetime of the component 104. The issuer of the request can thus gain actual and updated information on a state of the LIDAR module 100, to decide whether (or when) to intervene for repairing or replacing the LIDAR module 100 or one of the components 104.

In various aspects, the one or more processors 102 may be further configured to transmit (e.g., in response to the request) data representative of which component of the one or more components 104 has the shortest estimated remaining lifetime. The one or more processors 102 may be configured to estimate the remaining lifetime of more than one (e.g., each) component and determine which component has the shortest estimated remaining lifetime associated therewith. This component will likely be the first to have a failure (e.g., a hard failure or a soft failure), thus causing a failure of the LIDAR module 100. The information on which component is closer to the end of its lifetime may be used to repair or replace that component, thus prolonging the overall lifetime of the LIDAR module 100.

The one or more processors 102 may be further configured to transmit (e.g., in response to the request) data representative of which aging mechanism (and/or which aging factor) associated with the component having the shortest estimated remaining lifetime is the principal cause of the shorter remaining lifetime compared to the other components. This information may assist in determining how to repair the component, e.g. which sub-components may be replaced or repaired to increase the remaining lifetime of the component.

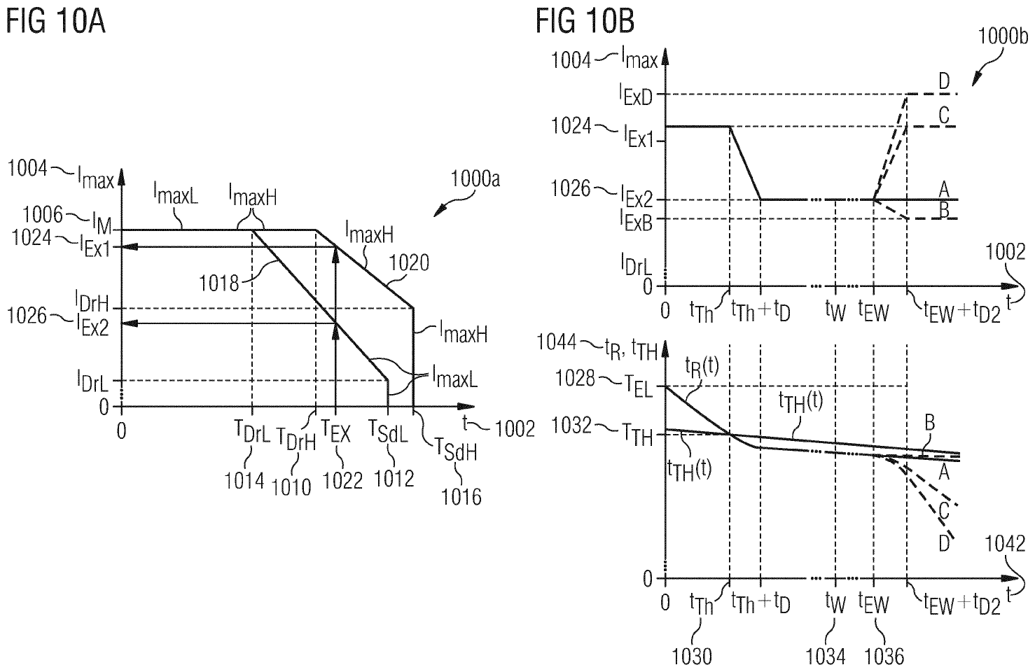

In various aspects, the one or more processors 102 may be further configured to receive an update (in other words, an upgrade) of one or more aging models associated with the aging mechanisms of the one or more components 104 (for example, via the one or more communication interfaces 110). As the knowledge on components, sub-systems, and systems may increase with the number of products in the field and the time these products are out, being able to upgrade aging models may ensure providing a more efficient (e.g., more accurate, or faster) estimation of the remaining lifetime. The upgrade of aging models may cover a range of possible modifications, including the modifications of formulas, tables, and data used to assess aging (also referred to herein as “degradation functions”), used to determine when and how to apply derating (as discussed below, see FIG. 10A and FIG. 10B), and used to assess the remaining product life.

Algorithms, formulas, tables, and data used to assess product aging based on historic measurements and data (describing how the product was used) may be the ingredients of the aging models describing the aging of components, sub-systems, and systems (see for example FIG. 9A to FIG. 9D). The upgrade may include replacing parts (or all) of a previous aging model with data provided to the LIDAR module 100, e.g. via the one or more communication interface(s) 110.

The update may be carried out, as an example, at the time of installation of the LIDAR module 100, e.g. in the car (e.g., in case of replacing a module in a garage with a module taken from stock having potentially outdated firmware/aging models), or while the module is in the field, e.g. by an over-the-air (OTA) firmware update. By upgrading aging models, the performance of the LIDAR module 100, e.g. the quality of the lifetime predictions by the module, may be enhanced even after shipment of the module. The updated aging model may include data and experience gathered by previously shipped and analyzed LIDAR modules 100.

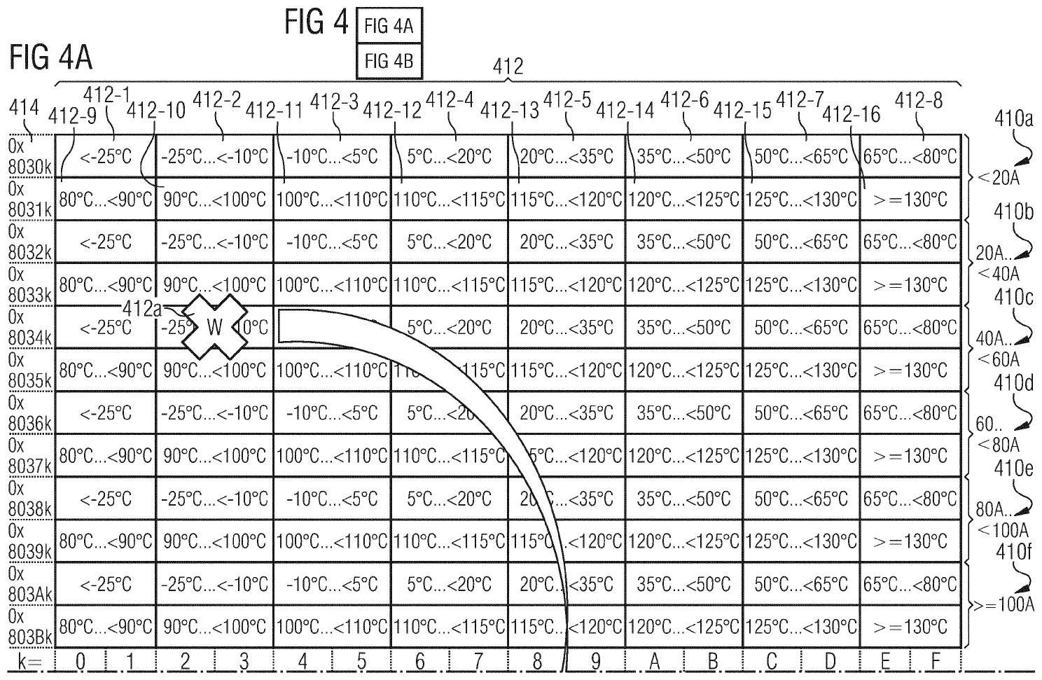

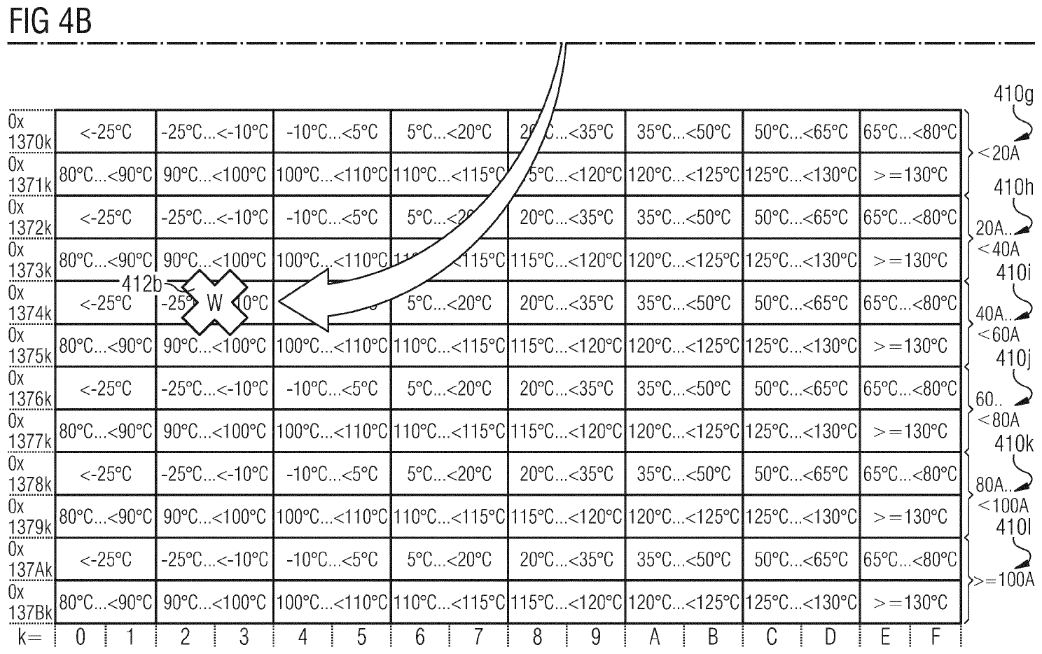

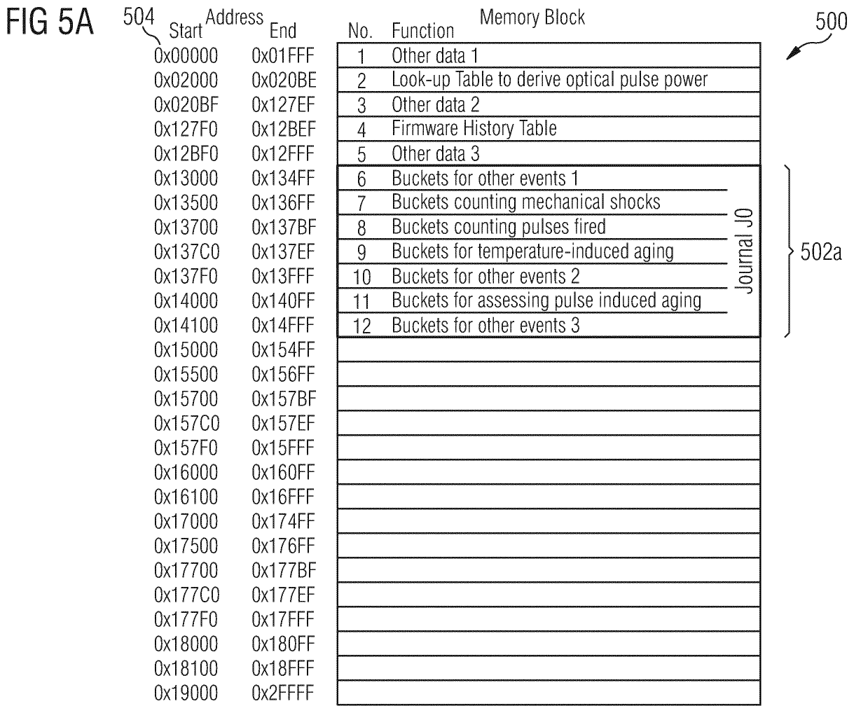

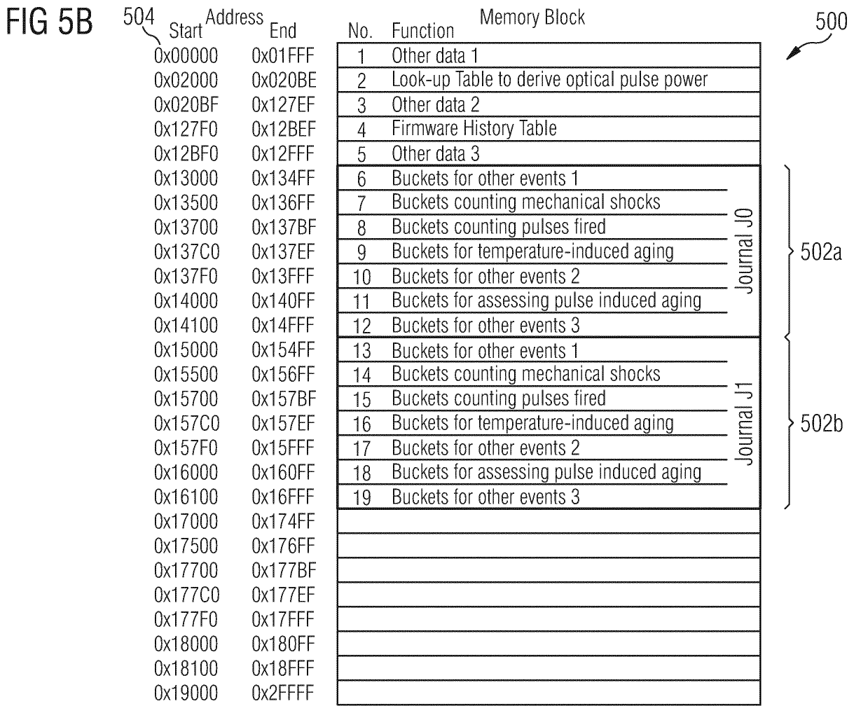

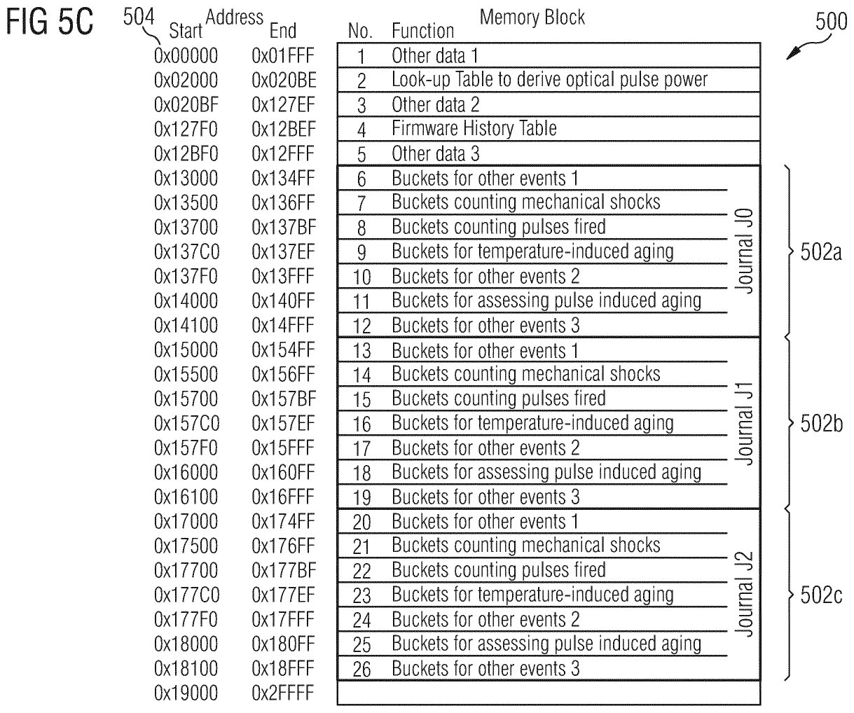

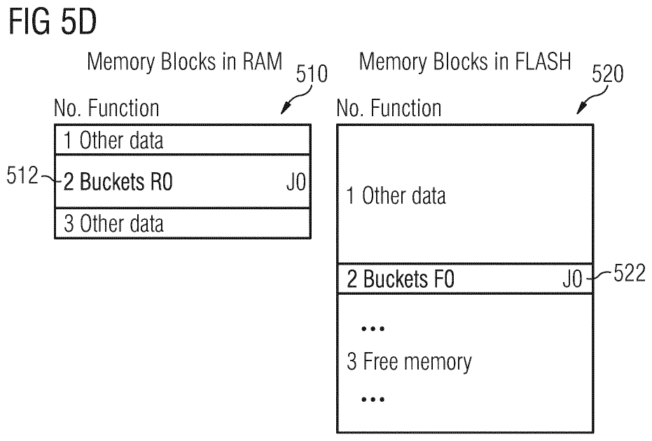

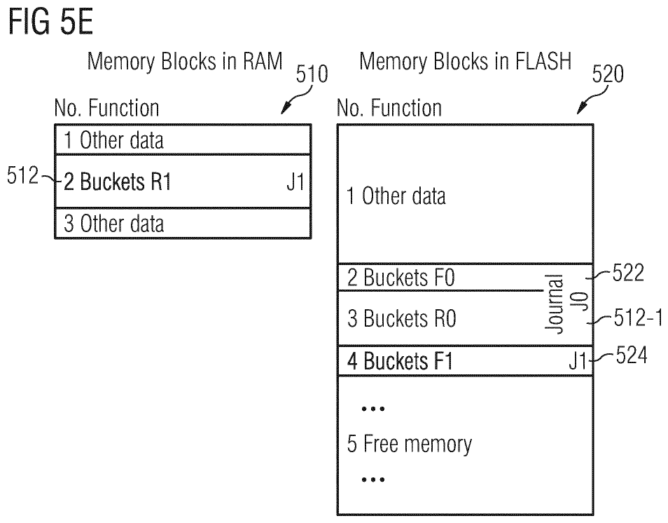

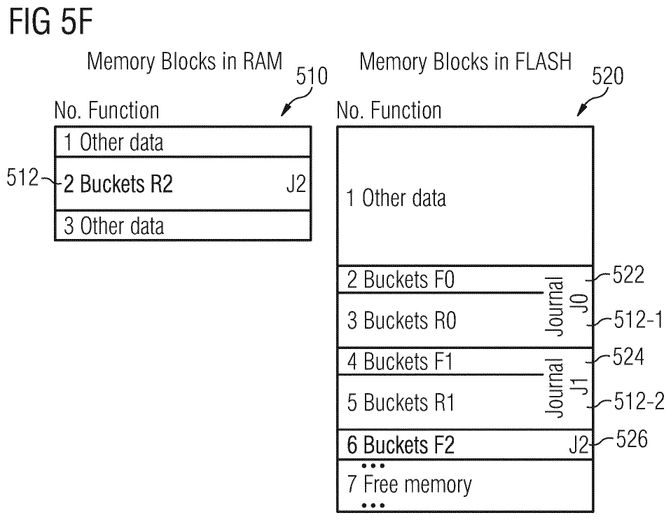

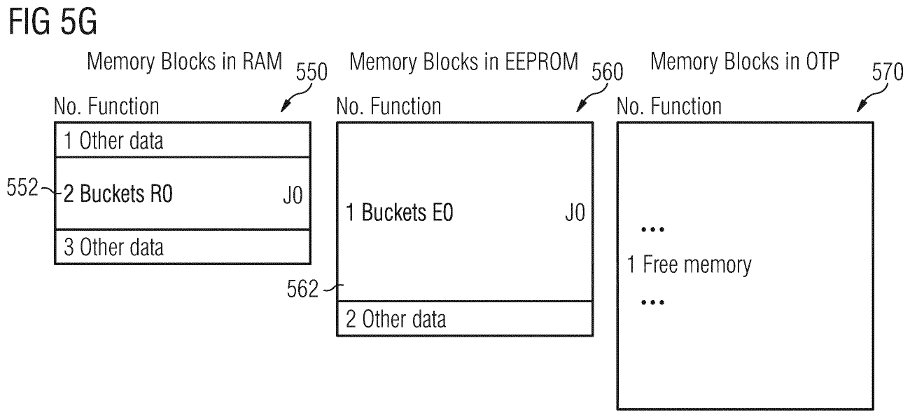

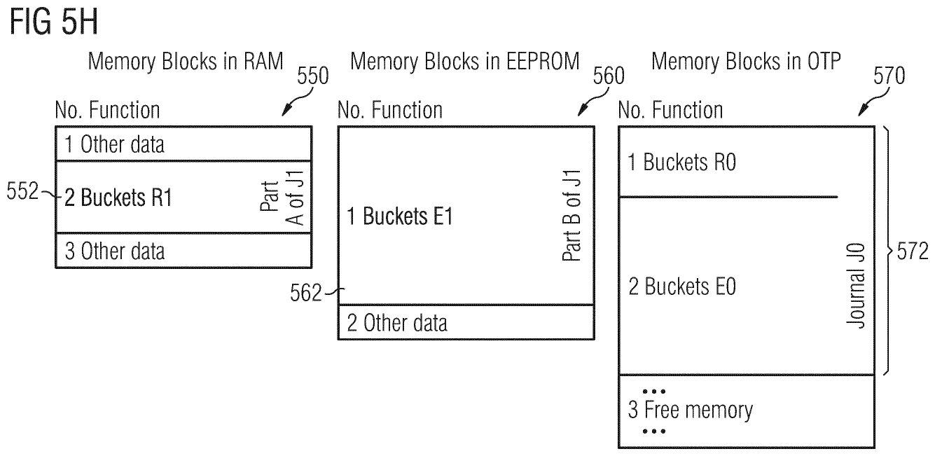

By way of illustration, the one or more processors 102 may be configured to answer three questions about (1) usage analysis (how was the product used in the past?), (2) monitoring (how is the product currently been used?), and (3) predictive maintenance (how much product life remains?). Aging events may be continuously recorded, e.g. in a non-volatile memory of the LIDAR module 100. Additionally or alternatively, a volatile memory may be used for some of the recording (see for example FIG. 4). Only as an example, an event may be generated every time a certain number of laser pulses have been emitted, or the product has been operated for a predefined amount of time, e.g. once every 10 minutes. The recoding may be performed in a time-series fashion or in a cumulative fashion. The cumulative fashion may provide the advantage of a more efficient memory space usage while still being computationally very cheap. The cumulative approach will be described in further detail below (see FIG. 3A to FIG. 3G), and may provide a significant accumulation of events (illustratively, may enable recording and storing a large number of aging events without occupying excessive memory space). In various aspects, the cumulative approach may be combined with a time-series approach (see FIG. 5A to FIG. 5C). As the control circuit 106 commands the individual parts of the LIDAR module 100, it may be seen as the “brain” of the module, and may be the ideal place to collect information about the product use and aggregate this information using the one or more processors 102 and storing the data in the respective memory 108.

The one or more processors 102 may be configured to answer the three mentioned questions from the recorded data (and without any additional information from the outside). The first question (usage analysis) may be answered by processing and further aggregating stored data depending on the requested data and requested level of granularity. The second question (monitoring) may be answered by directly providing status information (e.g. operating time, power ups, events, flags, etc.) or measurement results (the one or more processors 102 may retrieve stored measurement results or may perform the measurement just right after the request; measurements may be taken by, e.g., sensors on the product like temperature, voltage or current sensors). The third question (predictive maintenance) may be answered by first calculating lifetime models (e.g., formulas, for example stored in non-volatile memory estimating remaining lifetime) for individual components, sub-systems and their aging impact on product functionality (itemized as so-called aging aspects or aging mechanisms) using the mentioned stored data and then, in a second step, deriving the overall remaining product life by processing a “global lifetime function” (see FIG. 9A to FIG. 9D). In various aspects, the global lifetime function may be a minimum function, which takes all the individual remaining life values from the first step as its input data, and determines the minimum of all individual lifetime functions as the global lifetime in the second step.

In addition, the recorded data may be utilized to realize advanced product features like constant product performance and smart derating, as described in further detail below (see FIG. 10A and FIG. 10B). In case of these advanced product features, the data may be utilized by the LIDAR module 100 without any external request or triggers. In various aspects, the clock 120 and internal schedule(r) and/or internal “checkpoints” (in other routines of the firmware, e.g. every time a temperature sensor is read or the laser diode current is adjusted) may be dedicated to the advanced product features leading to an automatically and reoccurring revisiting of recorded data and acting upon it.

In various aspects, in addition to the time information, the clock 120 may be configured to provide a regular trigger to capture measurement values from various sensors (also referred to herein as monitoring sensors, illustratively monitoring the components 104) of the LIDAR module 100.

The LIDAR module 100 may include one or more (monitoring) sensors configured to sense one or more parameters (in other words, quantities) associated with the one or more components 104 (in some aspects, with a subset of the one or more components 104). The one or more sensors may be configured to monitor a status of the one or more components 104, e.g. a condition experienced by the one or more components 104. Various monitoring sensors may be provided, in accordance with the parameters of interest. Only as an example, the one or more monitoring sensors may include at least one of: a timer, a light sensor, a temperature sensor, a voltage sensor, a current sensor, and/or an acceleration sensor (a mechanical shock sensor). Illustratively, the one or more monitoring sensors may be configured to provide sensor data for use in the estimation of the remaining lifetime. Each monitoring sensor may be associated with one or more of the components 104, illustratively each sensor may be configured to sense one or more parameters associated with one or more of the components 104 (e.g., with neighboring components, or with sub-components of a same component, as examples).

The one or more monitoring sensors may be configured to transmit sensor data to the one or more processors 102, for example at periodic time intervals (e.g., every 5 minutes, every 10 minutes, every hour, or every 4 hours, as examples). The periodic time intervals may be defined by the clock 120 of the LIDAR module 100, e.g. the clock 120 may be configured to provide a trigger signal (e.g., one trigger signal for each sensor, or a common trigger signal) prompting the one or more sensors to transmit the respective sensor data to the one or more processors 102. The time intervals may be adapted to provide a sufficient amount of data for monitoring the one or more components 104, without generating an excessive amount of data.

The sensor data provided by the one or more monitoring sensors may be representative of at least one parameter (e.g., temperature, acceleration, received light, input or output voltage, acceleration, input or output current, etc.) associated with at least one component of the one or more components 104. By way of example, the one or more sensors may sense the input voltage and temperatures of housing (case), individual laser diodes, individual photo diodes, micro-electro-mechanical systems (MEMS) mirror, liquid crystal polarized grating (LCPG), lenses at their mounting points to the respective holders, etc., as described in further derail below. The one or more processors 102 may be configured to receive the sensor data from the one or more sensors, and may be configured to determine a parameter value for that parameter as a function of the received sensor data (e.g., a temperature value, an acceleration value, a current value, a voltage value, a light power value, etc.).

The one or more processors 102 may be configured to determine (e.g., to calculate) the parameter value as a function of a plurality of sensor data representative of the associated parameter. Illustratively, measurement values may be noisy. A number of measurement values (e.g., in a range from 5 to 50, as a numerical example) may be captured within a short amount of time (e.g., 10 ms-100 ms for temperature values, 10 μs-1 ms for acceleration values, as numerical examples) and may be processed to extract a clean parameter value. As an example, the one or more processors 102 may be configured to determine the parameter value based on an average of the received sensor data associated with the respective parameter. As other examples, the one or more processors 102 may be configured to determine the parameter value based on a minimum value of the parameter indicated by the sensor data, and/or based on a maximum value of the parameter indicated by the sensor data, and/or based on a median value of the parameter indicated by the sensor data. As a further example, the one or more processors 102 may be configured to determine the parameter value by disregarding the minimum and maximum of the captured values, and calculating the arithmetic average of the remaining values. This average may be referred to (and recorded in the following) as a single data point.

The one or more processors 102 may be configured to transmit at least part of the received sensor data (and/or one or more of the determined parameters value), e.g. via the one or more communication interfaces 110. The transmission of such information may provide the monitoring functionality described above (the answer to the question of how is the product being used). The one or more processors 102 may be configured to receive (for example, via the one or more communication interfaces 110) a request for sensor data and to provide (e.g., in the message 112 or in another message) the sensor data related to a parameter of at least one component in response to the request (e.g., the sensor data may be transmitted via the one or more communication interfaces 110). In other aspects, the one or more processors 102 may be configured to transmit the sensor data and/or one or more of the parameter values independently of a request, e.g. at periodic intervals, or driven by events, e.g. when entering the proximity of a service station.

In various aspects, the one or more processors 102 (e.g., the control circuit 106) may be configured to control the recording of the aging data, in addition to the implementation of the aging models and the estimation of the remaining lifetime of the LIDAR module 100.

The information (illustratively, the aging data) that may be recorded by the LIDAR module 100 (e.g., by the one or more processors 102) may be illustratively divided into three types of data: (1) time information (e.g., provided by the clock 120); (2) sensor data (e.g., captured by the one or more monitoring sensors, as described above); and (3) other information already available to the one or more processors 102 (e.g., information available in the control circuit 106 anyway).

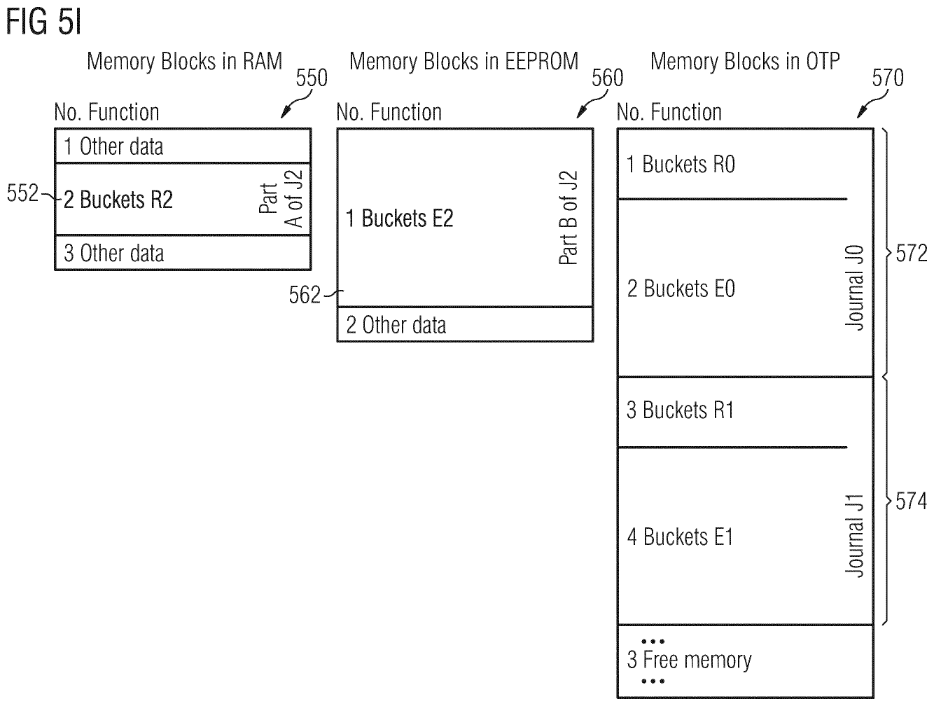

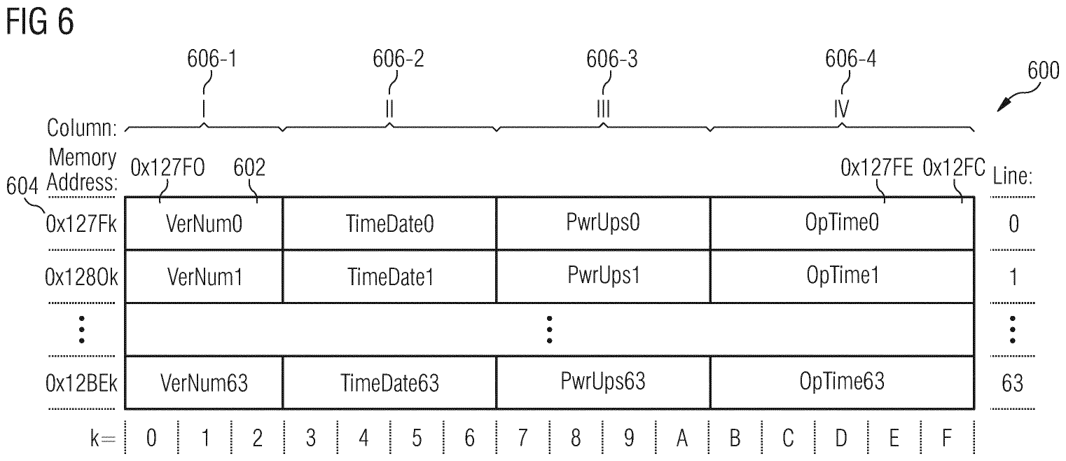

The other information already available to the one or more processors 102 may include, as examples:
(a) information generated by the one or more processors 102 themselves (e.g., by the control circuit 106, such as the number of power-ups);
(b) information received over the one or more communication interfaces 110 (e.g., via the communication bus 114, such as the firmware revision number to analyze the impact on firmware changes, and hence parameter settings as part of the code, on product life, see also FIG. 6);
(c) set-values commanded by the one or more processors 102 (e.g., by the control circuit 106); illustratively, set-values for the one or more components 104 provided via instructions generated by the one or more processors 102, e.g. a zoom level of the optics, a zone selected by a LCPG, a current set-values of the laser diode drive circuits (in case of a laser pulse generation with adjustable amplitude), and the like; and
(d) other sensor value information (e.g., a sensor, such as one of the monitoring sensors, that may be controlled by a sub-system of the LIDAR module 100, but may still be configured to communicate the sensor values to the one or more processors 102); an example may be the input voltage, as the input voltage may be measured by the power supply circuit as part of a control circuit of the power supply 118.

The above listed “other” information may be already available to the one or more processors 102 (to the control circuit 106), and the recording of such data (including no or some time information) may be carried out with low effort (e.g., compared to information not available in the control circuit 106, which may be generated first, but in any case may be communicated to the control circuit 106). The recording may be performed according to the “bucket approach” described in further detail below, see for example FIG. 3A to FIG. 3G.

The lifetime data captured and recorded in memory 108 may provide a comprehensive set of data points allowing to reconstruct the use and wear of the components 104 and sub-systems of the LIDAR module 100. The type of data to be stored may be selected in accordance with the models used for the reconstruction. In case the information (described above) available is insufficient for the purpose, additional quantities may be measured or derived from other (additionally measured) quantities employing respective models and solvers running on the one or more processors 102 of the LIDAR module 100, e.g. measuring temperature of a lens/laser diode at mounting point and derivation of core temperature of the respective lens by respective modeling, as discussed in further detail below.

In various aspects, the aging data used by the one or more processors 102 for the estimation of the remaining lifetime may include global data related to aging events experienced by the LIDAR module 100 (as a whole), and individual data related to aging events experienced by the one or more components 104. The global data may be understood as relating to aging events that the LIDAR module 100 as a whole experiences (and affect all the components), e.g. as related to aging factors common to all the components 104 (or at least common to the relevant components). The individual data may be understood as relating to individual aging events that one or more of the components experience (and may not directly affect the other components), e.g. as relating to aging factors specific for that component. The one or more processors 102 may control the recording (and storing) of the global data and individual data, e.g. may themselves record part of the data (such as the number of power-ups), and may control the recording of data provided by the one or more monitoring sensors (e.g., a temperature, a voltage, etc.). The recording and storing of aging (global and individual) data will be described in further detail below, see FIG. 3A to FIG. 3G.

The aging events related to the global data may be representative of at least one of:
(1) A number of power cycles of the LIDAR module 100. A power-up may stress the components 104 with transients, and a component may be stressed with overvoltage. Components 104 and connections (e.g., printed circuit boards and solder joints) may be mechanically stressed due to thermal cycling. Depending on the respective design, also power-downs may stress components 104 with more or less strong transients. As power-ups and power-downs always come in pairs it may be sufficient to count the number of power-ups (which may be typically easier to realize as the power is available for the respective processing and memory access).
(2) A number of operating hours of the LIDAR module 100. Many components age significantly while being operated, and may age less significantly during storage (illustratively, during a time in which the LIDAR module 100 is not operated).
(3) A temperature of the LIDAR module 100 above (or below) a predefined threshold temperature, and/or a period of time for which the temperature of the LIDAR module 100 is above the predefined threshold temperature. The predefined threshold temperature may be selected in accordance with an expected effect of the temperature on the one or more components 104. As a numerical example, the predefined threshold temperature may be in the range from 50° C. to 100° C., for example in the range from 120° ° C. to 200° ° C., for example may be 70° C. or 150° C. In some aspects, a plurality of predefined threshold temperatures may be provided, e.g. each associated with a respective component (or with respective one or more components) in accordance with the effect of the temperature on that component(s).
(4) A number of temperature cycles experienced by the LIDAR module 100. Depending on the design, temperature cycling may have a very significant and detrimental impact on a component's life due to induced mechanical stress, as mentioned above. The recording of temperature cycles (to which the entire module 100 may be exposed) may assist the assessment of the aging conditions.
(5) An acceleration experienced by the LIDAR module 100 being above a predefined threshold acceleration. In some aspects, the acceleration may be understood as a mechanical shock experienced by the LIDAR module 100 being above a predefined threshold shock. Mechanical shock or, in other words, strong physical acceleration of a module (e.g., of the LIDAR module 100) may cause significant aging of components, especially optical and electronic components may be impacted the most.
(6) A predefined time lapsed with the LIDAR module 100 being at a temperature above or below a predefined temperature threshold (e.g., a first temperature threshold for high temperatures, for example 70° C., or 100° ° C., or 150° C., and a second temperature threshold for low temperatures, for example −10° C., or −25° C., or −50° C.). Prolonged exposure to excessively high or excessively low temperatures may impact the aging of the LIDAR module 100.

In various aspects, in relation to the temperature (3), many components 104 may age significantly while being at elevated temperature, regardless of being in operation/powered or not, and hence regardless of whether the component is heating up itself or gets heated up by neighboring components. On the other hand, many of these components 104 do not significantly age at lower temperatures (at a temperature below a predefined threshold), e.g. at room temperature. In case the module 100 is not in operation, it may be assumed that all components and sub-systems are substantially at the same temperature, e.g. at ambient temperature. The assumption may be based on steady-state conditions and a fairly compact design of the module 100, as it may be the case in most applications. In operation, the respective temperatures of the one or more components 104 may be higher compared to the case temperature (illustratively, compared to the temperature of a housing of the LIDAR module 100), as the module may be cooled using the housing (also referred to herein as case) as a heatsink.

The one or more processors 102 may be configured to determine (e.g., to calculate, or estimate) a temperature of a component of the one or more components 104 by using a temperature of the LIDAR module 100. Illustratively, the temperature of at least one component (e.g., of each component, or of the components of a subset) may be estimated from the temperature of the housing of the LIDAR module 100. The one or more processors 102 may be configured to determine the temperature of a component based on a knowledge of the modes of operation (time sequence) of the LIDAR module 100, e.g. of the power dissipated in the components (power over time). In various aspects, the one or more processors 102 may be configured to determine the temperature of a component in accordance with a thermal model of the LIDAR module 100, describing a relation among the temperature of the housing with the temperature(s) of the component(s). For example, an all-encompassing thermal model may be provided, which may be however challenging to determine and computationally intensive to implement. As another example, one or more thermal sub-models may be provided, to estimate a subset (only a few) discrete temperatures at very specific places (in the LIDAR module 100). The one or more thermal sub-models may be configured to take into account not only the temperature of the housing, but also other temperatures measured in the system as input parameters. Measuring (and recording) the housing (case) temperature may provide assessing the operating temperature of the module 100 and its components 104. In case recording the housing temperature was not possible (e.g., due to memory constraints), time spans in which the system 100 was at a temperature above a certain (or multiple) threshold temperature(s) (e.g., above 50° C., or above 100° C., as examples) may alternatively be measured (and recorded).

There may be various options to measure the temperature of the LIDAR module 100, e.g. to measure the housing temperature. In various aspects, the LIDAR module 100 (e.g., the one or more monitoring sensors) may include a temperature sensor configured to detect a temperature of the LIDAR module (e.g., configured to detect a temperature of the housing of the LIDAR module 100). The temperature sensor may be disposed on (e.g., attached to) the housing of the LIDAR module 100. Only as an example, the temperature sensor may include a thermistor or a diode. For example, a thermistor mounted to the inside of the housing may be used to measure the housing temperature. The thermistor may be realized using a thermocouple, or a temperature-dependent resistor (e.g., a negative temperature coefficient (NTC), or a positive temperature coefficient (PTC) resistor). Alternatively, instead of being directly mounted to the housing, the thermistor may be located on a printed circuit board (PCB) for complexity and cost reduction. The PCB may be thermally connected (e.g., bolted or riveted) to the housing (and the thermistor may be placed very close (e.g., less than 10 mm or less than 5 mm) to the hole in the PCB that carries one of the screws or rivets with which the PCB is mounted to the housing). The temperature sensor may be configured to be powered continuously, to allow measurement and recording independently of an operation of the LIDAR module 100. As an example, the temperature sensor may be configured to receive power from the outside of the LIDAR module 100, e.g. “directly” from a vehicle's battery (in this configuration the circuit is not tied into the “ignition switch” circuit). As another example, the LIDAR module 100 may include an (additional) energy source configured to provide energy to the temperature sensor. The additional energy source may include, for example, a battery, and optionally may be used to provide energy to both the temperature sensor and the clock 120 (e.g., the real-time clock) of the LIDAR module 100. In various aspects, the temperature sensor may be a temperature sensor of one of the components 104 of the LIDAR module 100, e.g. may be a temperature sensor of the control circuit 106 (for example integrated therein). In combination with a temperature model, the temperature sensor may allow a calculation of the recorded housing temperature from the measured temperature inside the component (e.g., inside the control circuit 106) by considering loss power dissipated by the respective component and the thermal resistances/impedances as part of the thermal model.

In various aspects, in relation to the number of temperature cycles (4), the one or more processors 102 may be configured to evaluate thermal cycling based on sensor data of at least one temperature sensor disposed on (e.g., attached to) the housing of the LIDAR module 100 (e.g., the temperature sensor described above), for example based on an average of such sensor data. Even though probably every (or almost every) temperature sensor on the module 100 is likely being impacted to some extent by an overall fluctuating temperature (and hence every sensor on the module 100 could also measure the cycling to some extent), it may be preferable to assess thermal cycling by assessing the one or the average of a few sensors that are attached to the bulk/housing of the module 100 and hence vary the most with external temperature changes. In a typical configuration, measuring the external temperature (e.g., the temperature external to the LIDAR module 100, or external to the vehicle in which the LIDAR module is installed, for example the ambient temperature) directly is not possible or at least very complex, due to environmental constraints, for example the module needing to withstand corrosive liquids. The readings of the at least one sensor (in some aspects, of a plurality of sensors) disposed on the housing of the LIDAR module 100 may vary the least by thermal changes due to module's own operation. Illustratively, the heat dissipated inside a LIDAR module (e.g., inside the LIDAR module 100) may typically fluctuate quite a bit (e.g., in terms of number of occurrences and signal level) over time, with a more complex profile than just a simple cycling correlated with the module being in operation or being in “sleep mode”/being turned off. The “subtraction” of the temperature fluctuation generated by the module from fluctuations of the environment may thus be computationally complicated. The use of a sensor (or a plurality of sensors) disposed on the housing of the LIDAR module 100 allows measuring temperature fluctuations of the environment at points that are as close to the environment as possible, thus showing the least impact from module operation.

In various aspects, in addition or in alternative to the housing temperature, the (absolute) temperature for some (or each) component or sub-system of the LIDAR module 100 may be recorded, e.g. at least of the components and sub-systems deemed to be relevant from a product lifetime point of view (e.g., a subset of components, as described above). The one or more monitoring sensors may be configured to measure the individual temperature of the one or more components 104 (e.g., of at least one, of some, or each of the one or more components 104). For example, the one or more monitoring sensors may include one or more temperature sensors (e.g., one or more thermistors) associated with one or more of the components 104 (to measure a temperature thereof). Additionally or alternatively, the temperature of some of the components may be estimated using thermal modeling. The reason for this recording of temperature data is that a majority of failure mechanisms may be directly or indirectly dependent on temperature.

In various aspects, in relation to the acceleration (5), at least one sensor of the one or more monitoring sensors may be configured to measure (to sense) an acceleration of the LIDAR module 100 (e.g., at least one sensor may include an accelerometer disposed in such a way that it measures the acceleration of the LIDAR module 100). The global data may include an acceleration exceeding a certain threshold acceleration (e.g., 10 m/s², or 50 m/s², or 100 m/s², as examples). In some aspects, the magnitude of the acceleration may be measured (and recorded) jointly with the temperature when a shock occurs, and the one or more processors 102 may be configured to assess the aging impact based on both values. The temperature may be recorded jointly with the magnitude of the shock, as mechanical strength of materials may be temperature-dependent. The temperature range where the mechanical strength shows strong influence from the temperature may be dependent on the material of the module or component. For solid matter typically a strong influence may be present when getting close to the melting or glass temperature of the respective material. The same is true for low temperatures, where some materials may become brittle. Thus, also shocks at low temperatures may cause more impact than shocks with the same magnitude but at moderate temperatures.

It may be assumed that the shock magnitude is substantially the same (e.g., within ±10% of a magnitude of the acceleration) for any component 104 inside the LIDAR module 100. It may be sufficient to measure and record the mechanical shock only once for the entire LIDAR module 100, optionally in addition to the temperature of the module 100. Alternatively, one or more monitoring sensors may be configured to measure the individual acceleration of one or more (e.g., each) of the components 104, which may provide a more precise measurement. As an example, the monitoring sensors may include a plurality of accelerometers associated with one or more of the components 104 (to measure the acceleration thereof). The measure of the individual accelerations may be in addition to measuring the temperatures of the components showing significant temperature-dependence of their aging due to mechanical shocks.

The individual data related to aging events experienced by the one or more components 104 may be representative of various parameters affecting the one or more components 104. Different components may have different types of individual data associated therewith, depending on the respective aging mechanism(s). The individual data may be representative of at least one of:
(1) a time during which at least one component is operating;
(2) a temperature of at least one component during operation (e.g., a temperature during operation being below or above a predefined threshold temperature, for example a threshold in the range from 50° ° C. to 100° C., for example in the range from 120° C. to 200° ° C., for example 70° C. or 150° C.);
(3) a temperature of at least one component during storage (e.g., a temperature during storage being below or above the predefined threshold temperature);
(4) an input voltage provided to at least one component for operation (e.g., an input voltage being above or below a predefined threshold voltage, for example 1 V or 5 V);
(5) an input current provided to at least one component for operation (e.g., an input current being above or below a predefined threshold current, for example 1 A or 5 A);
(6) an optical power or an optical power density passing through at least one component (e.g., an optical power being above or below a predefined threshold optical power);
(7) an acceleration experienced by at least one component during operation (e.g., an acceleration during operation being above or below a predefined threshold acceleration, for example 10 m/s² or 50 m/s²); and/or
(8) an acceleration experienced by at least one component during storage (e.g., an acceleration during storage being above or below the predefined threshold acceleration).

It is understood that the types of global and individual data described herein are exemplary to describe the predictive maintenance strategy, and other types of global and individual data (e.g., additional, less, or alternative quantities) may be measured and recorded depending on the components of the LIDAR module 100 and the associated aging mechanisms.

The global and individual data may be freely selected in accordance with the desired estimation of the remaining lifetime of the LIDAR module, as long as they provide a comprehensive set of data points allowing to assess the product aging. The recorded data may be selected to allow for the reconstruction of how the product was used and how much wear occurred to the components and sub-systems of the LIDAR module. At least for one (e.g., each) component and/or sub-system of the LIDAR module 100 a temperature measurement may be recorded over time. In some aspects, multiple temperatures aside from other non-thermal quantities may be recorded for at least one (e.g., for most, or each) component of the LIDAR module 100 (e.g., for a subset of components).

In the following, in relation to the configuration of the LIDAR module 100 in FIG. 1A and FIG. 1B, possible components 104 and the associated aging mechanisms, aging factors, and aging events will be described. It is understood that the choice of components 104 described in the following is exemplary, and a LIDAR module (e.g., the LIDAR module 100) may include additional, less, or alternative components (with other associated aging mechanisms, aging factors, and aging events). Illustratively, below an exemplary set of components and/or sub-systems is provided with some of the respective “individual quantities” that may be recorded over time for the assessment of the remaining lifetime of the LIDAR module 100 and/or of the components 104.

In various aspects, the LIDAR module 100 (the one or more components 104) may include a light emission device 124 (also referred to herein as transmitter). The light emission device 124 may be configured to emit light towards a field of view of the LIDAR module 100. The light emission device 124 may include a light source 126 and a driver circuit (not shown) configured to drive the light source 126.

The light source 126 may be configured to emit light 134 having a predefined wavelength, for example in the visible range (e.g., from about 380 nm to about 700 nm), infra-red and/or near infra-red range (e.g., in the range from about 700 nm to about 5000 nm, for example in the range from about 860 nm to about 1600 nm, or for example at 905 nm or 1550 nm), or ultraviolet range (e.g., from about 100 nm to about 400 nm). The light source 126 may be configured to emit light 134 in a pulsed manner, for example the light source 126 may be configured to emit one or more light pulses (e.g., a sequence of light pulses). In some aspects, the light source 126 may be or may include an optoelectronic light source (e.g., a laser source). As an example, the light source 126 may include one or more light emitting diodes. As another example the light source may include one or more laser diodes, e.g. one or more edge-emitting laser diodes or one or more vertical cavity surface emitting laser diodes. The light source 126 may be configured to emit one or more laser pulses, e.g. a sequence of laser pulses.

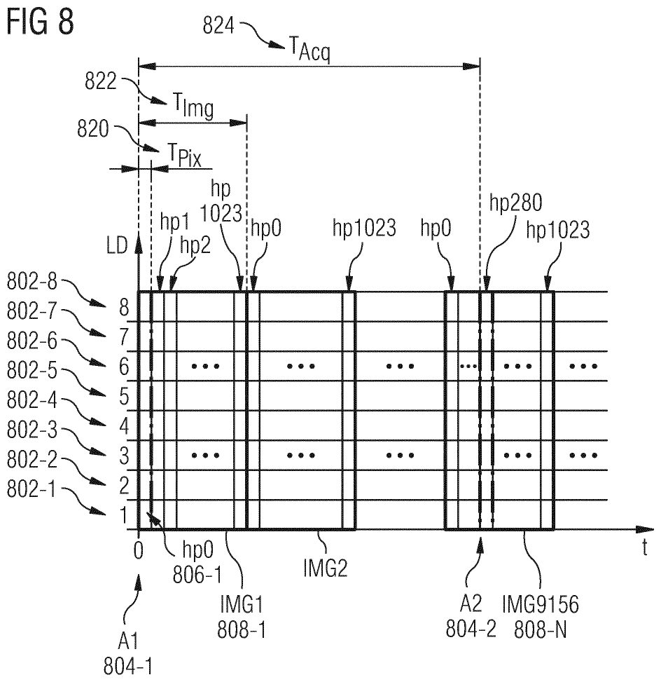

The individual data related to aging events experienced by the light emission device 124 may represent at least one of: a time during which the light emission device 124 is operating; a temperature of the light source 126 (e.g., a temperature being above or below the predefined threshold temperature); a peak power of an emitted light pulse; and/or a number of emitted light pulses. Illustratively, the individual data may be associated with the relevant aging factors (temperature, emitted light, etc.) for the light emission device 124, and may represent aging events that may affect the performance of the light source 126 (e.g., may affect the power of the emitted light). To reduce the amount of recorded data, the emitted light pulses may be subsampled, as described in further detail below, see for example FIG. 8.

In various aspects, the light source 126 may include a plurality of emitter pixels, e.g. the light source 126 may include an emitter array having a plurality of emitter pixels. For example, the plurality of emitter pixels may be or may include a plurality of laser diodes. For each pixel of the emitter array, relevant quantities may be recorded: pixel temperature (laser diode temperature); pulse power or peak current; and/or number of pulses emitted. Illustratively, the individual data related to aging events experienced by the light emission device 124 may, additionally or alternatively, represent at least one of: an individual temperature of at least one (e.g., of each) emitter pixel (e.g., an individual temperature being above or below the predefined threshold temperature); a number of light pulses emitted by at least one (e.g., each) emitter pixel; and/or a peak power of a light pulse emitted by at least one emitter pixel (e.g., a respective peak power of a light pulse emitted by each emitter pixel).

Each emitter pixel may be individually driven with an adjustable driving signal, e.g. an adjustable current. The amplitude of such adjustable current (or pulse power) may be recorded individually per pixel. In case all pixels are driven with the same current, e.g. as part of a “pulse sequence”, then less data recording may be sufficient (e.g., recording of the temperature of the hottest and the coldest emitter pixels). The total number of pulses emitted may be calculated by summation over all emitter pixels. In some aspects, not all the temperatures are measured, and some (or all) of the temperatures may be estimated employing respective thermal models, as described above.

Additional or alternative individual data may be related to the driver circuit of the light emission device 124, illustratively to the power electronics and/or pixel drive electronics. The individual data related to aging events experienced by the light emission device 124 may, additionally or alternatively, represent at least one of: a temperature of the driver circuit (e.g., the temperature of main transistor of the driver circuit); a peak power of a driving signal (e.g., a peak current in case of a driving current signal, or a peak voltage in case of a driving voltage signal) provided by the driver circuit; and/or a number of driving signals provided by the driver circuit. In some aspects, the driving signal may be or may include a pulse. In this configuration, the peak power may include a pulse power, and/or the number of driving signals may include a number of pulses emitted. The individual data may thus be associated with the relevant aging factors for the driver circuit (temperature, power, etc.).

In case the light source 126 includes an emitter array, it may be assumed that each pixel is individually controlled by its own drive electronics (e.g., the driver circuit may include a plurality of (sub-)driver circuits, each associated with a respective emitter pixel).

The peak current or pulse power for an emitter pixel may be approximated to be identical to what has been provided by the power electronics. This quantity (as well as the number of pulses) may thus be recorded for the emitter array, and recording it for the power electronics may be dispensed with. The respective temperature(s) of the most critical component(s) in each pixel driver circuitry may be recorded. Depending on the required accuracy of the driver component temperatures, and the physical arrangement of drive electronics and emitter, it may be a sufficient approximation to assume the driver electronics always having a constant temperature difference compared to the emitter. Then the temperature recording for the transmitter power electronics may be dispensed with (and hence any recording pertaining to the drive electronics) and memory space may be saved. Illustratively, the temperature of the driver circuit may be determined (e.g., calculated, for example by the one or more processors 102) based on the temperature of the light source 126 (as a difference with a constant temperature).

In various aspects, the LIDAR module 100 (the one or more components 104) may include a light detection device 128 (also referred to herein as receiver). The light detection device 128 may be configured to detect light from the field of view of the LIDAR module 100. The light detection device 128 may include a detector circuit 130 configured to provide a detected light signal (e.g., configured to convert light 136 received at the detector circuit 130 into an analog signal, such as in a (photo) current). As an example, the detector circuit 130 may include at least one photo diode. The at least one photo diode may be configured to generate an analog signal (e.g., a photo current) in response to a light signal 136 impinging onto the at least one photo diode. As examples, the photo diode may include at least one of a PIN photo diode, an avalanche photo diode (APD), a single-photon avalanche photo diode (SPAD), or a silicon photomultiplier (SiPM).

The individual data related to aging events experienced by the light detection device 128 may represent at least one of: a time during which the light detection device 128 is operating; a temperature of the detector circuit 130 (e.g., a temperature of the detector circuit 130 being above or below the predefined threshold temperature); an amount of received light; a power of received light; and/or a bias voltage provided at the detector circuit 130 (e.g., at the at least one photo diode). The received light 136 may include light 134 emitted by the LIDAR module 100, e.g. by the light emission system 124, and may include background light (ambient light). The portion of the received light 136 including the light 134 emitted by the LIDAR module 100 (e.g., reflected back towards the LIDAR module 100 by an object in the field of view), e.g. received light pulses, may have less optical power (and/or irradiation) compared to background light, e.g. compared to strong ambient light (sunlight) falling on the detector circuit 130. In some aspects, the one or more processors 102 may be configured to determine (e.g., calculate) a time of flight of the light 134 (e.g., of a light pulse) emitted by the light emission device 124 and received at the light detection device 128. The measurement of the time of flight may provide an understanding of the field of view of the LIDAR module 100, e.g. the location of an object (based on the emitted light reflected back by the object), the speed of an object, etc.

In various aspects, the detector circuit 130 may include a plurality of detector pixels (e.g., each associated with a respective photo diode), e.g. a detector array including a plurality of detector pixels. In this configuration, the individual data related to aging events experienced by the light detection device 128 may, additionally or alternatively, represent at least one of: an individual temperature of at least one detector pixel (e.g., a temperature of the photo diode associated with the pixel); a number of light pulses received by at least one detector pixel; a peak power of a light pulse received by at least one detector pixel; and/or a bias voltage provided to the pixel (e.g., a bias voltage of the associated photo diode).

The detector circuit 130 may include receiver electronics configured to generate and control the bias voltage provided at the detector circuit (e.g., the bias voltages provided at the detector pixels). In some aspects, the bias voltage(s) may be known (to the receiver electronics, which may transmit the information to the one or more processors 102), and its measurement may be dispensed with.

The individual data related to the light detection device 128 may be associated with the relevant aging factors for the light detection device 128 (e.g., temperature, received optical power, etc.), in accordance with the aging mechanisms for the light detection device (e.g., the processes in the semiconductor of the photo diode, the deterioration of electrical connection, the deterioration of the receiver electronics, as examples).

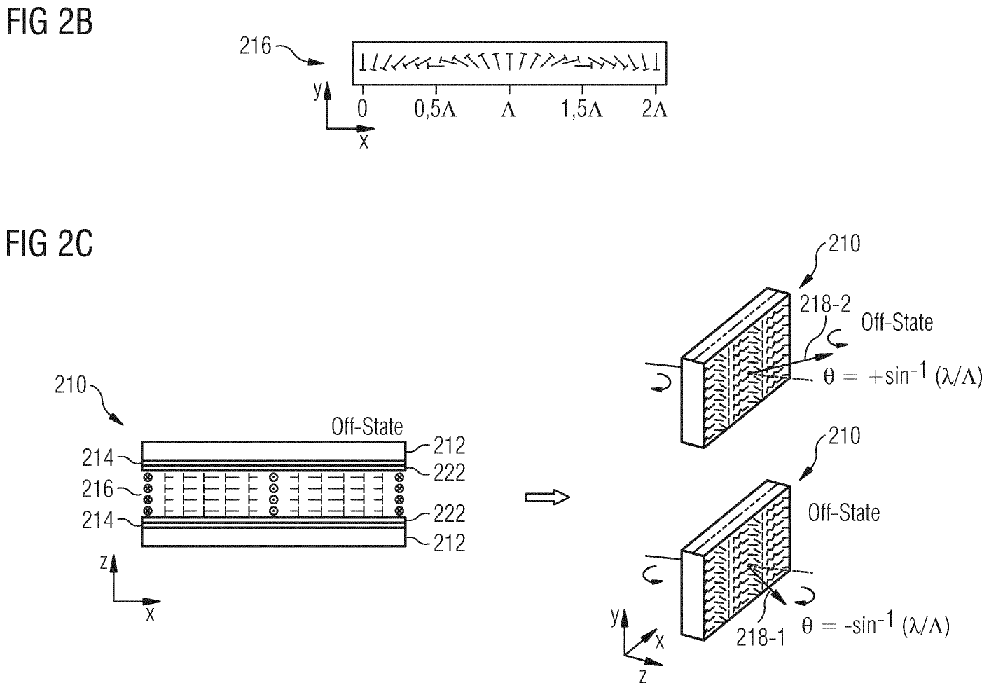

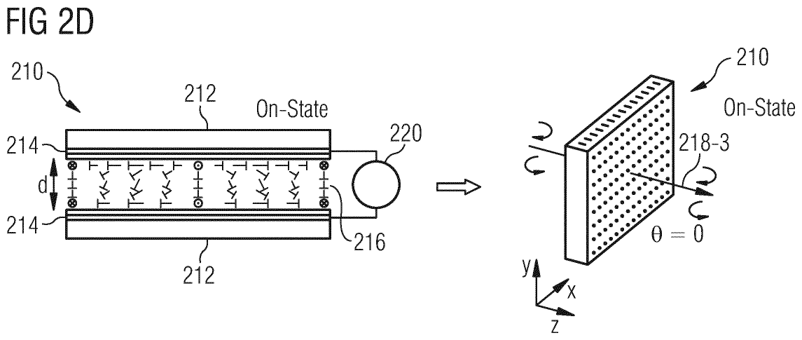

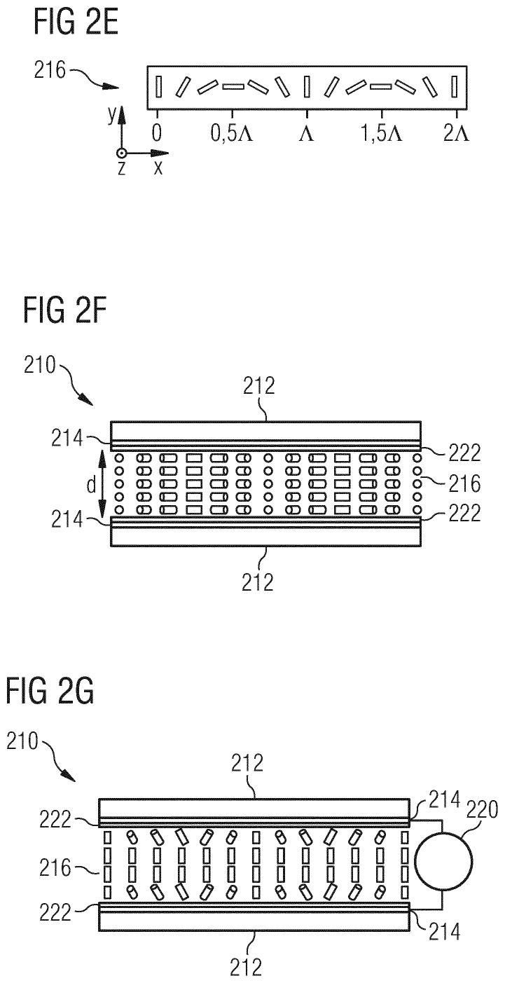

In various aspects, the LIDAR module 100 (the one or more components 104) may include one or more optical components 132 (illustratively, emitter optics and/or receiver optics, also referred to herein as one or more optical elements 132). The one or more optical components 132 may be configured to direct emitted light 134 towards the field of view of the LIDAR module 100, and/or may be configured to collect light from the field of view of the LIDAR module 100 (and direct light 136 towards the light detection device 128). The one or more optical components 132 may include, as examples, one or more lenses, one or more mirrors, a beam steering stage (e.g., including one or more beam steering devices, such as one or more MEMS mirrors and/or one or more LCPGs, see also FIG. 2A to FIG. 2G), and the like.

The individual data related to aging events experienced by the one or more optical components 132 may represent at least one of: a time during which the one or more optical components 132 are operating; a temperature of at least one optical component (e.g., temperatures of critical components, such as temperature of lenses, MEMS, LCPGs, etc.); a zoom status of at least one optical component; a number of light pulses passing through at least one optical component; a number of scanning operations performed with at least one optical component (e.g., in case of a beam steering device); an acceleration experienced by at least one optical component; a mechanical stress experienced by at least one optical component; and/or an optical power or an irradiation passing through at least one optical component. Illustratively, the individual data may represent the aging factors causing a loss of performance of the one or more optical components 132, e.g. an increased absorbance of light, a slower scanning speed, etc., in accordance with the related aging mechanisms (e.g., a deterioration of the transmission, a deterioration of the mechanical parts of a MEMS mirror, a deterioration of the liquid crystals of a LCPG, as examples).

For an optical component (e.g., one of the one or more optical components 132), the temperature may be measured at its mounting points, e.g. the temperature of the respective lens holder or mirror holder may be measured. A thermal model may be used (e.g., by the one or more processors 102) to assess the temperature inside the component, e.g. the lens or the mirror, based on the temperature of the respective holder. The aging is most critical inside the component (due to caused increase of imaging artefacts caused by component aging), and in case of optical components with high power throughput, temperatures are typically the highest.

The zoom status of at least one optical component may include, as an example, a zoom status of a (e.g., motorized) lens. The measuring of a zoom status may include a recording of a distance or an angle value over time, depending on the used technology. In some aspects, the zoom status may be recorded synchronously with the optical power. This may provide gaining knowledge of which optical component at what zoom status was exposed to how much optical power.

The number of scanning operations performed with at least one optical component may include, for example, a number of scanning operations performed for a MEMS mirror and/or a LCPG component (see also FIG. 2A to FIG. 2G). Depending on the used technology the number of scanning operations may include a number of MEMS cycles or a number of LCPG switching operations. Illustratively, in some aspects, the one or more optical components 132 may include a MEMS mirror (configured to scan a field of view of the LIDAR module 100 with the emitted light), and the individual data related to aging events experienced by the one or more optical components 132 may describe a number of scanning operations performed with the MEMS mirror. In some aspects, the number of scanning operations may be derived from the operating hours of the component (e.g., the operating hours of the MEMS).

The optical power or the irradiation “passing through” at least one optical component may include, for example, optical power or irradiation provided by the light emission device 124 (e.g., by the light source 126, e.g. the laser) and flowing through the at least one optical component (e.g., through each critical component in the transmission path). In some aspects, the optical power or the irradiation passing through at least one optical component may be estimated based on the (recorded) optical power emitted by the light emission system 124 (by the light source 126). Even measuring only the optical power of the source, an accurate estimation of the optical power flowing through the respective optical elements may be provided, e.g. by means of optical simulation. Also, typically the power absorption in optical elements is very small compared to the non-absorbed power (which includes optical power of reflected, “going through”, and scattered light), so that it may be sufficient to estimate the absorbed quantity of light with a lower fidelity, or it may even be possible to neglect this quantity entirely.

In some aspects, in addition or in alternative to the optical power and/or irradiation, the temporal optical power density distribution over time may be recorded (and used as individual data), e.g. a recording of optical power per wavelength over time may be performed. This configuration may be provided, for example, in case the light passing through the one or more optical components (in the transmitter path) has a broad wavelength distribution (e.g., as it may be the case for sunlight, or as provided by automotive front-lights).

The optical power or irradiation caused by background light, e.g. sunlight, and flowing through the one or more optical components 132 (e.g., in the transmitter path and receiver path) may be relevant for the optical components close to the outside of the LIDAR module 100. For example, it may be relevant for a LCPG (see also FIG. 2A to FIG. 2G) that is (by design) located close to the outside of the module (for example, it may be the last optical element in the light path of emission, and it may be the first optical element in the light path of reception). In various aspects, the one or more monitoring sensors may include an ambient light sensor configured to measure a level of ambient light experienced by the one or more optical components 132. The suitable ambient light sensor may provide measuring the impact caused by sunlight.

An example of mechanical stress (e.g., mechanical shock) experienced by the one or more optical components 132 may include an event of strong physical acceleration, for example caused by a hit or fall (in other words, a drop). Optical components may be impacted significantly by mechanical shock.

In various aspects, as described above, the LIDAR module 100 (the one or more components 104) may include a power supply circuit 118 configured to provide power to the LIDAR module 100 (e.g., power to the other components 104). The individual data related to aging events experienced by the power supply circuit 118 may represent at least one of: a time during which the power supply circuit 118 is operating; a temperature of the power supply circuit 118 (e.g., a temperatures of critical components, such as a temperature of switching transistor(s), rectifier diode(s), input and output capacitors, inductive components, as examples); a number of power cycles of the power supply circuit 118; an input voltage or an input current of the power supply circuit 118; an output voltage or an output current of the power supply circuit 118 (in some aspects, the power supply circuit 118 may provide multiple stabilized voltages, in this configuration multiple output currents may be recorded); a number of temperature cycles experienced by the power supply circuit 118; and/or an acceleration experienced by the power supply circuit 118.

Illustratively, the individual data may represent the aging factors causing a loss of performance of the power supply circuit 118, e.g. a reduced power, a slower reaction time, etc., in accordance with the related aging mechanisms (e.g., a deterioration of the electronics, a deterioration of the connections, as examples).

A power cycle of the power supply circuit 118 may be detected as part of the power supply circuitry and a respective counter (“bucket”) may be updated, e.g. increased by one (see also FIG. 3A to FIG. 3G). The number of power cycles may be a “global quantity” (e.g., may be part of the global data) as outlined above, as it may be relevant not only for the power supply circuit 118, but for the entire LIDAR module 100.

In various aspects, as described above, the LIDAR module 100 (the one or more components 104) may include the control circuit 106. The individual data related to aging events experienced by the control circuit 106 may represent at least one of: a time during which the control circuit 106 is operating; a temperature of the control circuit 106 (e.g., a temperatures of critical components, such as a temperature of integrated circuitry (IC) like microcontrollers, memory ICs and communication ICs including for example communication bus driver ICs); temperature cycles experienced by the control circuit 106; and/or an acceleration (mechanical stress) experienced by the control circuit 106. Illustratively, the individual data may represent the aging factors causing a loss of performance of the control circuit 106, e.g. a slower operation, a reduced computational efficiency etc., in accordance with the related aging mechanisms (e.g., a deterioration of the electronics, a deterioration of the connections, as examples).

In some aspects, the critical components of the control circuit 106 may include built-in temperature sensing circuitries that may be read out using respective registers. In this configuration an additional monitoring sensor to sense the temperature of the control circuit 106 may be dispensed with, and also thermal modelling to estimate component temperature may be dispensed with.

The critical components of the control circuit 106 may be integrated circuits, e.g. where the die is internally connected via wire bonding to pins of the package, possibly also having lots of pins (so called fine-pitch components), and may thus be quite delicate and vulnerable to mechanical shock as well as to the afore-mentioned temperature cycles.

FIG. 2A to FIG. 2G illustrate in more detail an example of optical component for a LIDAR module, e.g. for the LIDAR module 100.

FIG. 2A shows a beam steering stage 200, e.g. for use in a LIDAR module (e.g., the LIDAR module 100 may include the beam steering stage 200) in a schematic view according to various aspects.

A particular example of an optical component (e.g., as one of the one or more optical components 132 of the LIDAR module 100) is a liquid crystal polarization grating (LCPG) (see FIG. 2B to FIG. 2G). Liquid crystal polarization gratings (LCPGs) may be used for non-mechanical laser beam steering making them inherently suitable for LIDAR applications. In some aspects, a LCPG may be the only optical component provided for beam steering in a LIDAR module. In other aspects, a LCPG may be used in conjunction with other beam steering mechanisms, like a MEMS-based scanning concept.

Non-mechanical beam steering may be performed in two stages, as shown in FIG. 2A: the beam steering stage 200 may include a coarse steering module 202 (illustratively, a coarse steering technique), e.g. using an LCPG approach (e.g., the coarse steering module 202 may include a LCPG), combined with a fine steering module 204, e.g. based on a MEMS approach (e.g., the fine steering module 204 may include a MEMS mirror). The coarse steering module 202 and the fine steering module 204 may control the emission direction of light into a field of view 206 (also referred to herein as field of regard) of the beam steering stage (e.g., a field of view of the LIDAR module). As a numerical example, the field of view 206 may have an angular extension in the horizontal/azimuth (AZ) direction in the range from −60° to +60°, for example from −40° to +40°, with respect to an optical axis of the beam steering stage 200 (e.g., an optical axis of the coarse steering module 202). As another numerical example, the field of view 206 may have an angular extension in the vertical/elevation (EL) direction in the range from −20° to +20°, for example from −12° to +12º, with respect to the optical axis of the beam steering stage 200.

FIG. 2B to FIG. 2G illustrate in more detail various aspects of a LCPG.

FIG. 2B and FIG. 2E each shows a top view of a liquid crystal polarization grating 210 in a schematic view according to various aspects. FIG. 2C, FIG. 2D, FIG. 2F, and FIG. 2G each shows a side/perspective view of the liquid crystal polarization grating 210 in a schematic view according to various aspects. The structure and the operation of a LCPG may be known in the art, here a brief description is provided to illustrate the relevant aspects for the predictive maintenance strategy.

A LCPG (e.g., the LCPG 210) may have many favorable capabilities making it suitable for LIDAR applications, such as a light weight design, large aperture, wide steering angles, low loss of laser power, and fast switching speed to aim the beam. On the downside, LCPG beam-steering devices are not yet widely commercially available or fully characterized for demanding applications, like the automotive realm.

A LCPG 210 (also referred to herein as LCPG stage) may include a glass substrate 212 (e.g., a first glass substrate and a second glass substrate), a photo-alignment layer 222 (e.g., a first alignment layer and a second alignment layer), one or more electrodes 214 (e.g., two electrodes 214), e.g. a first indium tin oxide (ITO) layer and a second indium tin oxide layer, and a liquid crystal layer 216 (for example, a nematic liquid crystal layer). The liquid crystal layer 216 (e.g., having a thickness d) may be polymerized to lock in a desired optical pattern. The liquid crystal layer 216 may be sandwiched between the alignment layers 222 (and the electrodes 214).

The liquid crystal layer 216 (e.g., a nematic liquid crystal (LC) film) may have a continuous periodic pattern that can be classified as a Polarization Grating (PG). The liquid crystal layer 216 may be understood as the core of the LCPG 210. Unlike amplitude and phase gratings, a polarization grating operates by modulating the polarization of light.

The liquid crystal layer 216 may provide steering of light impinging onto the LCPG 210, based on the polarization of the light and on the grating period. Illustratively a LCPG (e.g., the LCPG 210) may be a birefringent device that steers light to one of two deflection angles, depending on the polarization handedness of the light impinging onto the LCPG (illustratively, the polarization handedness of the input light). As shown in FIG. 2C and FIG. 2F (for the director profile), without any control signal applied (an OFF state), the liquid crystals may have an orientation providing that light may be steered into a first direction 218-1 (m=+1) in case the polarization has a first handedness (e.g., in case the light is left-handed circular polarized, counter-clockwise circular polarized), and may be steered into a second direction 218-2 (m=−1) in case the polarization has a second handedness (e.g., in case the light is right-handed circular polarized, clockwise circular polarized)

In some aspects, the LCPG 210 may include integrated electrodes, which may enable switching operation. A switchable LCPG essentially may switch between three different steering states. As shown in FIG. 2D and FIG. 2G (for the director profile), by applying a control signal to the liquid crystal layer 216 (e.g., a voltage greater than a threshold voltage, V>Vth, for example by a voltage source 220), the alignment of the liquid crystals may be controlled (an ON state) to another orientation so that light may pass through the LCPG without being steered (into a third direction 218-3, m=0), independently of the handedness of the polarization. As shown in FIG. 2B and FIG. 2E (for the director profile), the alignment of the liquid crystals of the liquid crystal layer 216 may be varied to provide a desired grating period (and a desired beam steering), e.g. varying from 0 to 2λ, where λ may be a predefined grating period.

In some aspect, the LCPG 210 may include a plurality of stacked LCPG stages. Each element in the stack may be (individually) switched off, added, or subtracted from the net deflection. The stack (even a relatively small stack, e.g. with three LCPGs) may provide a large set of deflection angles, enabling a wide range of angles in two dimensions to be achieved with a small number of stack elements.

With respect to aging, limited information is currently available for LCPGs, in particular considering the environmental conditions in demanding applications, like the automotive realm. The relevant aging factors that may impact the aging of LCPG devices may be the temperature, the irradiation of light, and/or the switching cycles (of the liquid crystals). Illustratively, in the case that the one or more optical components of a LIDAR module (e.g., the one or more optical components 132 of the LIDAR module 100) include a LCPG, the individual data related to aging events experienced by the one or more optical components may represent at least one of: an optical power or an irradiation of light (e.g., laser light, or sunlight) received at the LCPG (from the field of view of the LIDAR module and/or from a light emission device of the LIDAR module, e.g. from the light emission device 124); a temperature of the liquid crystals of the LCPG; and/or a number of switching cycles of the liquid crystals of the LCPG.

Considering the temperature, especially events exceeding the nematic range of the liquid crystal (e.g., events with a temperature T outside the range from −20° C. to +60° C.) may be critical. In some aspects, the number of occurrences and/or the respective time duration in which such temperature range is exceeded (e.g., the occurrences of T<−20° ° C. or T>+60° C.), may be recorded and used to estimate the aging of LCPG (e.g., by the one or more processors 102). The viscosity and the elastic constant may also be affected by the temperature, which thus may be a relevant parameter to take into account for the analysis of the remaining lifetime of LCPGs.

The irradiation of light from the outside, e.g., sunlight in the ultraviolet range, and the irradiation of light from the inside (e.g., laser light emitted by the LIDAR module) may, in the long term, impact the properties of the used LCPG components, materials, and boundary surfaces. For example, the polymer chains (chain scission) may degrade the LCPG performance. Considering the irradiance from the sun, a LIDAR module (e.g., the LIDAR module 100) may include an ambient light sensor configured to measure the irradiation of sunlight at the LCPG. In addition, the exposure time may be measured, and these parameters may be used as a basis for an aging model. Considering the irradiation caused by light emitted by the LIDAR module (e.g., irradiation by a laser), the number of operating hours, and/or the number of emitted light pulses (e.g., laser pulses) may be used as a measure to evaluate the aging progress of the LCPG.

As the LCPG is constantly switching, it experiences a huge number of switching cycles during its lifetime, and a degeneration over the lifetime cannot be excluded (although there are no long-term studies currently available). The number of switching cycles and/or the device operating hours may be used as a basis when estimating the LCPG aging progress.

In light of the discussion above, a large amount of data describing the aging of the components of a LIDAR module may be used for the assessment of the remaining lifetime of the LIDAR module and its components. Various aspects are related to an improved strategy enabling the recording and storing of such a large amount of data in an efficient and cost-effective manner.

In the following, a strategy for implementing the recording and storing of the information related to the aging events experienced by a LIDAR module and its components (e.g., by the LIDAR module 100 and the one or more components 104) is described, e.g. for recording and storing the global data and individual data to be used for the estimation of the remaining lifetime of the LIDAR module and its components

A conventional time-series recording would either lead to running out of memory quickly, or to a significant increase in product price, in view of the required efforts to record the above list of quantities over the product's lifetime.

In various aspects, data compression approaches (either lossless or lossy) may be employed to efficiently store measurements or time-series recordings, e.g. temperature readings. Data compression may be known in the art, although for different types of applications, and various aspects may be based on the realization that such approach may provide a strategy applicable in LIDAR applications (e.g., in a LIDAR module) for enabling the estimation of a remaining lifetime. Such approach may require less memory space when compared to storing time-series measurements on a sample-by-sample approach.

Instead of continuously recording a value in a periodic manner (e.g., every second), the value may be recorded together with the time period in which the value was present before the variation. Instead of the value, the difference (in other words, the delta) with respect to the previous value (the previously stored value) may be stored. This may allow using less bits for the delta compared to the number of bits that recording the absolute value would require. The approach provides using less memory, but is limited in case the signal undergoes strong variations.

In case of noisy values (as it may typically be the case with real world measurements) the new value is only recorded in case a significant variation occurred, e.g. in case the variation is greater than a predefined threshold (e.g., at least 1% of the value's maximum range, or at least 2% of the value's maximum range, or at least 5% of the value's maximum range, as examples). The predefined threshold may be adapted in accordance with the available memory space, e.g. the threshold may be increased to further reduce the memory space required. This may turn the initially lossless approach in a lossy or irreversible approach, giving up some accuracy on how precisely the signal may be reconstructed.

However, such approaches may still generate an excessive amount of data in many use cases, requiring an amount of memory space that renders the approach unfeasible for cost-sensitive applications. There is thus a need for an adapted approach that allows storing data in a more efficient manner.

Various aspects are related to an adapted approach for recording and storing the information related to the aging events experienced by a LIDAR module (e.g., by the LIDAR module 100). The adapted approach is referred to herein as “bucket approach”. A “bucket” may be understood as a memory sub-portion associated with an “aging-relevant event” of the respective component (in some aspects, a bucket may be or may include a counter, as described in further detail below). A bucket may be initially empty (e.g., a counter may have an initial value of zero) and may be updated (e.g., increased) in case the component was exposed to the respective “event”. As an example, the event may include a temperature cycle or a mechanical shock (an event of strong physical acceleration potentially caused by a hit or fall/drop), as described above. The “bucket approach” may be implemented with a little memory space and little computational resources, thus providing advantageous properties for LIDAR applications (in particular for the automotive field). The computational effort to update a bucket (e.g., to increase a counter by one, or in other aspects to decrease a counter by one) may be negligible compared to the computational efforts needed for data-compression algorithms, for example on time-series data/recordings.

The bucket approach is described herein with particular reference to its implementation in a LIDAR module. It is however understood that it may also be applied in other applications, in which a recording of events impacting the lifetime of a device or component may be beneficial. Illustratively, the bucket approach may be implemented also by one or more processors and memory devices of other types of modules.

FIG. 3A shows a memory portion 300 in a schematic view according to various aspects. The memory portion 300 may be a portion of a memory device of a LIDAR module (e.g., of one of the one or more memory devices 108 of the LIDAR module 100). The memory portion 300 may include one or more memory sub-portions 302 associated therewith (e.g., a first sub-portion 302-1, a second sub-portion 302-2, and a third sub-portion 302-3 in the exemplary configuration in FIG. 3A).

A memory portion 300 may be understood as a part of the space available in a memory device. A memory sub-portion 302 may be understood as a part of the space associated with a memory portion 300. Illustratively, a bucket may be understood as a memory sub-portion, and a plurality of buckets associated with a same aging mechanism and/or with a same component (e.g., an array of buckets) may be understood as a memory portion.

At least one component of a LIDAR module (e.g., at least one, or each, of the one or more components 104 of the LIDAR module 100, for example the subset of relevant components) may have one or more memory portions 300 (illustratively, one or more arrays of buckets) associated therewith, for storing the aging data associated with that component. The one or more memory portions 300 may be provided in one or more of the memory devices of the LIDAR module (e.g., in one or more of the memory devices 108 of the LIDAR module 100).

In various aspects, a component may have a single memory portion 300 associated therewith (illustratively, a single array of buckets), and the single memory portion 300 may include a plurality of sub-portions 302 (illustratively, a plurality of buckets), each sub-portion 302 associated with a respective aging mechanism of the one or more aging mechanisms associated with the component. The relevant aging aspects for the component may be represented by the content of the respective memory sub-portion 302. Only as an example, in case the component is a laser diode, a first sub-portion 302-1 may be associated with the processes inside the semiconductor, a second sub-portion 302-2 may be associated with the optical components, and a third sub-portion 302-3 may be associated with the electrical connections.

Each sub-portion 302 of the single memory portion 300 may include a counter value. In the configuration with a single memory portion 300 per (relevant) component, the counter value may have, as initial value, a value representing an expected lifetime for that component (e.g., determined at the fabrication stage), and may be implemented as a count-down counter (e.g., decreasing for each aging event to indicate a decrease in the remaining lifetime). It is however understood that an implementation with a counter that is increased may also be provided (e.g., starting at zero and getting increased for each event).

The one or more processors of a LIDAR module (e.g., the one or more processors 102 of the LIDAR module 100) may be configured to receive an indication that an aging event associated with an aging mechanism of the component has occurred (e.g., via the sensor data provided by one or more monitoring sensors of the LIDAR module, or via information already available to the one or more processors, as described above), and may be configured to update (e.g., decrease, or to increase) the counter value of the respective sub-portion 302. Illustratively, the component may have one or more relevant aging mechanisms that may be considered by updating the content of the respective sub-portion 302 (the respective bucket), in case an aging event relevant for that mechanism is experienced by the component. Only as an example, in the case that the counter is a count-down counter, the bucket counter for the optical components may be decreased for each emitted laser pulse, or for a number of emitted laser pulses. As another example, the bucket counter for the electrical connections may be decreased for a voltage provided at the laser diode exceeding a predefined threshold voltage.

The approach based on a single array of buckets for a component may provide estimating the remaining lifetime of the component without relying on aging models, thus eliminating the need for updating/upgrading aging models. This approach provides using less memory and less computational efforts to determine the remaining product life.

A bucket per aging mechanism (per component/sub-system etc.) may be implemented with each bucket used as a counter (e.g., as a countdown counter as described above, or a count-up counter). Every time a respective aging event occurs (e.g., a shock, or an operation of the product for a certain time at a specific temperature, or any one of the other examples described above for the possible components) the respective bucket may be updated, e.g. decreased by a predefined amount (for example, by one) for a count-down counter (or increased by a predefined amount, e.g. by one, for a count-up counter).

The value of the counter of a sub-portion 302 (the bucket count) may provide an immediate indication of the remaining lifetime of the associated component, e.g. the value of the counter may correspond to the remaining lifetime in case the respective bucket and aging mechanism was the limiting one for the lifetime of the component. The one or more processors of a LIDAR module (e.g., the one or more processors 102) may be configured to estimate the remaining lifetime of the component based on the counter values of the sub-portions 302 associated with the component. For example, in the case that the counters are implemented as count-down counters, the one or more processors may be configured to determine the estimation of the remaining lifetime of the component in accordance with the smallest value of the counters associated with that component (the smallest value may be the limiting factor). As another example, for both count-down and count-up counters, the one or more processors may be configured to associate a counter value with a corresponding remaining lifetime (e.g., via a look-up table). In various aspects, a lifetime query to the LIDAR module may return the smallest count of all buckets (e.g., the one or more processors may be configured to transmit, e.g. in the message 112, the smallest counter value associated with a component in response to a received request). In other aspects, e.g. in case of count-up counters, the lifetime query to the LIDAR module may return the greatest count of all buckets.

In various aspects, the LIDAR module (e.g., the one or more processors) may be configured to monitor the values of the counters of the sub-portions 302 associated with the components of the LIDAR module (illustratively, all bucket values), and may be configured to provide an indication (e.g., to raise an alert) in case the smallest value drops below a certain threshold (or in case the greatest value increases above a certain threshold), for example prompting a replacement of the module or of the component to prevent a failure during operation.

In other aspects, a more structured configuration for the memory portion(s) associated with a component may be provided, to record and store the aging data with an increased level of granularity, thus allowing a more precise reconstruction (and a more precise estimation of the remaining lifetime), as described in relation to FIG. 3B to FIG. 3G.

FIG. 3B shows a memory portion 310 associated with a component of a LIDAR module (e.g., with one of the one or more components 104 of the LIDAR module 100) in a schematic view according to various aspects.

The memory portion 310 may be related to (in other words, associated with) an aging mechanism of the one or more aging mechanisms associated with that component. Depending on the component with which the memory portion 310 is associated, it may be related to one of the aging mechanisms described above, for example with the processes inside the semiconductor in case of a laser diode, with the switching of liquid crystals in case of a LCPG, with the absorption of light in case of a lens, etc. With respect to the configuration discussed above, it is the entire memory portion 310 to be associated with an aging mechanism, and not only a sub-portion.

A component may have more than one memory portion 310 associated therewith, as a function of the relevant aging mechanisms for that component.

The memory portion 310 (e.g., each memory portion associated with a component) may include a plurality of sub-portions 312, e.g. 16 sub-portions 312-1 to 312-16 (16 buckets) in the exemplary configuration in FIG. 3B (B_dr1 to B_dr16). The number of sub-portions 312 may be selected in accordance with a level of granularity to be provided for the respective aging mechanism. As a numerical example, the memory portion 310 (e.g., at least one of the memory portions associated with a component) may include a number of sub-portions 312 in the range from 2 to 16, for example in the range from 4 to 8. In the configuration with a memory portion associated with an aging mechanism, the respective sub-portions may be implemented as count-up counters (e.g., increased upon recording an aging event). In the following, such configuration is described, in which the recording of an event may include increasing a counter value by a predefined amount, e.g. by one. It is however understood that an implementation with a count-down counter that gets decreased (e.g., by one) upon recording an event may also be provided, and the following description may apply in a corresponding manner to the case in which count-down counters are used.

The memory portion 310 (and each sub-portion 312) may have a memory address 314 associated therewith, via which the memory portion 310 (and the sub-portions 312) may be accessed by the one or more processors of a LIDAR module (e.g., by the one or more processors 102 of the LIDAR module 100). Illustratively, the memory map of the memory portion 310 may provide the address to the individual Bytes of the respective buckets in the memory device(s) of the control circuit of the LIDAR module, e.g. each sub-portion 312 may have a respective address 314.

In the exemplary configuration shown in FIG. 3B, the address of the one-dimensional array of 16 elements, the buckets B_dr1 to B_dr16 (“buckets for counting drops”), may start, only as an example, at 0x13500 and may end at 0x1351F (where 0x indicates a notation of the address in a hexadecimal system). The memory address of a memory portion or sub-portion may alternatively be represented with a decimal notation. The hexadecimal notation may provide a more efficient description of memory addresses.

Each sub-portion 312 may be associated with a respective range of a value of an aging factor (a parameter or quantity) associated with that component, e.g. the first sub-portion 312-1 with a first range, the second sub-portion 312-2 with a second range, etc. Illustratively, each sub-portion 312 may be provided for recording (and storing) the aging events occurring in a particular range for a relevant aging factor (a relevant parameter) for the aging of the component (e.g., a temperature, an acceleration, a voltage, a current etc.).

For example, as described above, an aging factor associated with a component may include at least one of: a temperature of the component; a voltage provided at the component; a current provided at the component, an optical power passing through the component; and/or an acceleration experienced by the component. It is understood that the aging factors described herein are exemplary, to illustrate the principles of the predictive maintenance strategy, and other aging factors relevant for the aging of a component may be considered. The range of a value associated with the component is defined by the aging factor of interest, e.g. the range may include at least one of a temperature range, a voltage range, a current range, an optical power range, and/or an acceleration range, as examples.

As an exemplary case, the sub-portions 312 of the memory portion 310 may be associated with the acceleration (the mechanical shock) experienced by the component (the buckets may be for recording a drop, B_dr).

The sub-portions 312 (the buckets) may be for counting events of the component being exposed to the aging factor of interest, e.g. to strong acceleration. The different sub-portions 312 may provide differentiating between different intensity levels for the parameter (e.g., intensity in 17 levels the exemplary configuration in FIG. 3B, using 16 thresholds). The mapping of the magnitude of the parameter (e.g., acceleration, shock level) is illustrated in FIG. 3C and FIG. 3D. As described in further detail below, an aging event may lead to the update of one of the sub-portions 312 as a function of the intensity level of the aging event. In some aspects, a (e.g., each) sub-portion 312 may include a counter value representing the number of aging events occurred at a parameter value (at an intensity level of the aging factor) falling in the range associated with the sub-portion 312.

An aging event experienced by a LIDAR module or a component may be recorded in the one of the sub-portions 312 (or in more than one sub-portion 312 if impacting more than one component) as a function of the intensity level (also referred to as intensity value) of the aging event (e.g., as a function of the respective temperature, voltage, optical power, acceleration, etc.). The one or more processors of a LIDAR module (e.g., the one or more processors 102) may be configured to receive an indication that an aging event associated with a component occurred, and may be configured to record the aging event in a (first) sub-portion 312 associated with that component based on the parameter value (the intensity level of the aging factor) at which the aging event occurred. The one or more processors may be configured to update (e.g., increase) the counter value of the (first) sub-portion to record the aging event in the sub-portion.

In some aspects, overflow of the counter value of a sub-portion 312 may occur (e.g., in case a maximum number of aging events have already been recorded in that sub-portion). Possible approaches to deal with overflow will be described in further detail below, see for example FIG. 4. As a brief description, in case the one or more processors receive an indication that an aging event to be recorded in a sub-portion 312 (e.g., in the first sub-portion described above) occurred, the one or more processors may be configured to verify whether the counter value of the sub-portion 312 has reached a threshold counter value (in some aspects, a maximum counter value), and record the aging event in the sub-portion (only) in case the counter value has not reached the threshold counter value (illustratively, only in case the recording of the event would not cause an overflow of the bucket). As an example of a possible approach, the one or more processors may be configured not to update (e.g., not to modify) the counter value of the sub-portion 312 in case the counter value is (already) equal to the threshold counter value.

FIG. 3C and FIG. 3D each shows a respective graph 320c, 320d illustrating the assignment of a respective range to a sub-portion (e.g., to one of the sub-portions 312).

The sub-division of a memory portion 310 into the one or more sub-portions 312 may be a function of an expected behavior of the associated component. Illustratively, the number of sub-portions 312, the respective size, and the respective range of the aging factor may be selected as a function of expected aging events experienced by the component during its lifetime.

The graphs 320c, 320d may represent, on the horizontal axis 322c, 322d an intensity level of an aging factor, and on the vertical axis 324c, 324d a number (or index) of a sub-portion. Illustratively, the graphs 320c, 320d may show a plurality of intervals 326c, 326d (e.g., 16 intervals in this exemplary configuration, a1 to a16), in other words a plurality of ranges of intensity level, each associated with a respective sub-portion (a respective bucket). The graphs 320c, 320d show that the intensity levels may be adapted according to the expected events for the component, e.g. the spacing between intervals, the size of the intervals, the intensity levels, etc. Each interval may start at a respective threshold level (a16, a15, . . . , a1), and extend for a predefined range. The range of interest for the aging factor (e.g., for the acceleration in the exemplary case in FIG. 3C and FIG. 3D) may therefore subdivided in respective intervals, e.g. having equal sizes notated as “da” (FIG. 3C) or variable sizes (FIG. 3D).

In some aspects, a size (e.g., in bits, or in Bytes) of a sub-portion may be selected as a function of a probability of an aging event occurring in the respective range of the aging factor. In case of relatively higher probability, the sub-portion may have a greater memory size, and in case of relatively lower probability, the sub-portion may have a smaller memory size. Stated in a different fashion, a (first) sub-portion (e.g., B_dr16 in FIG. 3B) may have a (first) memory size greater than another (second) memory size of another (second) sub-portion, in case the probability of an aging event occurring at a parameter (aging factor) value in a (first) range associated with the (first) sub-portion is greater than a probability of an aging event occurring at a parameter value in another (second) range associated with the other (second) sub-portion.

In the exemplary case of mechanical shock, from the anticipated use of the product it may be more likely that there will be more shocks with low amplitudes compared to shocks with high amplitude. Most shocks experienced by a component during its lifetime may have acceleration levels between 0 (no or small impact) and a15 (assuming a15 as the second smallest threshold value among the threshold values in FIG. 3C and FIG. 3D). From the standpoint of the aging of a LIDAR module, only shocks exceeding the threshold a16 (the smallest threshold in FIG. 3C and FIG. 3D) may create any noticeable impact, and any shocks with intensities below an acceleration level of a16 may be completely ignored (illustratively, the smallest threshold value associated with the sub-portions may be selected such that only aging events having a measurable impact are recorded). Shocks with an amplitude level of a15 or higher may be considered “serious” and their amplitude level may actually have an influence on how much aging occurs on average with each shock. Whenever a shock with a respective acceleration occurs the associated bucket according to the FIG. 3C or FIG. 3D gets updated (e.g., increased by one).

The highest threshold (e.g., the highest acceleration threshold a1 in FIG. 3C and FIG. 3D) may be selected as a function of an expected failure of the component, e.g. may be chosen to be at a level where it is quite likely that the module will be non-functional after a single event at that intensity (e.g., a shock with an intensity of a1 or higher). Therefore, events at the highest threshold (and/or at the immediately preceding threshold), such as shocks higher than a1 as well as shocks falling into the interval right below (shocks higher than a2), should not occur at all, and a size of the respective sub-portions may be relatively small (e.g., a “bucket size” of 0 up to 255 counts corresponding to 1 Byte of memory may be chosen). In FIG. 3B, for example, the buckets B_dr1 and B_dr2, associated with the thresholds a1 and a2, may have the smallest size, e.g. 1 Byte. The sub-portions associated with the more (and most) probable intensity ranges for aging events may have the greater (or greatest) memory size. Considering the example in FIG. 3C and FIG. 3D, the vast majority of all shocks exceeding the lowest threshold a16 will have an amplitude of less than a15. The sub-portion associated with the smallest threshold (e.g., the bucket B_dr16 in FIG. 3B) may have the greatest size among the sub-portions, e.g. a size of 4 bytes enabling the counting up to 4294967296 (=2\hat{ }(4*8)−1) which is considerably larger compared with the other buckets (which may have, as an example a size of 2 Bytes and hence allowing a counting of up to 65535 (=2\hat{ }(2*8)−1). In some aspects, a sub-portion may have a memory size in the range from 1 Byte to 8 Bytes (selected as a function of the associated range, as discussed above).

By way of illustration, it may be stated that the “bucket size” may vary within the same array of buckets and it may be chosen based on application knowledge, The applications knowledge may guide the consideration of how often certain events occur and how detailed the recording may be in order to provide a desired accuracy when it comes to assessing the aging of the module and/or predicting the remaining life.

In the exemplary configuration in FIG. 3C, the interval size “da” 328 (the dimension of a range associated with a sub-portion, e.g. the distance between adjacent threshold values) may be constant. In this configuration, the implementation of determining the right bucket may be implemented efficiently with a division as illustrated in the pseudo-code below. Illustratively, the constant interval size may provide an efficient assignment of an aging event to the respective sub-portion. Considering the exemplary case of acceleration, every time a shock is noticed by an accelerometer (e.g., as part of the control circuit 106, or transmitting sensor data to the control circuit 106) an interrupt may be thrown to the one or more processors (e.g., the one or more processors 102) of the control circuit, and the measured acceleration value may be read from the register (denoted with “ma”). The interrupt service routine ISR_shock servicing the respective interrupt is shown below, as an exemplary implementation:
BEGIN ISR_shock
   CLI( ) // disable interrupts, to ensure no side-effects
   IF ma<a16 THEN GOTO exit // ignore event if below threshold
   a:=ma−a15 // subtract lowest threshold a16 from measured value ma
   IF a<0 THEN INC_drBucket(16) // increment drop bucket number 16
      ELSE // shock had amplitude larger than a15
         n:=15−TRUNC(a/da) // calc. bucket number: decrease number from 15 by rounded down division of amplitude a by da
         IF n<1 THEN n:=1 // bucket 1 has to be used for all shocks with amplitudes larger than a1
         INC_drBucket(n) // increment drop bucket n
   exit: // the program code following this label gets executed in any case regardless of amplitude
   CIF(if_shock) // clear interrupt flag if_shock. This flag gets set every time a shock is detected by the accelerometer, and needs to be cleared
   SEI( ) // enable interrupts again, as this one is serviced
END ISR_shock

The routine INC_drBucket illustrated in the above pseudo-code may get the bucket number (also referred to as bucket index) passed as an argument. With this number, the routing (e.g., implemented by the one or more processors 102) may first determine the starting address of the bucket (0x13600 to 0x1361C, as an example) and the size (e.g., 1, 2 or 4 Bytes) of the corresponding bucket before incrementing the respective counter unless an overflow would occur. In case an overflow of the bucket may occur, the routine does nothing (the dealing with overflow situations will be described in further detail below, with implementations of buckets as “non-overflow up counters”), unless the approach of “cascaded buckets” is implemented (see for example FIG. 4). It is understood that the routine may be applied to any type of aging factor for the recording of the associated events.

In some aspects, the interval “da” may be chosen to be a power of 2 of the resolution of the intensity level (e.g., of the acceleration level). This may provide a faster determination of the bucket number by using
(a) integer instead of float variables/operations; and
(b) shift instructions; e.g. if “da” equals 128 then instead of using a truncated division by 128 (=2\hat{ }7) the integer “ma” may be right shifted 7 times.

In some aspects, as shown in FIG. 3D, the intervals may be not evenly spread over the range to be covered (illustratively, the range may be divided with a plurality of intervals having a plurality of different interval widths). In this configuration, the bucket number may be determined by subtracting the interval sizes da16 328-1, da15 328-2, da14 328-3, etc. from the measured value minus the first threshold value (a16). This approach is simple to implement and it is an efficient approach, as the majority of the values (e.g., acceleration values) measured actually fall into the low value range as known from the application (e.g., hard shocks may be rare, otherwise the module won't live long anyhow).

In case no distribution of the measurement values is (a priori) known from the application or use case, a so-called interval halving method (also referred to as bisection method or binary search method) may be implemented (e.g., by the one or more processors 102) to assign the aging event(s) to the respective sub-portion(s). The method may include nested comparisons of the measured value with the thresholds: for testing a threshold value that is in between the two thresholds values including the bucket being searched may be used (illustratively, one of these two thresholds is too small and the other threshold is too large).

With the bucket approach, the time information describing when an aging event (e.g., a shock) occurred may not be recorded (illustratively, may be lost). In addition, also the exact intensity value of the aging event may not be recorded. However, the bucket approach provides recording aging events while occupying a reduced space in memory (e.g., 32 Bytes for the example described in FIG. 3B), and storing enough information to determine if relevant events (e.g., serious shocks) occurred, which may be an important information for warranty claims as an example. Even using a reduced memory space, the bucket approach still ensures an accurate estimation of the impact of aging events (e.g., shocks) on product aging.

As described above, the recording of additional information related to an aging event (e.g., the intensity level of the acceleration together with the temperature at which it occurred) may provide a more accurate estimation of the remaining lifetime of the LIDAR module. Even though measuring the amplitude (in other words, the magnitude) of a shock may be sufficient for the entire LIDAR module, the capture of the temperature in addition to the magnitude of the shock may provide a more accurate assessment of the aging impact caused by the shock. This multiple (e.g., double) recording may be provided with an adapted configuration of the buckets, as described in FIG. 3E and FIG. 3F. Illustratively, it may be realized using an array of bucket arrays, for example corresponding to the number of shocks in the respective temperature rages and shock impact strength.

FIG. 3E shows a plurality of memory portions 310-1, 310-2, 310-3, 310-N associated with a component of a LIDAR module (e.g., with a component 104 of the LIDAR module 100) in a schematic view according to various aspects.

A component may have more than one (in other words, a plurality) of memory portions associated therewith in relation to at least one of the aging mechanisms (e.g., in relation to each aging mechanism). The aging data associated with that aging mechanism may be stored in the plurality of associated memory portions. In the exemplary configuration in FIG. 3E, four memory portions 310-1, 310-2, 310-N 310-3, are illustrated, it is however understood that the number of memory portions for a specific aging mechanism may be selected freely (e.g., two, three, four, five, ten, or more than ten), as a function of the desired resolution and available memory space.

The different memory portions 310-1, 310-2, 310-3, 310-N may be associated with a respective range of an intensity value of an aging factor for that component. Illustratively, in each memory portion 310-1, 310-2, 310-3, 310-N may be recorded aging events occurring in the associated range (further sub-divided in the respective sub-portions 312 as described below). In the configuration in FIG. 3C, a first memory portion 310-1 of the plurality of memory portions may be associated with a first range of a value of a (first) parameter associated with that component (e.g., with a temperature range, as an example, e.g. T<−25° C.). A second memory portion 310-2 of the plurality of memory portions may be associated with another (second) range of a value of the same (first) parameter associated with that component (e.g., with another temperature range, e.g. −25° C.<T<20° C. The third memory portion 310-3 may be associated with another (third) range (e.g., 125° C.<T<130° C., and the N-th memory portion 310-N may be associated with another (N-th) range (e.g., T≥130° C.).

The sub-portions 312 (e.g., 16 sub-portions 312-1 to 312-16 in the exemplary configuration of FIG. 3E, for the sake of representation indicated only for the first memory portion 310-1, in the following referred to collectively as sub-portions 312) of each memory portion 310-1, 310-2, 310-3, 310-N may be associated with a respective range for the intensity level of another aging factor (e.g., the acceleration, as an example). By way of illustration, a two-dimensional array is provided, in which the memory portions provide distinguishing the intensity levels of one aging factor (e.g., T), and the sub-portions provide distinguishing the intensity levels of another aging factor (e.g., acceleration).

In the configuration in FIG. 3E, the first memory portion 310-1 may include a plurality of (first) sub-portions 312, each (first) sub-portion 312 associated with a respective range of a value of another (second) parameter (e.g., the acceleration) associated with that component. The second memory portion 310-2 may include a plurality of (second) sub-portions 312, each (second) sub-portion 312 associated with a respective range of a value of the other (second) parameter associated with that component. The same may apply for the other memory portions 310-3, 310-N. For the sake of illustration, only one address 314 is referenced.

As an exemplary implementation, the measured temperatures may be classified into a predefined number of (sub-) ranges, e.g. 16 temperature ranges (with 16 memory portions, e.g. each of the memory portions 312-1 to 312-16 of each memory portion 310-1 to 310-N may be associated with a respective one of the sixteen ranges in Table 1). Table 1 shows an example selection of the temperature ranges.

TABLE 1

| Array | From | To | Delta | | |
|---|---|---|---|---|---|
| No. | [° C.] | [° C.] | [° C.] | Range | |
| 1 | | −25 | | <−25° | C. |
| 2 | −25 | −20 | 5 | −25° C. . . . <−20° C. | |
| 3 | −20 | −15 | 5 | −20° C. . . . <−15° C. | |
| 4 | −15 | −5 | 10 | −15° C. . . . <−5° C. | |
| 5 | −5 | 5 | 10 | −5° C. . . . <5° C. | |
| 6 | 5 | 20 | 15 | 5° C. . . . <20° C. | |
| 7 | 20 | 35 | 15 | 20° C. . . . <35° C. | |
| 8 | 35 | 55 | 20 | 35° C. . . . <55° C. | |
| 9 | 55 | 75 | 20 | 55° C. . . . <75° C. | |
| 10 | 75 | 90 | 15 | 75° C. . . . <90° C. | |
| 11 | 90 | 100 | 10 | 90° C. . . . <100° C. | |
| 12 | 100 | 110 | 10 | 100° C. . . . <110° C. | |
| 13 | 110 | 120 | 10 | 110° C. . . . <120° C. | |
| 14 | 120 | 125 | 5 | 120° C. . . . <125° C. | |
| 15 | 125 | 130 | 5 | 125° C. . . . <130° C. | |
| 16 | 130 | | | ≥130° | C. |

In some aspects, as shown in Table 1, the difference (e.g., the temperature difference referred to as “Delta” in the Table 1) covered by a single arrays of buckets may be unevenly distributed over the range of interest. The uneven distribution may provide keeping to a minimum an overall error caused by the quantization of an aging factor (the temperatures) into buckets. At very high temperatures connections, e.g. solder joints and adhesives, may tolerate less mechanical stress. At very low temperature a material, e.g. plastics, may become brittle, and may break more easily. A finer temperature resolution may be provided for very low and very high temperatures in order to get away with roughly the same error for wear due to shock caused by the quantization of temperatures into buckets.

The provision of such an array of arrays (a two-dimensional array), per relevant component (e.g., for each component relevant with respect to aging) allows the accurate capturing of historic (aging) data. The approach including multiple two-dimensional arrays may increase the required memory quite a bit. In order to reduce the memory space, the relevant components of the module may be clustered (in other words, grouped) in such a way that the components within a cluster are at a same or similar temperature (e.g., within a delta of 10% of a target temperature, as an example, or within a delta from one another in the range from 10° C. to 30° C.), thereby reducing the number of arrays, while not giving up significantly on precision.

The tolerated delta between components within a cluster (e.g., the temperature delta) may be selected depending on the component aging models and/or on the application. In automotive LIDAR applications the maximum temperature difference within a component cluster may be 15° ° C., as a numerical example. For consumer products a span of 30° C. may be selected. For these two applications the components may be clustered considering a thermal steady-state of the module. In more advanced or critical applications and use cases the components nearby and having roughly the same temperature even during thermal transients may be grouped into a cluster (leading to more clusters, and hence more memory usage).

As another exemplary case, shown in FIG. 3F, the wear on the laser diode emitter array during may be derived using the “bucket approach”, in a similar manner as the impact of the shock.

FIG. 3F shows a plurality of memory portions 310a-310f associated with a laser diode emitter array in a schematic view according to various aspects.

As in the case of aging impact due to mechanical shock, the measured temperatures may be classified into a plurality of ranges (e.g., 16 temperature ranges), resulting in a plurality of sub-portions 312 per memory portion (e.g., an array of 16 buckets 312-1 to 312-16 per memory portion in the exemplary configuration in FIG. 3F). The sub-division of the overall range may be different compared to the division described in Table 1. Even though the considered overall temperature range spans from (below) −25° C. up to (above) 130° C. the respective temperature ranges may be selected differently, as shown in Table 2 for example. As for the considered overall temperature range, the aging of the emitter pixels due to their operation may increase as the temperature increases, and a finer granularity (equaling smaller temperature spans per bucket) may be provided for higher temperatures. Table 2 describes the respective temperature ranges associated with the sub-portions 312-1 to 312-16 of each memory portion 310a-310f, as numerical examples.

TABLE 2

| Array | From | To | Delta | | |
|---|---|---|---|---|---|
| No. | [° C.] | [° C.] | [° C.] | Range | |
| 1 | | −25 | | <−25° | C. |
| 2 | −25 | −10 | 15 | −25° C. . . . <−10° C. | |
| 3 | −10 | 5 | 15 | −10° C. . . . <5° C. | |
| 4 | 5 | 20 | 15 | 5° C. . . . <20° C. | |
| 5 | 20 | 35 | 15 | 20° C. . . . <35° C. | |
| 6 | 35 | 50 | 15 | 35° C. . . . <50° C. | |
| 7 | 50 | 65 | 15 | 50° C. . . . <65° C. | |
| 8 | 65 | 80 | 15 | 65° C. . . . <80° C. | |
| 9 | 80 | 90 | 10 | 80° C. . . . <90° C. | |
| 10 | 90 | 100 | 10 | 90° C. . . . <100° C. | |
| 11 | 100 | 110 | 10 | 100° C. . . . <110° C. | |
| 12 | 110 | 115 | 5 | 110° C. . . . <115° C. | |
| 13 | 115 | 120 | 5 | 115° C. . . . <120° C. | |
| 14 | 120 | 125 | 5 | 120° C. . . . <125° C. | |
| 15 | 125 | 130 | 5 | 125° C. . . . <130° C. | |
| 16 | 130 | | | ≥130° | C. |

FIG. 3F may illustrate the bucket approach for a single pixel of the laser diode emitter array. Laser diodes may age with each pulse depending on the temperature of the laser diode and the peak current of the pulse (these three quantities, temperature, peak current and number of pulses, are described above as the aging-relevant quantities for the laser diode). Providing a two-dimensional array of buckets may provide the memory map as shown in FIG. 3F. The counter value of a bucket 312 may correspond to the number of laser pulses generated within the respective temperature and current interval. Each memory portion 310a-310f may be associated with a respective current range, and the sub-portions 312 within a memory portion 310a-310f may be associated with a respective temperature range. As numerical examples, the first memory portion 310a may be associated with the current range I<20 A, the second memory portion 310b may be associated with the current range 20 A<I<40 A, the third memory portion 310c may be associated with the current range 40 A<I<60 A, the fourth memory portion 310d may be associated with the current range 60 A<I<80 A, the fifth memory portion 310e may be associated with the current range 80 A<I<100 A, and the sixth memory portion 310b may be associated with the current range I≥100 A. It is understood that the ranges described herein are only an example, and additional, less, or alternative ranges may be selected as a function of a desired resolution.

For each pixel in an array of laser diodes of a LIDAR system the two-dimensional array of buckets shown in FIG. 3F may be provided, assuming that each pixel is driven individually. In case multiple pixels (e.g., laser diodes) are fired jointly (e.g., at the same time, or in a pre-determined time sequence), then a single two-dimensional array of buckets may be provided (whereby the average or maximum temperature/current may determine the specific bucket that gets updated, e.g. increased, when the respective pixels are operated).

The recording of aging events in terms of emitted pulses may be demanding in terms of used resources, in view of the large number of pulses used for LIDAR applications. As the buckets only have a size of some Bytes (e.g., 2 Bytes), increasing a counter of a bucket with every pulse emitted in for most systems/applications may lead to exhausting the bucket rather quickly (e.g., considering 2 Bytes, a bucket may count up to 65535 pulses (=2\hat{ }(2*8)−1)). Depending on the system the laser diode may be fired from a few ten times per second (the image repetition rate, in case of a FLASH-based system) up to hundreds of thousands of pulses per second (the pixel frequency, in case of system with a 2D-scanning emitter). Counting each single pulse generated by a laser diode may not be feasible. In extreme cases the counter for counting the pulses may even wear out faster than the laser diode itself. In addition just incrementing the bucket(s) may create a huge computational load on the CPU of the control system (unless the counters are implemented in hardware). In some aspects, a subsampling approach is provided for recording the number of pulses, as described in further detail in relation to FIG. 8. It is understood that the subsampling approach may be applied not only to the counting of laser pulses, but to other processes in which a large number of aging events may be expected.

The example described in relation to FIG. 3F is related to the use of recorded data is used to reconstruct the wear of pulsing the laser diode. There may be, in addition or in alternative, another (second) aging mechanism with a (sole) dependency on the temperature that may lead to aging over time (regardless of whether or not the laser diode was actually operated), as described in relation to FIG. 3G. Illustratively, the time the laser diode spends at a certain temperature has an impact irrespective of whether the laser diode emits laser pulses or not.

FIG. 3G shows a memory portion 310g associated with a laser diode in a schematic view according to various aspects.

The bucket approach may be provided also for this other aging mechanism related to the temperature. Each sub-portion 312 (each bucket, for example sixteen sub-portions 312-1 to 312-16 in the exemplary configuration in FIG. 3G) may store the time in increments of a predefined value (e.g., 30 second) in which the laser diode had a temperature within the respective temperature range (the sub-portions 312 of the memory portion 310g may have associated therewith the ranges described in Table 2, as a numerical example). With a bucket size of, for example, 3 Bytes each single counter may measure up to approximately 16 years when triggered every 30 seconds before the bucket value gets frozen in a “full” (saturated) state.

A respective one-dimensional array of buckets 310g may be provided for each pixel of the laser diode emitter array, e.g. assuming that each pixel is driven individually and different pixels may be at different temperatures. In some aspects, the heatsinking of the pixels may be constructed in such a way that different pixels may be (or may be considered to be) at the same temperature (e.g., within +3ºC or +5° C.) even in case the pixels are driven individually, and in this configuration a single array 310g may be provided for describing the temperature-induced aging of the whole emitter array.

In some aspects, the associated value “range” per bucket may be selected to be different within the same array 310g (illustratively, the width of the ranges may vary). The temperature-induced aging may have a stronger effect at higher temperatures compared to lower temperatures; illustratively the component may age in the same way if exposed to a medium temperature for a long time or a high temperature for a short amount of time. Smaller temperature inaccuracies may be tolerated at higher temperatures.

The recording of temperature-dependent aging may be carried out continuously and irrespective of whether the module is active (e.g., irrespective of whether the module is in operation performing ranging tasks) or not. Some LIDAR modules may be not powered when they are not operated, and may not include a battery to perform this task. In this case an incomplete estimation/prediction of the temperature-induced aging is possible. As a possible solution, the “global quantity” operating time is not recorded separately, as it may be computed by summation over all “temperature-dependent aging buckets” and multiplying by the time constant related to a bucket increment (e.g., 30 seconds in the exemplary case described herein, or 1 minute, or 2 minutes, as other examples). A separate recording of the operating time (e.g., using a single bucket for this purpose) may allow for a plausibility check.

In summary, a plurality of memory portions 310a-310f as shown in FIG. 3F may be provided for each laser diode of a transmitter sub-system (e.g., of the light emission device 124 described in FIG. 1A and FIG. 1B), e.g. to record current and temperature (with an array size, for example, of 12 lines×16 Bytes=192 Bytes). In addition, or in alternative, a memory portion 310g as shown in FIG. 3G may be provided (e.g., one for each laser diode, or one whole array, as described above), to measure the temperature only (with an array size, for example, of 3 lines×16 bytes=48 bytes).

In an exemplary scenario, in which the approximation of all laser diodes approximately at the same temperature may not be acceptable, each laser diode may have both arrays (shown in FIG. 3F and FIG. 3G) associated therewith (in total 240 Bytes for the exemplary values described above). The two arrays may be arranged in memory one following the other (e.g., via selecting the respective addresses 314, as shown in FIG. 3F and FIG. 3G). Both arrays together may be the first element of an array of bucket arrays covering the laser diodes (e.g., 8 as a numerical example) of a transmitter sub-system of a LIDAR module. In the exemplary representation in FIG. 3F, the memory range occupied by the array of arrays of buckets may start at the address 0x13700. The last byte of the 1920 Bytes may be located at the address 0x13E7F.

The example provided herein in relation to laser diode may apply in a similar manner to other components or sub-systems of a LIDAR module (e.g., to one of the components 104 of the LIDAR module 100). For a single component or sub-system multiple aging processes may be relevant and multiple arrays of buckets may be provided for the same component or sub-system.

In some aspects, the number of sub-portions 312 (the number of buckets) related to a same aging factor (to a same quantity, e.g. the temperature) may vary from array to array (e.g., a first memory portion and a second memory portion related to a same aging factor may have a different number of sub-portions). Each array may describe a different aging mechanism, and the number of buckets per aging mechanism may be selected in such a way that all aging (regardless of the involved mechanism) may be described with the same accuracy (all aging mechanisms for all the components and sub-systems of the LIDAR module may be evaluated in the global lifetime function as described below, see FIG. 9A to FIG. 9D).

The proposed “bucket approach” may be applicable for aging mechanisms for which the sequence in which the component or sub-system is going through the different “aging-relevant statuses” is not relevant. This consideration holds true for the relevant aging mechanisms occurring in a LIDAR module. The simplification however may not hold in case of very highly accelerated aging, which is however not relevant for LIDAR applications.

In some aspects, for applying the “bucket approach” for “slowly occurring” aging, the time at which the respective aging-relevant status was present (e.g., the time at which the aging event occurred) may be quantized. The quantization may be understood as implementing a digital clock by using buckets (and counters). The “virtual” clock may have a coarse time base (coarse may be understood as tens of seconds or minutes, instead of milliseconds or microseconds of a typical digital clock in control or computer systems). For example, every time the component/sub-system/system was for a duration of a certain time (e.g., a fixed or predefined time duration) powered or at a certain temperature, the respective bucket/counter may be updated (e.g., increased by one).

In various aspects, a memory sub-portion 312 may include a non-overflow up counter. Illustratively, a bucket 312 may start at an initial value (e.g., zero) and may be updated (e.g., increased) over time, but it cannot overflow and may instead be saturated (all bits sets=111 . . . 111b=FFF . . . FFFh=0xFFF . . . FFF). The memory portions 310 and sub-portions 312 may be selected such that none of the buckets 312 may reach its maximum capacity during an expected lifetime of the product. However, in case the actual life significantly exceeds the anticipated life, the maximum capacity of one or more of the buckets 312 may be reached. To prevent misleading interpretation of the data, the counters may be configured not to overflow (which would lead to them starting at the initial value, e.g. zero, zero again).

The one or more processors of a LIDAR module (e.g., the one or more processors 102) may be configured to implement a “non-overflow feature” of the counter, as described by one of the three options A through C below.
A) The one or more processors may be configured, at first, to check that not all bits of the counter value are set; only if not all bits are set the counter may be updated (e.g., increased); in case the one or more processors determine that all bits of the counter are set (the counter has a value of 0xFFF . . . FFF), then the command of updating the counter (increasing it by one) is skipped (in other words, not executed);
B) The one or more processors may be configured, at first, to update, e.g. increase, the counter; in case an overflow occurs (e.g., the overflow bit of the arithmetic logic unit, ALU, is set) then its value is overwritten by 0xFFF . . . FFF;
C) The one or more processors may be configured, at first, to update, e.g. increase, the counter; in case an overflow occurs (e.g., the overflow bit of the ALU is set) then the counter may be decreased (also resulting in a counter value of 0xFFF . . . FFF).

Instead of non-overflow up counters some (or all) of the buckets 312 may include (e.g., may be realized as) non-underflow down counters (e.g., updated by decreasing instead of increasing).

An advantage of the bucket approach with respect to the time-series approach described above may be that for the “bucket approach” the amount of memory required is predefined/predetermined (e.g., upon fabrication, or upon an update of a LIDAR module) and does not grow over time.

An additional or alternative approach for dealing with the overflow of the buckets will be described in relation to FIG. 4.

FIG. 4 shows a plurality of memory portions 410a to 4101 associated with a component of a LIDAR module (e.g., with a component 104 of the LIDAR module 100) in a schematic view according to various aspects. The memory portions 410a to 4101 may include a plurality of respective sub-portions 412 (e.g., sixteen sub-portions 412-1 to 412-16 in the exemplary configuration in FIG. 4, referenced for the first memory portions 410a for the sake of illustration, collectively referred to as sub-portions 412). The memory portions 410a to 4101 and the sub-portions 412 may be configured as the memory portions 300, 310 and the sub-portions 302, 312 described in relation to FIG. 3A to FIG. 3G. As an example, the memory portions 410a to 410f, and the memory portions 410g to 4101 may be associated with a respective current range as the memory portions 310a to 310f described in FIG. 3F. The sub-portions 412 may be associated with a respective temperature range, as described in Table 2. The memory portions 410a to 4101 and the respective sub-portions 412 may have memory addresses 414 associated therewith. For the sake of representation, FIG. 4 is illustrated split into FIG. 4A and FIG. 4B, but it is considered and described as a single figure.

The issue of buckets overflowing was mentioned above, illustratively the case in which the bucket size is insufficient for the number of events/counts it should hold. The remedy described above includes the implementation of “non-overflow up counters” to avoid the creation of completely non-trustable data due to the potential roll-over of counters/buckets.

In various aspects, additionally or alternatively to implementing “non-overflow up counters”, the bucket size may be (virtually) expanded by utilizing a so-called “cascaded buckets” approach. Different buckets, e.g. located in different memory areas of the control circuit (e.g., in different types of memory) may be “cascaded” to create a large “effective” bucket.

“Cascading” may be understood as updating, e.g. increasing (in other words, incrementing), a second level bucket in case the first level bucket overflows (thereby turning its value to the initial value, e.g. zero). The first level bucket may have a memory size of, for example, 2 Bytes. The second level bucket may be an additional memory area, e.g. with a size of 2 Bytes. The 2nd level bucket may count the number of overflows of the 1st level bucket. The two buckets may effectively form a single virtual/effective bucket.

In the representation in FIG. 4, in case the counter value of a (first) sub-portion 412a is equal to the threshold counter value, the one or more processors may be configured to record the aging event in another (second) sub-portion 412b. The other (second) sub-portion 412b may be located in a (second) memory portion 410i different from a (first) memory portion 410c in which the (first) sub-portion 412a is located. The (second) memory portion 410i may be associated with the same component and the same aging mechanism as the (first) memory portion 410c. The (second) sub-portion 412b may be associated with the same range of the value of the aging factor as the (first) sub-portion 412a (e.g., the same temperature range).

The (second) memory portion 410i may be located in a different memory area with respect to the (first) memory portion 410c. In the representation in FIG. 4, the memory portions 410g to 4101 may include the second level buckets (or higher level), and the memory portions 410a to 410f may include the first level buckets (or lower level).

The cascaded bucket approach may be utilized for a single bucket or for arrays of buckets as shown in FIG. 4. As an exemplary scenario, as shown in FIG. 4, the approach may implemented to record the number of laser pulses generated by a pixel as discussed above in relation to FIG. 3F (e.g., the memory portions 410a to 4101 may be associated with a respective current range, and the sub-portions 412 with a respective temperature range). In case of an event, the bucket 412a (for example) associated with this specific event inside the 1st level array of buckets (the memory portions 410a to 410f) may be incremented. This action is indicated by the X in portion FIG. 4A of FIG. 4, which indicates that the memory location is read out, the read value is increased by one and then written back to the same memory location, indicated by the engraved W. If an overflow occurs during this increase, then the corresponding 2nd level bucket 412b (indicated by the X in portion FIG. 4B of FIG. 4) gets increased by one, too. This conditional action is indicated by the arrow in FIG. 4.

The cascaded arrays may have the same dimension, e.g. the two arrays (the memory portions 410c, 410i), or more in general all the arrays cascaded, may include the same number of buckets. The buckets within an array may have different sizes, as described above, and also buckets (e.g., the buckets 412a, 412b) with a same index and located in different (but cascaded) arrays may have a different size.

In various aspects, more than two levels of buckets (and/or arrays) may be provided. A 3rd level bucket (even more memory allocated to the counting of the respective event, with a size of, for example, 3 bytes) may be added to the previously formed effective bucket. The 3rd level bucket may be used for counting the number of overflows of the 2nd level bucket. All three buckets effectively form a single virtual/effective bucket having the size (in bits) of the 1st, 2nd, and 3rd level buckets (number of bits of all three buckets added up; with the exemplary values described above 2+2+3=7 Bytes). The effective bucket may count up to 2\hat{ }(8*7)−1=72,057,594,037,927,935 which s approximately 72 quadrillion events before the resulting bucket would overflow. From this calculation it can be seen that for all practical purposes less than 7 Bytes may be a sufficient effective bucket size. The more the size of the effective buckets gets reduced the higher the likelihood of an unwanted overflow of the entire effective bucket. In case larger buckets are desired, additional levels may be provided.

In various aspects, the counters of the sub-portions may include non-overflow counters (e.g., up counters or down counters) also in the configuration with the cascaded buckets, to avoid an unwanted overflow. In case an overflow of the mth-level bucket would occur, the mth-level bucket is only increased if the (m+1)th level bucket can be increased. In case the (m+1)th level bucket would also overflow, then it may be checked if the (m+2)th level bucket could be increased without overflow. Only if the checking results in a possible increase of a higher level bucket, all lower level buckets may be increased resulting in their overflow. In case there is no higher level bucket that could be increased then no action is taken, and all buckets remain as they are, resulting in ignoring the event.

The approach of “cascaded buckets” provides the advantage of increasing the effective bucket size, thus making an overflow less likely. In addition, in contrast to a more straight-forward approach of simply providing “wider” buckets (that is, buckets with more bits), the approach of “cascaded buckets” allows benefitting from the additional advantages of lower cost, higher performance and/or reliability to higher compared the straight-forward approach. Lower cost may be achieved in view of the fact that only the first bits of the effectively created large bucket needs to be held in fast memory (e.g., RAM) and the “rest” of the bucket can be realized using slower and slower memories, as described above, and at the same time typically cheaper and cheaper memories.

In various aspects, the memory portions of different levels may be provided in memories of different types. With reference to FIG. 4, the (second) memory portion 410i may be located in a memory of a different type with respect to the (first) memory portion 410c. The different parts of a large “effective” bucket may be written to different types of memory, e.g. RAM, EEPROM, FLASH and hard-drive/disk memory/storage (here listed in the order of fast to slow which at the same time arranges these memory types from expensive to low-cost).

The “lower” level buckets may be provided in a fast memory type, and the “higher” level buckets may be provided in a slow (or relatively slower) memory type. The memory type in which the memory portion 410c is located may be faster than the memory type in which the memory portion 410i is located. As an example, the (first) memory portion 410c may be located in a RAM memory, and the (second) memory portion 410i may be located in one of a EEPROM memory, a FLASH memory, or a hard-drive memory.

As an exemplary implementation, RAM may be used for the lower but faster bits of the counter/bucket 412a, whereas for the higher and more slowly changing bits of the bucket 412b a FLASH memory may be used. By using RAM for the fast changing digits of the counter/bucket, events occurring even with fairly high frequency may be recorded, hence a “high performance recoding” may be realized. Increasing the maximum counting frequency may provide higher accuracy (in case numerous events of the same kind happen within a short amount of time, it is less likely that one of the events would be dropped or not recorded due to the speed with which the record is being written) and higher precision (the system may be designed to count, for example, every pulse fired, instead of subsampling the sequence of laser shots in order to count every tenth shot on average, as another example).

For events that may occur at rates that are even too fast for recording using RAM, a subsampling approach may be provided (see FIG. 8), in combination with the cascaded bucket approach.

Writing data (the value of a bucket) first to RAM or EEPROM before writing it to FLASH, may reduce the number of write-cycles of the FLASH memory, and thereby extending the life of the FLASH memory (as FLASH differently than, for example, RAM shows a (slow) degradation of memory cells and eventually their failure) and thereby system reliability. As RAM is a volatile memory, in case of a (sudden) power outage (if not saved in non-volatile memory) the bucket(s) in RAM may be lost. Assuming proper sizing of volatile and non-volatile buckets being cascaded, this unwanted loss of data may be negligible, as only the lower and hence least-relevant bits of the compound counter/bucket may be lost.

The described “bucket approach” may provide recording historic data with very efficient usage of memory space compared to a time-series approach, and may be implemented with very little computational resources. However, as described above, information on when the aging event happened may be lost. Another concern of the “bucket approach” may come from potentially overflowing buckets, hence the buckets may be appropriately sized and/or data corruption may be at least prevented by implementing buckets as “non-overflow counters”, as described above.

In view of these considerations, a so-called “journaling” may be implemented in various aspects, as described in relation to FIG. 5A to FIG. 5C. A “journal” may be understood as a set of (potentially fresh) buckets that may be started in case a special event has occurred. Illustratively, a journal may include the set of buckets (e.g., the memory portions and respective sub-portions) used to record the history of events that occur during a given period of time. A journal may include all buckets related to the components of a LIDAR module, or may include only a subset of the buckets. The aging events may be recorded in a (first) journal for a certain period of time, and in another (second) journal after journaling (after a journal operation). Stated in a different fashion, the one or more memory portions associated with a component (e.g., with a component 104 of the LIDAR module 100) may form a first set of memory portions, and the one or more processors of a LIDAR module (e.g., the one or more processors 102) may be configured to assign a second set of one or more memory portions to the component. A set of memory portions may be a journal.

The one or more processors may be configured to assign a second set of one or more memory portions to the component in response to a trigger event (a special event). Examples of a special event, e.g. of an event triggering the creation of a new journal, may include, as examples:
(A) a counter value of a sub-portion of the first set of memory portions reaching the threshold counter value, illustratively the overflow of any of the buckets currently in use. In various aspects, the “non-overflow counter” functionality for the bucket that would overflow may trigger a “journaling operation” (the creation of a new journal), rather than ignoring the event that triggered the bucket increase. After the journaling is completed (a new journal has been created) the mentioned “non-overflow counter” routine (which may still be executed or which may be executed again after the return from the prior-called journaling routine) may increment the respective bucket right thereafter (which will start from the initial value, e.g. 0 and have a value of 1). The journaling may provide, in this case, that no data is lost (even in the case in which the product experiences more events of a certain type than anticipated during product design).
(B) a certain (predefined) point in time being reached. As an example, a point in time in which a new regulation enters into force, or a new update is available, and the like. As an exemplary scenario, in case a new regulation takes effect from Jan. 1, 2022 on, journaling (e.g., triggered on Jan. 1, 2022 at midnight) may provide distinguishing how the product was used before and after the regulation took effect.
(C) a predefined (absolute) time since the last journaling has lapsed (e.g., one day, one week, or one month, as examples), e.g. a predefined number of hours having elapsed since the assignment of a previous set of one or more memory portions. This may provide monitoring the occurrence of events, this type of trigger may ensure that the time covered by a journal will not exceed a certain period of time.
(D) the system was in operation for a predefined time (e.g. since it was powered up for the first time, or since the last journaling happened), e.g. the LIDAR module having operated for a predefined number of hours. This type of special event may be implemented by a reoccurring comparison of the bucket that counts the operating time, which may start counting from zero every time a new journal is created, and the value defining the current journaling time duration. The journaling interval duration may be predetermined and constant over time, or it may vary over time, as outlined below.

Journaling (also referred to herein as journaling operation, journaling event, or journaling action) may be understood as the definition (e.g., by changing an offset) and/or creation of a new journal, e.g. in response to a trigger event. In some aspects, upon journaling, the journaling interval (the maximum time allowed between two journals) and other special event conditions may be updated.

A special event triggering the journaling may impact one, or a plurality, or all of the buckets used for recording aging events. Having all buckets to be part of the journal is optional, but having as many buckets as possible in a journal may increase the overall value/benefit of the stored information for gathering a most complete picture of the system at the time when the journal was created.

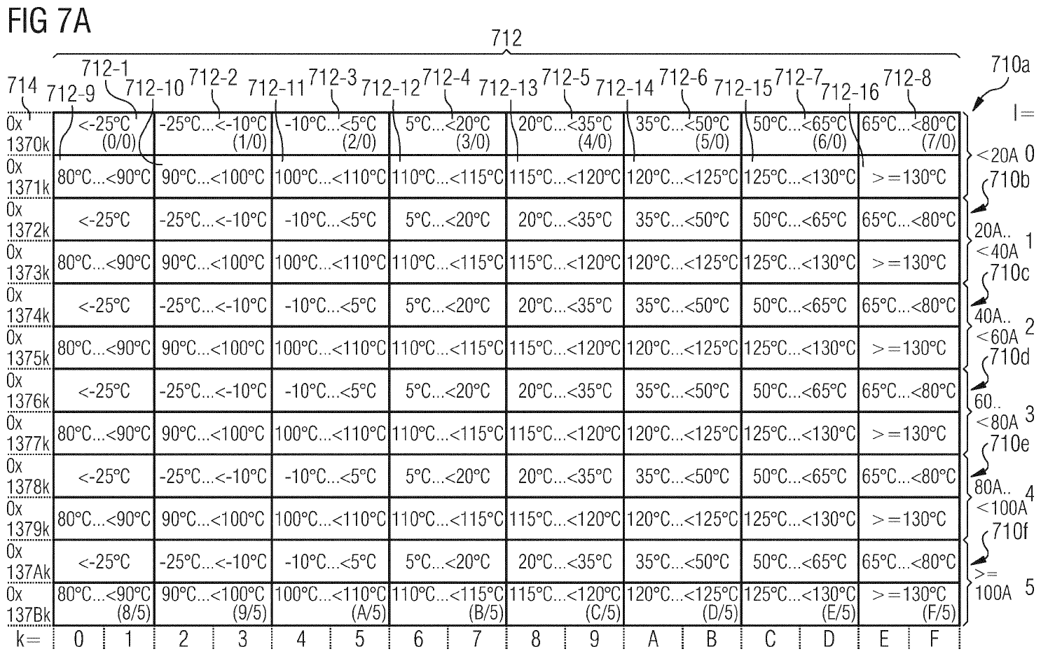

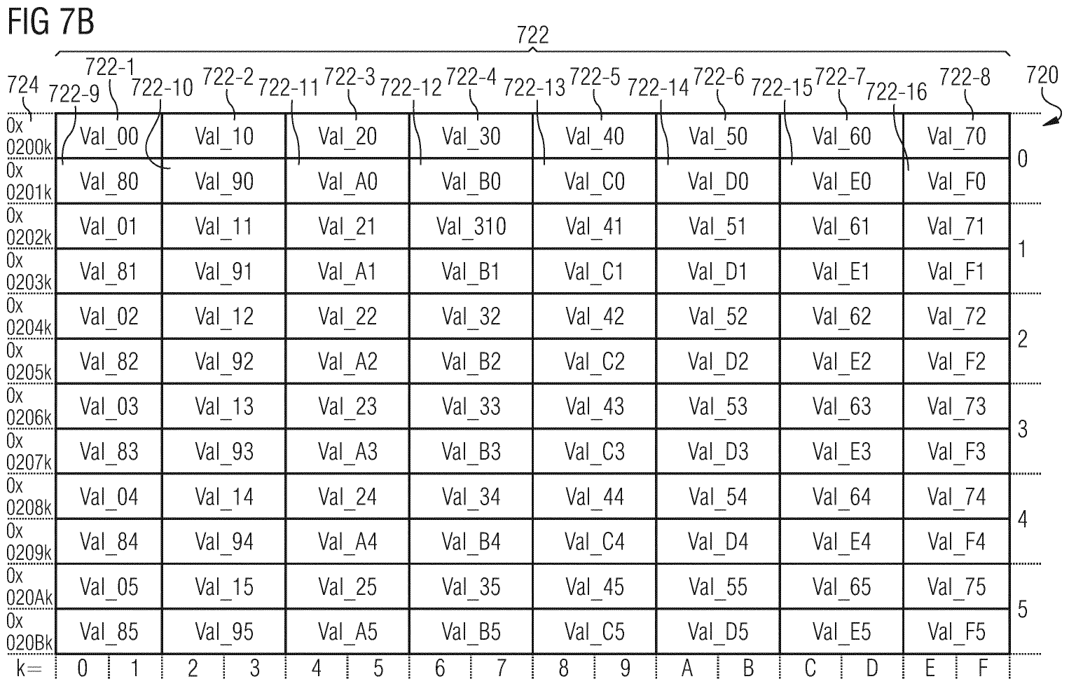

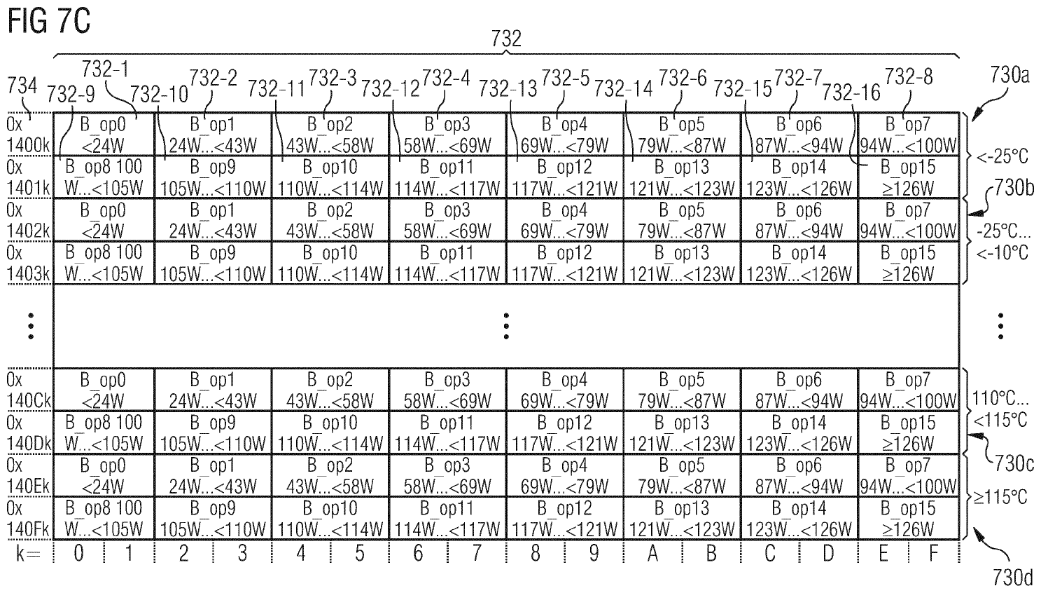

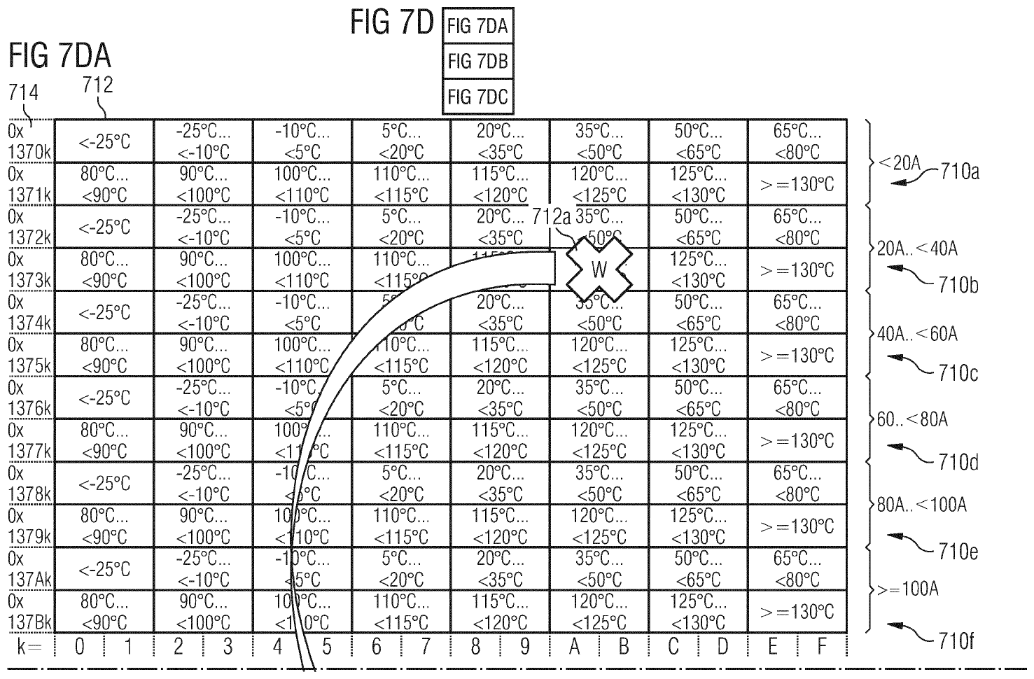

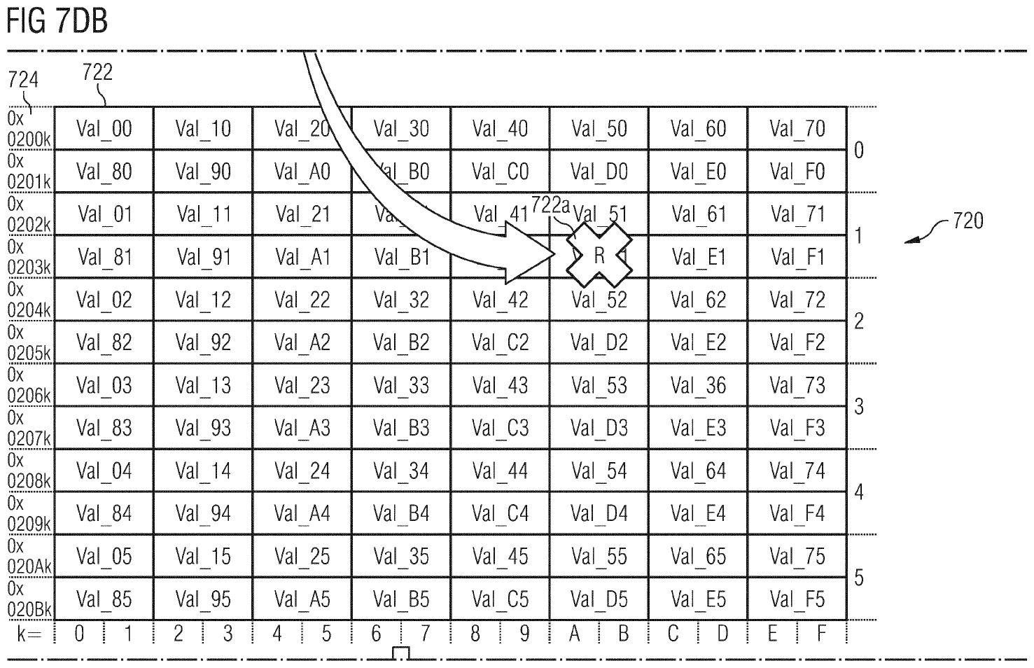

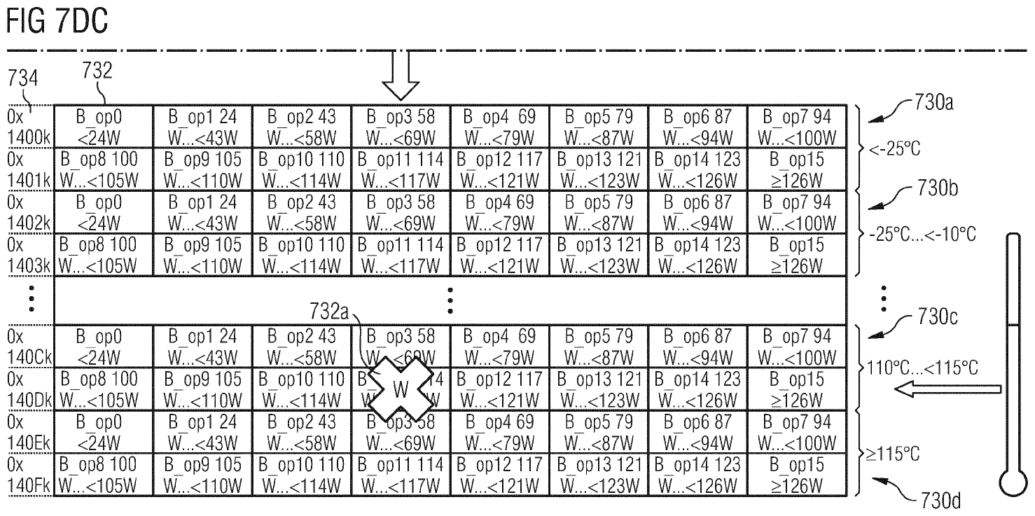

Some type of data, for example a Firmware History Table (see FIG. 6) or look-up tables (see FIG. 7B) may be excluded from the journaling operation, which may apply to the buckets assigned to recording aging events. A timer measuring the time the LIDAR system as a whole is powered, or a timer measuring the time the transmitter is active, may be seen (and implemented) as buckets, and may be included into journals. The operating time since the last journaling event (the last journaling operation) may be read from the respective bucket (which may be part of the current journal). The total operating time of the product may be derived by adding up the respective bucket of the current and all previously stored journals.

By way of illustration, the memory portions 300, 310, 410a-410g described above, and the respective sub-portions 302, 312, 412 may be understood as part of a same journal, e.g. journal zero (J0).

As an exemplary scenario, for a LIDAR module (e.g., the LIDAR module 100), a warranty period may cover 5000 h of operating time. In addition an extended warranty period of 10000 h may be granted. The product may be designed and manufactured to last up to 30000 h of product life. The LIDAR module may have an initial journaling interval, e.g. of 1000 h. After a predefined journaling operation, e.g. after the sixth journal (after 6000 h, and ensuring having good records exceeding the warranty time of 5000 h) the journaling interval may be increased, e.g. may be set to 2000 h for another predefined period, e.g. for the following 3 journals (thereby covering 12000 h, including the extended warranty time spanning until the 10000th hour). Beyond the other predefined period, the journaling interval may be further increased, e.g. may be set to 4000 h for the last five journals. The last journal (in this exemplary scenario the 14th journal) may be used indefinitely (not only until 32000 h have been reached) from the 28000th hour on. With this journaling approach the designed life of 30000 h should be well covered. The extension of the journaling interval may provide saving memory space and decreasing the probability of buckets becoming saturated, which may be less of a concern the older the product becomes.

FIG. 5A shows a memory block 500 in a schematic view according to various aspects. The memory block 500 may be part of a memory device of a LIDAR module (e.g., part of a memory device 108 of the LIDAR module 100).

As an example, the memory block 500 may describe a partitioning of a FLASH memory; it is however understood that it may describe a partitioning of other memory types.

The memory block 500 may include a (first) journal 502a, e.g. the journal J0. As an exemplary assumption, the journal 502a may not include cascaded buckets. The journal 502a may include, as examples, buckets for counting mechanical shocks (e.g., as described in FIG. 3E), buckets for counting pulses fired (e.g., as described in FIG. 3F), buckets for temperature-induced aging (e.g., as described in FIG. 3G), and buckets for assessing pulse induced aging (see FIG. 7A to FIG. 7D). It is understood that the recording of aging events is not limited to transmitter and emitter components, but also the other components of a LIDAR module (e.g., the receiver, optics, power supply circuit, and control circuit) may be considered, as described above (e.g., the journal 502a may include respective buckets for such components, e.g. as “other data” in FIG. 5A). The partitions of the memory block 500 may have a respective memory address 504 associated therewith.

The representation in FIG. 5A may describe the memory partitioning before a (first) journaling operation, e.g. a time t1 before the first journaling operation (e.g., time t1 may be less than 1000 h as described above).

FIG. 5B shows the memory block 500 in a schematic view according to various aspects. FIG. 5B may illustrate the situation after the first journaling, e.g. at a time t2. With the first journaling another (second) journal 502b (J1) was created (e.g., by the one or more processors 102).

The journaling may be carried out in an efficient manner, e.g. by changing a single pointer to make the new journal 502b J1 the current journal instead of the first journal 502a J0. The routines described above may be configured to access the buckets of the current journal via a paging concept, e.g. the routines may be configured to access a bucket not directly via its address but to access a bucket via its virtual address, and the first Byte of the first bucket may correspond to virtual address 0. From the virtual address the physical address may be determined (e.g., derived or calculated) by adding an offset to the virtual address with an offset. A first offset may be provided for the first journal 502a, e.g. as long as J0 is the current journal, the offset may be 0x13000, as an example. A second offset may be provided for the second journal 502b, and the second offset may replace the first offset upon carrying out the journaling. The offset 0x13000 may be overwritten by the second offset, e.g. 0x15000 as an example, when the first journaling happens. Then all routines designed to operate on the current journal may be configured to automatically access the buckets of J1, even though the routines may not be “aware” of the journaling, without any change in any of the routine's code, and without any conditional statements (depending on which journal is the current journal) in the program code of these routines to perform the switching of what is deemed the “active” or “current” buckets.

In various aspects, the memory beyond the first journal 502a, e.g. the memory beyond J0 (from 0x15000 on), may be initially made up of “zeros” by default (e.g., via programming during production), and this memory area may be automatically interpreted as empty buckets after the first journaling happens.

After the one or more processors (e.g., the one or more processors 102) carried out the first journaling, the one or more processors (e.g., the microcontroller) may be configured to automatically increase the buckets of the second journal 502b J1, in response to the occurrence of the respective aging events. The memory area of journal J0 may be rarely accessed by the one or more processors, and if so, then the memory is only read from but never written to.

FIG. 5C shows the memory block 500 in a schematic view according to various aspects. FIG. 5C may illustrate the situation after a second journaling, e.g. at a time t3. With the second journaling another (third) journal 502c (J2) was created (e.g., by the one or more processors 102).

Every journal may increase the used memory by a predefined number of Bytes. As an example, every journal may increase the used FLASH memory by 8 kilobytes. For sake of representation, the memory space up to 0x2FFFF and only up to the second journaling is illustrated in the FIG. 5A to FIG. 5C. Only the first three journals 502a, 502b, 502c are shown. It is however understood that more journals may be created, e.g. 14 journals as described above, during product life. In this exemplary case, an “old product” may hold up to 14×8=118 kilobytes of (valuable) historic data.

In various aspects, the buckets of a journal may be arranged in a consecutive manner leading to a journal being a single area in memory. This configuration may provide minimal computational efforts without wasting memory space. In case of journals including buckets located in different types of memory (e.g., in case of cascaded buckets), the buckets may be arranged such that a journal may be a single area in memory per each type of memory.

A new journal (also referred to herein as journal page) may include the same number and type (e.g., size) of buckets as the previously used journal (e.g., the first journal 502a may include a same number of memory portions and memory sub-portions as the second journal 502b, and as the third journal 502c). As soon as the journaling action is carried out, the new journal may become the current journal, and the aging events occurring after the journaling may be recorded (only) in the new journal.

The buckets of all non-current/old/historic journals may remain unchanged to ensure trustworthiness of the recording. The implementation of accessing historic (in other words non-current) journals may be configured to ensure that only read access occurs. As an example, the old journals may be stored in memories configured to allow a single write operation. With reference to FIG. 5A to FIG. 5C the one or more processors may be configured to record (e.g., to copy) the content of the first set of memory portions (the first journal 502a) in a memory configured for a single write operation (upon the first journaling operation). The one or more processors may be further configured to record the content of the second set of memory portions (the second journal 502b) in a memory (of a same type or a different type) configured for a single write operation (upon the second journaling operation). The memory configured for a single write operation may include one of a one-time-writable (OTP) memory, or a programmable read only memory (PROM). Illustratively, old journals may be stored in one-time-programmable (in other words, one-time-writable) memory. Some of these memory devices (e.g., classified as PROM devices) may be programmed using an external programmer, whereas other devices (e.g., called OTP devices) may not. Devices with the latter property may be the ones preferably used.

In various aspects, there may be two options (which may be combined with one another) for creating a “new journal”:
(i) A first option may include copying into a different memory space (referred to as archive space, as described in further detail below) some or all data held in the memory space of the currently used buckets, and resetting some or all of the buckets which were used prior to the journaling (e.g., the buckets may be set to a predefined bit sequence, for example corresponding to the value 0, e.g. zero events; the bit sequence may be actually zero, e.g. notated as value 0x0 in memory).
(ii) A second option may include using new memory space for the new journal (which will become the current journal), while the journal used up to now will (form now on) remain untouched (as described above in relation to FIG. 5A to FIG. 5C, and as will be described in further detail below).

The second option may provide the advantage of avoiding any data copy action, and it may be preferable in a system that allows its implementation. No copy action is carried out, as only the offset (the offset pointer to the current journal) is modified, as described above. With the modification of the offset, the pointers to the current buckets may point to new memory locations (being empty), whereas the memory space of the buckets previously used (illustratively, the “old journal”) may remain unchanged from now on (illustratively, from the journaling operation onwards).

In relation to the second option, the approach of memory paging or memory banking may be conveniently applied, as described above. A journal may be realized as a memory bank (or may be an actual memory bank, depending on the architecture of the system). An offset pointer (also referred to herein as page-pointer) may be configured to select the memory bank which is being used. The physical address of the memory location (bucket) may be determined by adding up the virtual address of the bucket (equaling the distance from the beginning of the journal to the bucket to be addressed) and the offset.

In various aspects, as described in relation to FIG. 5D to FIG. 5F, a subset of buckets (of the current journal) may be allocated to a memory of a first type and a memory of a second type, e.g. to RAM and FLASH memory, for example in a cascaded bucket approach. Another subset of buckets (of the current journal) may be allocated only to one type of memory, e.g. in a FLASH memory.

FIG. 5D, FIG. 5E, and FIG. 5F show a (first) memory block 512 of a first memory type 510 (e.g., RAM, only as an example) and a (second) memory block 522 of a second memory type 520 (e.g., FLASH, only as an example) in a schematic view according to various aspects.

In FIG. 5D the memory partitioning of the first (RAM) memory block 512 and of the second (FLASH) memory block 522 may be illustrated before the first journaling. The currently used buckets (of the journal J0) at this point in time are located in the memory blocks/areas 512, 522, e.g. referred to as “Buckets R0” and “Buckets F0”.

In FIG. 5E, the situation after the first journaling is shown. During the journaling the content of the buckets in the memory 510 of the first type (e.g., a volatile memory, in this example RAM) was copied (e.g., by the one or more processors) to the memory 520 of the second type (e.g., FLASH, in the part 512-1, referenced as R0), and the buckets in the first memory 510 were reset (referenced as R1). In addition, the offset providing the start address of the current buckets in the second memory 520 was increased so that it now references the buckets in a new memory location 524 (F1). The new current journal may include the part 512 in the first memory 510 and the part 524 in the second memory 520.

In FIG. 5F, the situation after the second journaling is shown. The content of the buckets in the memory 510 was copied to the memory 520 (e.g., in the part 512-2). The offset providing the start address of the current buckets in the second memory 520 was increased so that it now references the buckets in a new memory location 526. The new current journal may include the part 512 in the first memory 510 and the part 526 in the second memory 520.

In the configuration in FIG. 5D to FIG. 5F, the current journal is split between the two memory types (e.g., RAM and FLASH memory).

In various aspects, only a subset of the data stored in the first memory 510 may be copied during journaling to the second memory 520. As an example, the buckets may be distributed between RAM and FLASH memory, and not all of the data held in the RAM block used for the buckets may be copied during journaling to FLASH memory. This may provide saving memory space. For example, the most significant bit(s) (or Byte(s)) may be copied from the first memory 510 to the second memory 520 during journaling. As an exemplary case, for cascaded buckets having 2 Bytes in RAM and 2 Bytes in FLASH memory, (only) the most significant byte from RAM is copied into the respective section in FLASH during journaling. Thereby a lossy data compression may be realized considering the most significant bits as the compressed data.

In various aspects, the above-described lossy data compression may be further developed, and no copying action from the first memory 510 to the second memory 520 is carried out. All journals, illustratively the current and each of the “old” journals, may occupy as much second memory 520 (FLASH memory) as the current journal. In case the data in the first memory 510 (in RAM) is completely disregarded, then potentially a significant loss of information may occur. In order to alleviate this loss of information, and before the respective area in the first memory 510 is reset (e.g., set to zero), for all cascaded buckets the part of the bucket in the second memory 520 may be incremented by one in case the part of the bucket in the first memory 510 is more than half full (in a typical implementation the most dominant bit set in RAM of this bucket would be set).

In various aspects, the current journal may be divided across a first memory of a first type and a second memory of a second type, and the non-current journals may be stored in a third memory of a third type (e.g., a third memory configured for a single write operation). As an exemplary implementation, the current journal may be implemented using RAM (Part A of the journal) and EEPROM (Part B of the journal), and all non-current journals may be stored in an OTP memory. During journaling a respective section of the OTP memory may be “burnt”/programmed with the data from both parts of the current journal. Right thereafter the respective memory sections in RAM and EEPROM may be erased to become the new current journal. This approach is illustrated in FIG. 5G to FIG. 5I, showing a first memory 550 (e.g., RAM), a second memory 560 (e.g., EEPROM), and a third memory 570 (e.g., OTP). The third memory 570 is initially empty (e.g., at a time t1, FIG. 5G), and the journal (J0) may be split across a part 552 (a memory block) of the first memory 550 and a part 562 (a memory block) of the second memory 560. After the first journaling, the content of the first journal is copied in a part 572 (a memory block) of the third memory 570 (at a time t2, FIG. 5H). After the first journaling, the content of the second journal is copied in a part 574 (another memory block) of the third memory 570 (at a time t3, FIG. 5I), etc.

In various aspects, the memory storing the non-current (the old) journals may be external to the one or more processors (or microcontroller) of a LIDAR module (e.g., external to the one or more processors 102 of the LIDAR module 100). The memory, e.g. EEPROM, FLASH, OTP memory may be in one or more separate devices (which may be part of the control circuit).

It is understood that, in addition to the memory types described above, other types of memory, such as Hard-drive/Disk/HDD or even cloud storage (illustratively, potentially not part of the control circuit or even not part of the LIDAR system) may be provided to “archive” the “old journals”. A drawback of such implementation may be a slower (or absent) response of the module to certain type of requests or certain product features (e.g., Smart Derating) in case the cloud connection is slow or down.

As described above, the amount of memory provided for the “bucket approach” may be predefined/predetermined and does not grow over time. This highly advantageous property may be preserved in the case of the “bucket approach with journaling”, e.g. by setting a predefined number of journals, for example by limiting the number of journals in the code. In this configuration, the favorable feature remains true even if the product exceeds the anticipated maximum lifetime (all designated journal pages are used up, meaning the designated memory area, e.g. in FLASH, is “full”) as the system upon the occurrence of events may continue to further increase the respective buckets (being part of the current journal, which is the last journal).

In various aspects, for the journal approach non-overflow buckets may be provided, e.g. buckets with “non-overflow counter” functionality. This may prevent overflowing buckets. In some aspects, for journaling, “advanced non-overflow counters” may be provided (e.g., one or more of the memory sub-portions may include an advanced non-overflow counter). With advanced non-overflow counters the overflow of any bucket, including cascaded buckets as described above, may trigger the creation of a new journal, unless there is no more memory space available for creating another journal (or unless the predefined maximum number of journals has been reached). In case no space is available or the maximum number of journals has been reached, no action is taken, and the occurrence of the event may be ignored.

According to the described approach a significant accumulation of events may be conducted before a new journal is created. The creation of a journal may be quite memory extensive, and potentially also computationally intensive at least for a small duration of time, even though the journaling action may be implemented in such a way that the journaling does not negatively impact the rest of the functionality of the control circuit. To justify this approach, a journal may be used for a significant fraction of the lifetime “L” of the product. The duration of such “significant fraction” may be estimated as follows, for typical LIDAR product applications. Assuming, as an example, that it could suffice to cover only 5% of product life “L” with historic data (typically it may be more than 5%), and assuming that a journal would use up to 0.1% of the memory space dedicated to store historic data (meaning the memory can hold at least 1000 journals), then every 5%*0.1%*L, meaning every twenty-thousandth of the product life, a new journal may be created. For an automotive LIDAR product with a life of 5000 hours (illustratively, the car may be operated for 5000 hours before it gets retired), a new journal may be created every quarter of a hour on average (so every 15 minutes on average), leading to the LIDAR system running out of journal memory space after 250 hours or roughly ten and a half (10.5) days of continuous operation. The frequency of journaling (e.g., the trigger events described above) may thus be adapted as a function of the expected life of the product.

FIG. 6 shows a memory portion 600 in a schematic view according to various aspects. The memory portion 600 may be a portion of a memory device of a LIDAR module (e.g., of a memory device 108 of the LIDAR module 100). The memory portion 600 may include a plurality of sub-portions 602. The memory portion 600 and the sub-portions 602 may be associated with respective memory addresses 604. The memory portion 600 may be understood as a “Firmware History Table”, as described in further detail below.

In various aspects, a recording of the firmware version running in the LIDAR module may be provided, to associate the occurrences of the aging events with the firmware. This may provide evaluating the impact of firmware updates on the aging of the LIDAR module. Illustratively, a memory of the LIDAR module (e.g., one of the memory devices 108 of the LIDAR module 100) may store data associated with each firmware version of the LIDAR module (e.g., may include a memory portion, the memory portion 600, storing the firmware data).

The LIDAR module may provide (e.g., transmit, for example via the one or more communication interfaces 110) not only its current firmware number (e.g., during a maintenance check of the car), which may provide assessing whether or not to perform an update, but in addition the module may provide a complete history of all firmware versions ever running on the system. The history may be stored in a dedicated “Firmware History Table”, e.g. in a dedicated memory portion 600, shown in FIG. 6. This approach may provide the possibility for the LIDAR module manufacturer to be in a better position in case of customer complaints or even law suits concerning the product. For example, it may be proven that a faulty firmware version was never running a certain product, hence this faulty firmware cannot be the root cause of an issue.

As shown in FIG. 6, the dedicated memory portion 600 may include a first column 606-1 storing the firmware revision number (e.g., column I, as 3 bytes, VerNum0, VerNum1, . . . VerNum63, as examples), a second column 606-2 storing the time of the first boot-up with the respective firmware version (column II; as 4 bytes, TimeDate0, TimeDate1, . . . , TimeDate63, as examples), a third column 606-3 storing the counter/bucket values of power up events (column III; as 4 Bytes, PwrUps0, PwrUps1, . . . PwrUps63, as examples), and a fourth column 606-4 storing the operating time (column IV; as 5 bytes, OpTime0, OpTime1, . . . , OpTime63, as examples). Illustratively, the data associated with a firmware version (e.g., each line of the table may be associated with a respective firmware version) may include the aging events occurred during the time in which that firmware version was running in the LIDAR module. The time information (e.g., the current date and time) may be taken from a clock (e.g., the clock 120), for example a RTC.

In various aspects, in addition to storing the counter/bucket values of power ups and operating hours, also the (overall weighted) cumulated time at elevated temperature, the (cumulated weighted) number of temperature cycles and the (cumulated weighted) number of mechanical shocks, illustratively all “global quantities” at the time of a new firmware update may be recorded in the “Firmware History Table” (e.g., in the memory portion 600). These weighted cumulated numbers may be generated from each of the respective arrays, illustratively from the memory portions storing the respective aging events. The array may include the historical data with respect to elevated temperatures, temperature cycles, and mechanical shocks. The one or more processors of a LIDAR module may be configured to carry out a respective weighting-cumulating-function. This function (e.g., a subroutine) may be configured to take each cell of the respective array (illustratively, the content of each sub-portion of the respective memory portion), to multiply it by a weight and to sum up the weighted cell values providing/returning a single number (to be stored in the “Firmware History Table”). The weights may be chosen to be roughly proportional to the impact on product life (e.g., the higher the acceleration magnitude of a respective bucket, the higher the weight; with this approach, a lot of shocks with lower magnitude may turn out to give the same cumulated weighted number of mechanical shocks as a very few with high magnitude).

In various aspects, the “Firmware History Table” may be located in the same memory area as all the lifetime-related data. This memory area may be not erased when parts or the entire firmware of the LIDAR module are updated.

In various aspects, every time during the power-up of the control circuit of a LIDAR module, e.g. of the control circuit 106, (as part of the code executed during startup/boot-up), the current firmware revision version may be read out (of the executable code area, e.g. in FLASH memory) and compared with the firmware revision number it used at the last boot-up (e.g., which may be found as the last line in the “Firmware History Table”). The “Firmware History Table” may be stored, for example, in EEPROM memory or a different area of the FLASH memory (an area of the FLASH memory where also the other lifetime-related (historic) data is being stored). In case the two version numbers are different (which means a firmware update happened before the restart) then a new line may be added to the “Firmware History Table” at the end of the respective list. The new line may include the current version number, the actual time (e.g., taken from the RTC, or requested by the module from the outside, for example in case the car is still connected via a diagnosis system), and the current values of the counters for power up events and operating hours.

In various aspects, the “Firmware History Table” may be realized as a ring-buffer. In addition to the “Firmware History Table” the current line number of the table may be stored. The current line number may be stored elsewhere in memory with respect to the “Firmware History Table”, for example right before the beginning of the memory area of the “Firmware History Table” or right after the table (e.g., in the immediately preceding or in the immediately following Byte). The current line number may be interpreted as the pointer to the current line holding (amongst other information) the firmware version number present at the previous startup. Every time a new firmware version is detected, and a new line would be written, first the current line number may be modified and then the new line may be written to the respective line determined by the modified line number. The modification of the line number may include increasing the current line number by one unless the current line number points to the end of the table. In case the table is exhausted, then the current line number may be reset (e.g., the number set to an initial value, for example to 0) resulting in an overwriting of the first line of the table (essentially corresponding to the behavior a ring buffer).

In the following, with relation to FIG. 7A to FIG. 7D, the use of the bucket approach will be described with particular detail in relation to the aging of optical components, which are an important part of LIDAR applications.

FIG. 7A, shows a plurality of memory portions associated with an optical component of a LIDAR module (e.g., with an optical component 132 of the LIDAR module 100). FIG. 7B, shows a look-up table associated with an optical component of a LIDAR module (e.g., with an optical component 132 of the LIDAR module 100). FIG. 7C, shows a plurality of memory portions associated with an optical component of a LIDAR module (e.g., with an optical component 132 of the LIDAR module 100). FIG. 7D, shows an updating of the content of a memory sub-portion in a schematic view according to various aspects.

The aging of optical components (e.g., of the optical components 132 of the LIDAR module 100) may be mainly impacted by temperature, zoom status, optical power, and mechanical shock. Temperature, zoom status, and mechanical shock may be recorded independently of each other per critical optical element using the bucket approach described above.

In principle also the optical power may be measured and recorded in the same way. A different approach for the optical power may also be provided, in which:
(a) the data concerning the transmitter pixels (e.g., the laser diodes) may be already recorded (for other purposes) and may be “re-used” for aging assessment of optical components with very little efforts; and
(b) more accurate aging predictions of optical components may be made in case historic values of optical power and operating temperature (e.g., with a synchronous recording of both values) are available.

Three possible implementations of the above-described approach for the optical power are provided in the following. It is however understood that other approaches may be possible.

### (1) Total Number of Pulses

When determining (e.g., deriving, or calculating) the total number of pulses through an optical component from (recorded) transmitter data, the option (a) above is leveraged (e.g., the one or more processors of the LIDAR module may be configured to determine the total number of pulses through an optical component based on the number of light pulses emitted by the light emission system). This approach may be advantageous, in particular, in case pulses of constant power are generated by the transmitter. As an example, the light emission system may be configured in such a way that the pulse shape (amplitude, duration, etc.) is not adjustable, and the optical power through the critical optical components of the transmitter path may be assumed to be the same for every single pulse. This may be the case, for example, in case the system includes a control loop configured to modify the power provided to the laser diode(s) slightly depending on the laser diode(s) temperature and thereby compensating the laser diode's temperature dependency on optical power output.

The derivation of number of pulses from the recorded transmitter data may be dependent on the type of transmitter data being recorded (e.g., being available to the control circuit, e.g. to the one or more processors). Illustratively, it may be dependent on the format/type of data:
(a) in case the number of pulses the transmitter generates is available/recorded, the number of pulses through the optical elements may be identical to the transmitter pulses (or may be directly derived from this data considering optical aspects);
(b) in case the operating time of the transmitter and the average pulse rate are available/recorded, the number of pulses through the optical elements may be calculated by multiplying the operating time with the average pulse rate, optionally adjusting this result by considering optical aspects.

As a numerical example, the primary collimator of a LIDAR module which was operated for 5000 hours, in which only during 10% of the time the transmitter was generating light with a pulse frequency of 10 KHZ, was exposed to 18 billion pulses (5000 h×0.1×3600 s/h×10000 1/s=18×10\hat{ }9).

In case the recorded transmitter data is used the number of pulses for the assessment of optical component(s) aging may be derived without significant computational efforts and without any additional memory.

### (2) Total Number of Pulses Per Optical Pulse Power Level/Bucket

In case the LIDAR system (e.g., its one or more processors) is configured to control the optical output power (e.g., to actively control the light amplitude based on the environment, or using amplitude shift keying for communication), a “bucket approach” considering different transmitter power level (and thereby indirectly transmit pulse energy levels) may be applied, instead of only recording the number of transmitter pulses (or transmitter operating time and pulse frequency).

The same approach, as described above for (1) may be applied for deriving the number of pulses with a certain energy level through a respective optical element based on the available transmitter data.

The recorded transmitter data (e.g., as described in FIG. 3F, and with array indexes for the first and last line shown for convenience in FIG. 7A) may initially have been recorded to assess the wear of the laser diode(s)/transmitter pixels due to operation. FIG. 7A may show a plurality of memory portions 710a-710f with a plurality of sub-portions 712 (e.g., sixteen sub-portions 712-1 to 712-16) and respective memory addresses 714 corresponding to the memory portions 310a-310f, the sub-portions 312, and the memory addresses 314 described in relation to FIG. 3F, with the addition of respective row/column indexes (e.g., from 0/0 in the top left corner, to F/5 in the bottom right corner).

Referring to FIG. 7A, the data stored in the memory portions 710a-710f may be used to estimate the optical power through critical optical components of the transmit path. A predetermined (e.g., hard-coded in the module's firmware) mathematical formula and/or algorithm may be applied, taking the drive current (or electrical power) of the laser diode and/or transmitter pixel and/or transmitter module and its temperature as the two input parameters.

As an example, the algorithm may include a look-up operation using a look-up table to determine the optical pass-through power per pulse from the recorded temperature and pulse current (as such data may be already available for determining emitter aging). The array/table/map index from the recorded data, e.g., the row/column indexes shown in FIG. 7A, may be used to select the optical pulse power value/level from the look-up table. An example of a look-up table 720 is provided in FIG. 7B, including a plurality of values 722 (e.g., sixteen values 722-1 to 722-16 per portion, in the exemplary representation in FIG. 7B) with respective addresses 724. Each value 722 may be referenced by corresponding indexes (e.g., a corresponding row/column index).

Depending on the scaling of the values in the look-up table (e.g., in the look-up table 720), the value may correspond to a power level in Watts, or just a power level bin (as described under (3) below). In relation to deriving the power level, as provided by the look-up table 720 in FIG. 7B, a predefined number of Bytes (e.g., two Bytes) may be used as “conversion factor” converting the index to the optical power level of the generated pulse. The values of the look-up table may include known effects in laser diodes and LEDs, such as like current droop (illustratively, the light output may increase less than linearly with an increase in drive current) and temperature droop (illustratively, the light output may decrease with increasing temperature of the emitter). The determined power level in Watts as well as the number of pulses may then be used as inputs for determining the aging of the respective optical component using the dedicated aging model of the respective optical component.

In various aspects, during “normal” operation, the look-up table (e.g., the look-up table 720) may be used as read-only memory. For example, the table 720 may be allocated in a read-only memory, such as OTP (one-time-programmable) memory (ROM), or a memory having slow write-performance, such as EEPROM or FLASH memory (e.g., as indicated by the addresses 724 in the exemplary configuration in FIG. 7B). Upgrading of aging models after production, as described above, may be advantageous, and using a non-volatile read-write memory like EEPROM or FLASH memory for the look-up table may allow upgrading the aging models.

### (3) Total Number of Pulses Per Optical Pulse Power and Per Temperature Level/Bucket

As mentioned under point (2) directly above, instead of deriving the pulse power in Watts, the index of the respective bucket for counting the pulses created with a respective current through and temperature of the diode may be used to map the index to an optical power level bin. In case of power bins, a few bits per element of the look-up table (similar to those of FIG. 5E to FIG. 5G) may be sufficient. In case, for example, all potential power levels are classified into 16 bins of optical peak power (as described in Table 3 below), e.g. ranging from 0 W to 120 W plus a maximum production tolerance of +5%, then only 4 bits of memory per element of the look-up table may be used, thereby storing two elements in a single Byte. In this configuration the look-up table 720 shown in FIG. 7B may occupy only 48 Bytes instead of 192 Bytes.

TABLE 3

| Array | From | To | Delta | | |
|---|---|---|---|---|---|
| Index | [W] | [W] | [W] | Range | |
| 0 | 0 | 24 | 24 | <24 | W |
| 1 | 24 | 43 | 19 | 24 W . . . <43 W | |
| 2 | 43 | 58 | 15 | 43 W . . . <58 W | |
| 3 | 58 | 69 | 11 | 58 W . . . <69 W | |
| 4 | 69 | 79 | 10 | 69 W . . . <79 W | |
| 5 | 79 | 87 | 8 | 79 W . . . <87 W | |
| 6 | 87 | 94 | 7 | 87 W . . . <94 W | |
| 7 | 94 | 100 | 6 | 94 W . . . <100 W | |
| 8 | 100 | 105 | 5 | 100 W . . . <105 W | |
| 9 | 105 | 110 | 5 | 105 W . . . <110 W | |
| 10 | 110 | 114 | 4 | 110 W . . . <114 W | |
| 11 | 114 | 117 | 3 | 114 W . . . <117 W | |
| 12 | 117 | 121 | 4 | 117 W . . . <121 W | |
| 13 | 121 | 123 | 2 | 121 W . . . <123 W | |
| 14 | 123 | 126 | 3 | 123 W . . . <126 W | |
| 15 | 126 | | | ≥126 | W |

The approach described so far is very similar to the one described under (2) above, except for using temperature bins instead of peak power values. A main difference with respect to the previous approach may be that in this approach the temperature of the optical component is considered in the recording. The temperature may be derived by measurement(s) using temperature sensors and/or thermal modeling using known power dissipations by components inside the LIDAR module in addition to known or measured module environment temperature(s)/module housing temperature(s). Instead of saving the actual temperature value, buckets/bins for recording the temperature may be used, as shown in Table 4 below. As temperatures of optical components may be lower than those of transmitter pixels, a different set of bins compared to the temperature binning shown in Table 1 may be provided (illustratively, the temperature ranges associated with the memory sub-portions may be different, as shown in Table 4).

TABLE 4

| Array | From | To | Delta | | |
|---|---|---|---|---|---|
| No. | [° C.] | [° C.] | [° C.] | Range | |
| 1 | | −25 | | <−25° | C. |
| 2 | −25 | −10 | 15 | −25° C. . . . <−10° C. | |
| 3 | −10 | 5 | 15 | −10° C. . . . <5° C. | |
| 4 | 5 | 20 | 15 | 5° C. . . . <20° C. | |
| 5 | 20 | 35 | 15 | 20° C. . . . <35° C. | |
| 6 | 35 | 50 | 15 | 35° C. . . . <50° C. | |
| 7 | 50 | 60 | 10 | 50° C. . . . <60° C. | |
| 8 | 60 | 70 | 10 | 60° C. . . . <70° C. | |
| 9 | 70 | 80 | 10 | 70° C. . . . <80° C. | |
| 10 | 80 | 90 | 10 | 80° C. . . . <90° C. | |
| 11 | 90 | 95 | 5 | 90° C. . . . <95° C. | |
| 12 | 95 | 100 | 5 | 95° C. . . . <100° C. | |
| 13 | 100 | 105 | 5 | 100° C. . . . <105° C. | |
| 14 | 105 | 110 | 5 | 105° C. . . . <110° C. | |
| 15 | 110 | 115 | 5 | 110° C. . . . <115° C. | |
| 16 | 115 | | | ≥115° | C. |

The bucket approach may be applied as described in the case (2) above, however in the present approach the classification may be carried out according to the temperature using a two-dimensional array for counting the number of pulses. This approach is illustrated in FIG. 7C, showing a plurality of memory portions 730a-730d, each associated with a respective temperature range (e.g., T<−25° C., −25° C.<T<10° C., 110° C.<T<115° C., and T≥115° C. respectively, as numerical examples), each memory portions 730a-730d including a plurality of sub-portions 732 (e.g., sixteen sub-portions 732-1 to 732-16 in the exemplary configuration in FIG. 7C) associated with a respective optical power range (in Watts, according to Table 3), and respective memory addresses 734. Every time a pulse is emitted the optical power and the temperature of the optical component may be determined. The temperature may determine which of the (e.g., which the arrays of 16 one-dimensional arrays) holding the count numbers is selected, whereas the pulse power may determine the index of the respective array element which will be updated, e.g. increased by one. So whenever one of the buckets in FIG. 3B (FIG. 7A) is updated (e.g., increased) also one of the buckets of FIG. 7C may be updated (e.g., increased).

FIG. 7D may illustrate the approach (3), to show an example of how to determine the bucket to be updated (e.g., increased). For the sake of representation, FIG. 7D is split into FIG. 7DA, FIG. 7DB, and FIG. 7DC, it is however considered and described as a single figure. The exact same index of the element (which was just increased/written to; marked with a X with an engraved W in portion FIG. 7DA of FIG. 7D) of the array tracking the number of pulses of the laser diode may be used to access the look-up table. In the exemplary configuration in FIG. 7D, the index of the sub-portion 712a of the memory portion 710b may be used to access the corresponding element (having the corresponding indexes) of the look-up table 720. The element 722a of the look-up table 720 to be read is indicated by a X with an engraved R in portion FIG. 7DB of FIG. 7D. The value read from the lookup-table 720 may provide the index of the element 732a (marked as X with an engraved W in portion FIG. 7DC of FIG. 7D) in the 1-dimensional array (e.g., in the memory portion 730c) that is to be increased/written to. The correct 1-dimensional array may be selected by using the temperature associated therewith.

As described above in relation to the recording of large numbers of aging events, e.g. in the case of the emitted light pulses (e.g., laser pulses), in various aspects a subsampling approach may be provided, as described in FIG. 8.

FIG. 8 illustrates a subsampling process for the recording of aging events in a schematic view according to various aspects.

The subsampling may prevent exhausting the buckets quickly. The pulses (illustratively, the train of events) may be subsampled in such a way that the statistics with respect to the number of pulses, temperatures and peak currents (e.g., of the laser diode) may be preserved. A single sample per predefined period of time may be taken, e.g. a single sample every minute as a numerical example.

In case a LIDAR module (e.g., the LIDAR module 100) includes a plurality of light sources (e.g., a plurality of laser diodes) the subsampling may be carried out in a way that ensures that also the distribution of pulses between light sources gets preserved when subsampling. In case all light sources are fired equally often (illustratively, with a same rate) by design, then the distribution is automatically preserved. In case the number of pulses may vary between the different light sources, an adapted approach may be provided. The adapted approach may include checking which light source (e.g., which laser diode) was fired last when the time for subsampling has come and then record its status (e.g., every minute). In case all light sources are fired equally often, then all light sources may be sampled, e.g. every minute. In the following (in particular for the approaches outlined below) it may be assumed that multiple light sources (e.g., multiple laser diodes) are all being fired at the same time, but illuminating different areas of the field of view.

Whenever the (sub-) sampling is happening, the value present at the last pulse for the respective light source (the one used last in case only a single light source is sampled) or for each light source is being used. The current value may still be read out of the respective control register(s) of the driver control, and the temperature sensor(s) may be sampled just now (in other words, the temperature acquisition may be started), as temperatures do not change that quickly the error caused by the time it takes to acquire the temperature value(s) is negligible with respect to potential temperature changes of the light sources. In case this simplification does not hold, then a pre-trigger may be generated starting the acquisition at the right time, e.g. synchronized with the firing of the respective light source (e.g., the respective laser diode).

In various aspects, the subsampling may be carried out in a way that is “uncorrelated” from the timing of the image acquisition and/or having a constant probability of sampling at any time regardless of the imaging. An array of buckets per emitter pixel (e.g., per laser diode) may be a good representation of how the pixel is being operated due to the averaging over time. With this approach theoretically a bucket could overflow after a number of hours that may be determined under the assumption that the module is operated at constant temperature with a completely homogeneous scene leading the vision-based control to fire the light source (e.g., the laser) always with the same peak current.

The sampling mechanism may be implemented in such a way that is not correlated with the imaging process to avoid non-uniform (sub-) sampling. In case of an unwanted “correlation” the sampling may always happen when the pixel(s) of a specific area of the image (e.g., the upper right corner) are illuminated, and averaging over only these pulse events may lead to a skewed representation of how the light sources are used throughout the product life. An exception where a correlation may be acceptable are FLASH systems, in which the pulse power to illuminate the scene is not varied.

Depending on the actual system implementation a number of approaches for realizing this subsampling may be provided. Illustratively, the number of light pulses emitted by a light source of a LIDAR module (e.g., by the light source 126 of the LIDAR module 100, e.g. the number of laser pulses emitted by a plurality of laser diodes) may be subsampled by using at least one of the following approaches.

### (1) A Periodic Non-Synchronous Timer

During the operation of the transmitter sub-system of the LIDAR module (e.g., the LIDAR module 100), a periodic timer (for example, implemented as a continuously running very slow clock) may be provided to sample the status of each emitter pixel. The timer duration may be selected in such a way that the duration is not a multiple of the image repetition time. As a numerical example, the timer duration may be approximately 1 minute, or approximately 2 minutes. By choosing the timer to be non-synchronous with the image, the sampling of the status of the emitter pixels (the laser diodes) appears uncorrelated to the imaging or effectively random.

FIG. 8 illustrates an example of subsampling, e.g. the subsampling for a 1D scanning LIDAR system having laser diodes (e.g., eight laser diodes 802-1 to 802-8, LD1 through LD8) disposed along one dimension, e.g. arranged in horizontal direction covering the vertical field of view.

In this exemplary case, the pixel clock may be generated by subdividing a 20 MHz signal from a crystal clock by a 7-bit counter (by 128) thereby generating a pixel clock fpix=156.25 kHz (equaling a pixel duration of 820 Tpix=6.4 μs). Assuming that the system is a 1D-scanning system with a 1024 pixel (horizontal) the image be scan resolution, repetition frequency may approximately 152.6 Hz, e.g. considering that the image repetition duration equals 822 TImg=1024×6.4 μs=6.5536 ms). A sample may be taken approximately every 9155.3 frames for taking a sample every minute. A timer with a precise 60 s period 824 TAcq may be used to (sub-) sample the respective laser diode status, thereby falling in-between the two image acquisition starts at 59.998208 s (illustratively, provided by 9155 frames multiplied by the TImg of 6.5536 ms) and 60.0047616 s (illustratively, provided by 9156 frames multiplied by the TImg of 6.5536 ms). Assuming an initial start for both the timer and the image acquisition system at time 0, then at time 0 the laser diode status got sampled (event 804-1 A1, happening at the beginning of the first image 808-1 IMG1), as while pixel 806-1 hp0 (the first pixel of the horizontal scan) was acquired, at the time 60 s the status gets sampled (event 804-2 A2, happening during the acquisition of the 9156th image 808-N IMG9156) while pixel hp280 gets acquired. Illustratively, the sampling was initiated when pixel 806-1 hp0 was acquired, as carrying out the temperature measurements and saving the data to memory will very likely take longer than the pixel acquisition time.

(2) A Periodic Synchronous Timer with Continuously Varying Offset

The second approach may be implemented by two stages.

The first stage may include waiting until counter/timer (e.g., first counter or first timer) indicates a defined (and constant) number of image acquisitions has happened (e.g., 9000 image acquisitions, as a numerical example, to be adapted according to the desired sampling rate). In various aspects, the counter may get the respective trigger pulses and/or trigger information by an image synchronization pulse generated by the acquisition system every time a full image has been acquired. In various aspects, the counter may be immediately reset and read for again counting up to a predefined value (e.g., 9000) as soon as the next synchronization pulse is received.

The second stage may be carried out after the first stage has fired. In case of a FLASH transmitter sub-system, the second stage may include a sampling being carried out right away (as mentioned above, having a correlation from a timing point of view for the image acquisition and the (sub-) sampling of the laser diode status is of no concern). In case of a scanning system architecture, either an additional timer or an additional counter (e.g., a second counter or a second timer) may be started. The time or the preset count may be successively (e.g., with every sampling event, illustratively every time the second stage gets activated) modified between an initial value (e.g., 0) and the time it takes for one full image acquisition (illustratively, the image repetition time; with the assumption that there are “no time-gaps” in-between images, otherwise the approach may be modified to distribute the sampling only over the time where the laser diodes are operated, that is the acquisition time, and time-gaps are not (sub-)sampled). After the second timer or counter has lapsed the (sub-)sampling is accomplished. By successively modifying the small delay caused by the second timer/counter the sampling may appear at different times of the image acquisition and/or of the entire image and/or of the pixels of the image.

By way of illustration, the second approach may be understood as an alternative implementation of the first approach, in which the counter or timer of the first stage, which is synchronous with the image acquisition, gets into turned an non-synchronous (sub-)sampling signal by the offset generated by the second stage.

(3) A Periodic Synchronous Timer with Random Time Delay

In the third approach, the second stage of the second approach may be replaced by a random time delay. A LIDAR module (e.g., the LIDAR module 100) may include a random time generator. The random time generator may be configured to provide delay times with a predefined (e.g., rectangular) probability distribution. The random time generator may be configured to span times of one or multiple of the image acquisition duration.

In various aspects, the third approach may be implemented with a single timer, rather than with a two-stage implementation. Every time the (single) timer is up, the timer may be restarted, a (sub-) sampling may be triggered and in addition firstly a random number may generated (e.g., the system may have approximately 1 minute to generate the new number, as an example) and secondly added to a constant. The constant may be approximately equal to the timer set value needed for a time of a predefined duration, e.g. a time of 1 minute (a constant equaling to 1 minute may be understood as an offset on top of the time delay caused by the random number). The result of this summation may be provided as the new set value for the timer.

### (4) A Low Accuracy Clock (Determining Subsampling)

In various aspects, the subsampling may be provided by means of a clock or periodic timer with a predefined duration, e.g. a duration of approximately 1 minute, which is non-synchronous to the image acquisition, similarly to the first approach. In the fourth approach, the timer/clock (e.g., realized by an RC-timer) may have a (fairly) low accuracy (e.g., lower compared to the case without subsampling). Illustratively, the actual timer duration may show a significant temperature-dependency and/or the actual timer duration may show significant jitter (fluctuations over time, potentially appearing as being random in nature). Such clock/oscillator/timer features may be typically unwanted for any timing circuitry, but may be utilized to the advantage for subsampling, as the low-accuracy ensures a nicely well-distributed (sub-) sampling.

(5) A Periodic Synchronous Timer with Continuously Varying Offset (e.g., in Increments of Pixel Duration)

In various aspects, providing an uncorrelated timer may be not possible or not feasible, e.g. depending on how the timing within the system/control is organized it may cause lots of effort to have an uncorrelated timer. The fifth approach may address these issues. The fifth approach may include two stages as the second approach. The first stage may be identical to the first stage of the second approach. The first stage may be synchronized to the image repetition frequency and may generate a delay of multiple of the image frame duration. The second stage is different compared to the second approach. In the fifth approach, the second stage may be implemented by a timer of counter, and the time offset added to the delay time of the first stage may be continuously varying by increment of the pixel duration. The second stage may be implemented, for example, by a count-down counter configured to trigger the subsampling and which is reset every time it reaches a predefined value (e.g., zero). The reset value may be provided by a second counter which is an up-counter triggered by the first counter (illustratively, by the down-counter). The second counter may be updated (e.g., increased by one) every time the first counter reaches the predefined value (e.g., zero). If the second counter reaches a predefined number (e.g., 1024 assuming the 1D scanning LIDAR system has a 1024 pixel (horizontal) scan resolution) it may be reset (illustratively, it may be configured to count between 0 and 1023, as a numerical example).

By way of illustration, the fifth approach may be similar to the second approach, in which the truly non-synchronous counter/timer in the second stage of the second approach is replaced by a pixel-synchronous counter/timer which is still (somewhat) non-synchronous with the image repetition.

In the following, in relation to FIG. 9A to FIG. 9D, additional aspects related to an exemplary model for calculating the remaining lifetime of a LIDAR module (e.g., of the LIDAR module 100) and to the possible uses of the data will be described.

In various aspects, data processing may be triggered by an internal event or an external request (e.g., a request received via one of the communication interfaces of the product). The data processing (e.g., by the control circuit 106, e.g. by the one or more processors 102) may realize one of the following features:
(1) Product Monitoring;
(2) Product Usage Analysis; and/or
(3) Real-time Remaining-Life-Estimator (as described in further detail below).

With relation to product monitoring (1), the control circuit (e.g., the one or more processors) of a LIDAR module (e.g., the one or more processors 102 of the LIDAR module 100) may be configured to provide information about the current status of the LIDAR module. The product monitoring may involve the least data processing (e.g., compared to the usage analysis and the lifetime estimation), as the monitoring feature may be configured to “only” provide the product status right now. Upon trigger by the external request or internal event, either the value(s) is (are) already available in registers or memory (e.g., operating time up to now, number of power ups up to now, etc.) or sensor values may be provided (e.g., provided by one or more monitoring sensors of the LIDAR module).

In case of sensor values (e.g., the present temperature of the housing, the present input voltage, etc.) being requested, the next steps may be carried out as a function of whether or not sensor data was just very recently acquired by the respective sensor (e.g., in the 10 minutes preceding the request, or in the 5 minutes preceding the request, as examples). In the first case, the recently acquired sensor data may be used. Otherwise, the acquisition process of the sensor may be triggered (e.g., of one or more of the monitoring sensors, in accordance with the requested information). After the acquisition of the sensor value (or several sensor values with consecutive averaging in case of noisy sensor), the sensor value may be provided (e.g., transmitted).

The requested data may be converted in the respective data format described by the data communication protocol and/or used API (application protocol interface) before being finally communicated.

With relation to product usage analysis (2), the control circuit (e.g., the one or more processors) of a LIDAR module (e.g., the LIDAR module 100) may be configured to process and further aggregate stored data as a function of which data and with which level of granularity have been requested.

As a first exemplary scenario, for a request on how many hours the product was operated at a temperature greater than 70° C., all elements of the operating hour array may be summed-up starting from the index belonging to the 70° C.-80° C. range (as a numerical example).

As a second exemplary scenario, a request received over the communication interface on how many laser pulses were emitted by the product in total up to now may be first acknowledged from the product by sending an acknowledgement message with a request ID. The request ID may be created by the product. Thereafter (e.g., as a low-priority task for the processor) all buckets (e.g., buckets for different temperatures and different peak currents) may be added up by the processor(s) of the control circuit to derive the total number of pulses. This number may then be communicated together with the initially created request ID (linking this message to the original request) using the communication interface.

With relation to predictive maintenance (3), in various aspects, the control circuit (e.g., the one or more processors) of a LIDAR module (e.g., the LIDAR module 100) may be configured to apply a global lifetime function, as described in further detail below. The global lifetime function may be configured to provide the estimated remaining life t_{R} (t) of the LIDAR module at any point in product life/time t. The global lifetime function and all other related functions and routines (which are run before the global lifetime function is called) may be part of the “aging model” for the LIDAR system, and may be upgrade-able, as described above. In the following, the modifications of formulas, tables, and data used to assess aging (also referred to as “degradation functions”) will be described.

As described, for example, in relation to FIG. 1A and FIG. 1B, an aging aspect (an aging mechanism) may describe one aspect that may impact product life, e.g. may lead to the product not being able to perform its function anymore. An example may include the bond wire failure (e.g., due to breaking, electrical overstress, etc.) inside the laser diode. This example may be an aging aspect on component level. Another aging aspect may include the deterioration of optical performance of the transmit path, including deterioration of the laser diode light output and optical transmissivity of other optical elements in the transmit path. An optical deterioration resulting in the generation of less than a predefined threshold (e.g., less than 70% light to the original light output of the LIDAR module), thereby leading to the module not having sufficient range any longer, may be understood as end of life. The second aging aspect may be an aging aspect on sub-system level, e.g. the transmitter sub-system. Considering all (relevant) “n” aging aspects in the global lifetime function may provide the estimated remaining life.

Considering, for the sake of explanation, aging aspect number k, being one of the n aging aspects which may be considered for the overall LIDAR module. As an example, the aging aspect k may describe the aging of the transmitter sub-system. In case the LIDAR module is operated as assumed during design, the transmitter sub-system may last the time T_{EL,k}, where “EL” stands for “Engineered Life”. The evolution over time t of the estimated remaining life t_{RiE,k}(t) may be given by the equation:

t_{RriE,k}(t)=T_{EL,k}−t. (1)

FIG. 9A shows a graph 900a illustrating the remaining lifetime 910 t_{RiE,K} (illustratively, a line 910 representing the remaining lifetime) associated with aspect k, linearly decreasing from a starting value 906 corresponding to the engineered life (T_{EL,k}). The graph 900a may have the time t along the horizontal axis 902, and the remaining lifetime associated with aspect k t_{R,k}(t) along the vertical axis 904. The remaining lifetime ends with no remaining time left at the end of life 908 t=T_{EL,k}.

Illustratively, the one or more processors LIDAR module (e.g., the one or more processors 102 of the LIDAR module 100) may be configured to estimate a remaining lifetime of a component (e.g., of the one or more components 104) by estimating a respective partial remaining lifetime defined by each aging mechanism associated with that component. The one or more processors may be further configured to select as remaining lifetime of the component the shortest partial remaining lifetime among the partial remaining lifetimes defined by the aging mechanisms associated with that component. In various aspects, the one or more processors may be further configured to transmit, e.g. in response to the request, data representative of which aging mechanism associated with the component having the shortest estimated remaining lifetime defines the shortest partial remaining lifetime.

The one or more processors may be configured to estimate the remaining lifetime of the component based on a predefined lifetime of the component adjusted in accordance with the aging data associated with the component. The one or more processors may be configured to estimate the respective partial remaining lifetimes defined by each of the one or more aging mechanisms associated with that component based on the predefined lifetime of the component adjusted in accordance with the respective aging data related to the one or more aging mechanisms associated with that component (e.g., the aging aspect k, and the other aging aspects associated with that component). The overall remaining life may be based on individual predefined lifetimes of the respective components and an adjustment based on the aging data.

Very likely the LIDAR module is not operated under exactly those operating conditions as assumed during design. For example the LIDAR module may be operated at a different temperature. An operation of the transmitter module may be carried out at a temperature other than ϑ₀ (illustratively, a temperature other than at a defined reference point inside the transmitter module), e.g. all the time or for part of the time. In case the actual temperature ϑ of the transmitter module is different than ϑ₀, or in general in case the operating conditions of the LIDAR module are different than predefined conditions, then for aging aspect k a temperature correction factor Jₖ, as illustrated in FIG. 9B, may be provided, e.g. may be determined experimentally.

FIG. 9B shows a graph 900b illustrating a relationship between an aging aspect (e.g., the temperature ϑ, along the horizontal axis 912) and a respective correction factor (J(ϑ), e.g. for the aspect k, Jₖ(ϑ), along the vertical axis 914).

The correction factor may be configured to adjust the measured time, in such a way that the time effectively runs slower in case of temperatures lower than the predefined value 916 ϑ₀ or faster in case of operating temperature being greater than the predefined value 916 than ϑ₀. The remaining life of the LIDAR module, in case the only lifetime limiting aspect would be the aging aspect k, may be provided (over time) by the following equation:

t_{R,k}(t)=T_{EL,k}−∫₀^{t}Jₖ(ϑ(τ)dτ. (2)

The correction factor may be implemented (e.g., in the control circuit) using the “bucket approach” described above (e.g., in FIG. 3A to FIG. 3G). It is assumed, as an example, buckets 0 to M, e.g. M=63, spanning the temperature range ϑ_{L} to ϑ_{H} arranged in a linear array B(l) with array elements B(0), . . . , B(l), . . . B(M). Whenever the transmitter module has been (cumulatively) operated for a time δ at a temperature within the temperature range

l(ϑ_{H}−ϑ_{L})/(M+1)+ϑ_{L} . . . (l+1)(ϑ_{H}−ϑ_{L})/(M+1)+ϑ_{L},

being covered by bucket 1, the respective bucket count may be updated, e.g., may be increased by one:

B[l]:=B[l]+1.

In various aspects, the function Jₖ(ϑ) may be approximated by a look-up table J. As an example, the memory of a LIDAR module may store a look-up table including the adjustment factors or the coefficients of the formulas to determine the adjustment factors of each sub-portion of the plurality of sub-portions associated with a component. To derive the look-up table the function Jₖ(ϑ) may be evaluated at the respective center temperatures ϑ_{c}(l) for each bucket l which is ϑ_{c}(l)=(l+0.5)(ϑ_{H}−ϑ_{L})/(M+1)+ϑ_{L}. The look-up table may be

J[l]:=Jₖ(ϑ_{c}(l)=Jₖ((l+0.5)(ϑ_{H}−ϑ_{L})/(M+1)+ϑ_{L})

In various aspects, the integration over time (see equation 2 above) may be simplified by (e.g., approximated with) an accumulation over time (using the bucket) followed by a summation over all bucket values. The buckets may be weighted by the respective correction factor from the look-up table. The remaining life may therefore be approximated as follows (considering the time õ for which the transmitter module has been operated at a temperature within the temperature range described above),

t_{R,k}(t)˜T_{EL,k}−δΣₗ₌₀^{M}J[l]*B[l]. (3)

J[l] is referring to a value from the look-up table, which is an array of values that never change/get changed. B[l] is referring to the value of the 1-th bucket, which is varying (e.g., increasing) over the life of the product.

Illustratively, each sub-portion associated with a component may have an adjustment factor associated therewith, the adjustment factor being dependent on the range associated with the sub-portion. The one or more processors of a LIDAR module may be configured to estimate the remaining lifetime of the component based on the predefined lifetime of the component adjusted by using the counter value of each associated sub-portion weighted by the respective adjustment factor. As an example, as described in equation (3) above, the remaining lifetime may be calculated as a difference between an expected overall lifetime of the component, and the summation of the counter values of the associated sub-portions weighted by the respective adjustment factor.

FIG. 9C shows a graph 900c illustrating the estimated remaining life t_{R,k}(t) (in the vertical axis 934, with the time t in the horizontal axis 932) derived from aging aspect k while the product is aging. The graph 900c includes “now” as a point in time 936, denominated by t_{N}. Values for estimated remaining life t_{R,k}(t) beyond t_{N} are not available, as this time has not yet passed. And the estimated remaining life right now may be the point 938 T_{N,k}:=t_{R,k}(t_{N}).

To the total life 940 t_{L,k}, the decline of the remaining life over time may be averaged from time 0 (corresponding to the brand new product) until now. From this decline the total life may be extrapolated. The linear function may be given by interpolation between the points (0/T_{EL,k}) and (t_{N}/T_{N,k}):

$${t}_{Rl , k} ( t ) = {T}_{EL , k} - \frac{{T}_{EL , k} - {T}_{N , k}}{{t}_{n}} t$$

As the total life t_{L,k} fulfills the condition t_{Rl,k}(t_{L,k})=0, the total life only considering aging aspect k may be given by:

$${t}_{L , k} = \frac{{T}_{EL , k}}{{T}_{EL , k} - {T}_{N , k}} {t}_{N}$$

The estimated remaining life t_{RL,k} from now on assuming a continued use of the product as in the past (and linear extrapolation, e.g. the index “L”, while only considering aging aspect k) may be given by t_{RL,k}:=t_{L,k}−t_{N}:

$${t}_{RL , k} = \{ \begin{matrix}{T}_{EL , k} , for {T}_{N , k} = {T}_{EL , k} \\ \frac{{T}_{N , k}}{{T}_{EL , k} - {T}_{N , k}} {t}_{N} , otherwise\end{matrix}$$

Illustratively, the one or more processors may be configured to predict a behavior of the remaining lifetime of a component based on an estimated remaining lifetime of the component and the aging data associated with the component. The prediction may include extrapolating the behavior of the remaining lifetime based on a difference between the estimated remaining lifetime and an expected remaining lifetime, and the expected remaining lifetime may include a remaining lifetime of the component in case the component had been operated under factory-defined operating conditions.

As a division by zero is to be avoided, it may be first checked whether the estimated remaining life right now T_{N,k} is already different than T_{EL,k}, which is the starting value of t_{RL,k} according to equation (3) above. In case the estimated remaining life right now is T_{EL,k} then an extrapolation does not make sense as there may be no data to extrapolate and the remaining life to be returned may be T_{EL,k}.

The remaining life from now on may be different in case the use of the product from now on would go as anticipated during design. In this case the slope of the decline of the remaining life may be identical to the one of initially estimated remaining life t_{RiE,k}(t). The function describing the remaining life from now on with this (initially anticipated) slope (which is −1, as an example) may be defined as t_{Re,k}(t). It is illustrated in FIG. 9D. FIG. 9D shows a graph 900d illustrating different linear extrapolations of the remaining life at time t_{N}.

It may be expressed as,

t_{Re,k}(t)=T_{N,k}+t_{N}−t

The estimated remaining life t_{RE,k} from now on assuming a product use as anticipated at design (and only considering aging aspect k) may be t_{RE,k}=t_{LE,k}−t_{N}, with t_{Re,k}(t_{LE,k}):=0 (and as t_{Re,k}(t_{LE,k}):=0 leads to t_{LE,k}=T_{N,k}+t_{N}):

t_{RE,k}=T_{N,k}.

The result is not surprising, as the remaining life had been initially defined as the remaining life in case the product gets operated as designed.

In case a continued use of the product as in the past is assumed, the estimated remaining life from now on would be estimated as t_{RL,k}. In case it is assumed a product use as anticipated at design, then the estimated remaining life from now on may be t_{RE,k}. It may be generalized as t_{R*,k}(t) to be considered as the relevant estimated remaining life from now on in case the product is exposed to the aging condition *. As mentioned above, the product may instead be exposed to a completely different operating conditions from now on. This aging condition “U” may be understood as a user-defined aging condition. The description of the user-defined profile in this case may be provided (e.g., via the one or more communication interfaces 110) to the control circuit of the LIDAR module along with the request of estimating the remaining life under this condition.

Based on the above, three options for t_{R*,k}(t) may be determined:

$${t}_{{R}^{*} , k} ( t ) = \{ \begin{matrix}{t}_{RE , k} ( t ) , \\ {t}_{RL , k} ( t ) , \\ {t}_{RU , k} ( t ) .\end{matrix}$$

where t_{RE,k} is in the case of a use as anticipated at design, t_{RL,k} is in the case of a use that will continue as in the past, and t_{RU,k} is in the case of a use according to a user-defined profile.

Illustratively, the estimated remaining lifetime of a component may include at least one of: a first estimated remaining lifetime in case the element from now on would be operated under factory defined operating conditions; a second estimated remaining lifetime in case the element from now on would be operated under operating conditions as described by the aging data associated with the element; and/or a third estimated remaining lifetime in case the element from now on would be operated under user-defined operating conditions.

Regardless of how the aging from now will look like, the estimated remaining life t_{R*}(t) for the entire product at any point in time (e.g., at any point in product life t) may be determined by considering all the hypothetical individual remaining lifetimes provided (by all aging aspects) by the n aging aspects as part of the global lifetime function. The shortest of all these lifetimes t_{R*,k}(t) may limit the overall lifetime,

t_{R*}(t)=minₖ(t_{R*,k}(t)), with k∈{1 . . . n} (4)

Stated in a different fashion, the one or more processors may be configured to estimate as remaining lifetime of the component the shortest remaining lifetime of the first remaining lifetime, the second remaining lifetime, and the third remaining lifetime.

The estimated remaining life from now on (at time t_{N}) may be defined as follows, in case only the aging aspect k would be relevant and under the assumption that from now on the product will be operated under the anticipated operating conditions of product design,

t_{R*,k}:=t_{R*,k}(t_{N}),

and the estimated remaining product life may be defined as,

t_{R*}:=t_{R*}(t_{N}).

Considering the aging aspect j as the aging aspect with the lowest (in other words, the shortest) estimated remaining life of all the n aging aspects, parameter j may fulfill the following condition,

t_{R*}(t)=t_{R*,j}=minₖ(t_{R*,k}(t)), with k∈{1 . . . n} (5)

In addition to the estimated remaining life t_{R*}, also the index j may be reported as a result of the Predictive Maintenance request. With j it is then clear (to the receiver of the predictive maintenance request, e.g. a diagnosis software running in the LIDAR module maker's cloud) which component (or components), and which aging mechanism (or mechanisms) are limiting life. In various aspects, the aging aspect, and not an index pointing to a single component or sub-system, may be reported, as an aging aspect may capture the result of the multiple components aging at the same time. An example of a more complex aging aspect may include the laser light output deprecation to 80% of its original value with a probability of 3% (also referred to as “3% percentile”). The decrease in light output may be dependent on the aging of the laser diode die, the aging of the optical components of the laser diode, as well as the aging of a number of additional optical components in the optical transmit path.

Depending on the condition * specified in the request, not only the remaining life t_{R*} may be different depending on *, but also j may vary.

The implementation of the equations (4) and (5) in a control circuit (e.g., in the control circuit 106, e.g. in the one or more processors 102) may be rather simple, e.g. may include looping over all n remaining life times t_{R*,k}. These lifetimes may be calculated based on the specified condition * and may be held in an array R. As an example, at least two aging conditions k may be considered, that is n>=2, and the array R may have at least the elements R[1] and R [2]. While looping over R, the value and the index of the shortest time may be memorized in the variables t and j, as shown in the pseudo-code below,

```
t:=R[1]
j:=1
i:=1
WHILE i<n LOOP:
  i:=i+1
  IF R[i]<t THEN
    t:=R[i]
    j:=i
```

The above implementation may be understood as a real-time remaining-life-estimator providing not only an estimate on the remaining life (in operating hours) but also a pointer to the component or sub-system that will (most likely) fail first (as the next). Illustratively, in various aspects, the one or more processors may be configured to estimate the remaining lifetime of the LIDAR module by estimating for each relevant component of the LIDAR module (e.g., each component of the one or more components, or each component of a subset of components) a remaining lifetime of that component based on the aging data representative of aging events associated with that component, and selecting as remaining lifetime of the LIDAR module the remaining lifetime of the component having the shortest remaining lifetime among the relevant components.

The data recorded may be provided to respond to a request for information coming from outside the product as described above, for example in relation to FIG. 1A and FIG. 1B. In addition, or as an alternative, the recorded data may also be utilized to realize other advanced product features, as described in the following in relation to FIG. 10A and FIG. 10B.

The carrying out of the advanced product features described herein may be provided without any external trigger. One or more internal triggers may be configured to cause the LIDAR module to take certain actions “on its own” (e.g., the processor(s) of the LIDAR module to execute code associated with the respective advanced product features). As an example, an internal trigger may include the internal clock or the execution of a subroutine with a “checkpoint”, e.g. every time a temperature sensor is read or the laser diode current is adjusted, a condition related to the respective advanced product feature may be checked (e.g., weather a measurement values exceeds a threshold level, with threshold level dependent on the previous usage of the LIDAR module).

The aging of components and sub-systems may lead to overall system performance degradation. In some aspects, a Constant Product Performance may be implemented, to mask the performance degradation over time. The one or more processors of a LIDAR module (e.g., the one or more processors 102 of the LIDAR module 100) may be configured to adjust one or more operational parameters of a component of the LIDAR module as a function of the aging data. Illustratively, the control circuit of the product may be configured to modify one or more internal parameters to ideally completely offset the otherwise exhibited performance degradation. In various aspects, the one or more processors may be configured to adjust the one or more operational parameters of a component of the LIDAR module in accordance with an estimated remaining lifetime of the component, as described in further detail below.

Two approaches to realize a Constant Product Performance feature may be provided.

The first approach may include measuring the aging of the component and sub-systems during operation and, in this closed-loop control approach, regulating internal parameters to keep the measured values of interest constant. For example, the LIDAR module may include a beam splitter and an additional photo diode to measure the amount of light generated by the laser diode and over time increase the laser diode current in order to keep the generated light constant.

The first approach may provide the advantage that neither historic data on how the product has been used, nor on how this use may influence aging, is required to determine how much compensation (using the internal parameters) is to be provided for offsetting the aging. Illustratively, the aging may be directly or indirectly measured and compensated using a closed-loop approach.

A drawback may be that the aging of components, e.g. the beam splitter or the photo diode in this example, may create new errors that may lead to unintended and confusing effects. In addition, the first approach comes with additional cost compared to the second approach outlined in the following.

The second approach may be understood as a feed-forward approach. The changes to be provided to the internal parameters may be determined by using three core elements.
(1) The (e.g., continuously/quasi-continuously ongoing) recording of exposed storage/operating conditions (or some other kind of historic data);
(2) Aging models of the components and sub-systems; and
(3) Relationships describing how this component aging influences the overall product performance, e.g. the performance function Q described below.
   The three core elements may include information stored in non-volatile memory (in different areas of potentially different volatile memories) of the control circuit inside the LIDAR module (e.g., in the memory devices 108).

As an example for a LIDAR system, the performance factor Q may include the range (illustratively, the maximum distance in which the system can detect an object). It is understood that there may be a plurality of performance factors Q for a system to be considered. In various aspects, the performance factors may be prioritized in order for the control unit to converge to a set of new internal parameters, e.g. in case internal parameters influence multiple performance factors. Illustratively, one or more performance factors Q may be considered for a given constant product performance, e.g. for the “Constant Range Feature”. In a LIDAR module, among others, the (maximum) range, may be influenced by the laser diode current (or in case of LIDAR system with adaptive range feature, the maximum laser diode current).

In order to keep product performance constant over time (at least for some time), the system may be configured in such a way, that for a new product there may be some headroom for the laser current. Illustratively, a brand new product may be configured to operate only at a reduced output level (even under worst conditions not yet leading to a derating), e.g. at 80% of the nominal laser diode current. The nominal current was used not only when selecting the specific model of the laser diode but also to design the laser diode driver electronics and the heatsinking of the laser diode.

As the module ages, the laser diode current I_{LD} may be gradually increased to compensate for the drop in the following quantities:
(a) Light output of the laser diode L_{LD} (I_{LD}, H), where H is (for simplification of this description) a vector (or matrix) holding all historic information of the LIDAR module (e.g., all buckets providing information about the prior operation, usage, storage, etc. of the product).
(b) Sensitivity S(H) of photo diode (PiN diode or APD) where S may including the aging of additional components of the receiver sub-system (like the DC power supply providing the bias voltage for the photo diode).
(c) Transmissivity of optical components, e.g. described by transmissivity factors A₁(H), . . . , Aₖ(H) of the respective k optical component.

The performance function Q may be defined as:

Q(I_{LD},H)=L_{LD}(I_{LD},H)*S(H)*Πⱼ₌₁^{k}(Aⱼ(H))^{a(j)} (6)

where the function a(j) is either 1 if the optical component j is only in the optical receive or the optical transmit path or a(j) is 2 in case the component is in both the receive and transmit path.

On a regular basis, e.g. in 10 hours interval, the control circuit may be configured to evaluate the performance function Q(I_{LD},H). In case a minimum performance Qₘᵢₙ is no longer achieved,

Q(I_{LD},H)<Qₘᵢₙ,

then the (maximum) laser diode current may be increased by a small amount i_{LD},

I_{LD,new}=I_{LD}+i_{LD}.

Illustratively, the one or more processors of the LIDAR module may be configured to adjust one or more operational parameters of the component based on a target performance for the component (e.g., based on the minimum performance).

Instead of increasing the current by a constant amount (e.g., 0.1% of the initial current), the new laser diode current may, additionally or alternatively, be calculated from the current value by multiplication with a constant factor, e.g. by multiplying with 1.001.

Right after the increase, the control circuit may be configured to test for sufficient product performance again and potentially increase the laser diode current multiple times. The repeated checking may however introduce artifacts, and cause a negative overall user experience or even avoidance of running into safety-critical conditions.

The functions L_{LD}(I_{LD},H), S(H), A₁(H), . . . , Aₖ(H) describe the average aging of the respective components (assessed using a large ensemble of LIDAR modules). The respective functions are not the, e.g., 3% percentiles as used for other “smart product features” as mentioned above.

In various aspects, the above-mentioned functions describing aging behaviors (and located in non-volatile memory of the control circuit) may be updateable through one of the communication interfaces of the LIDAR module. This may allow updating the aging functions for LIDAR modules already in the field, thereby utilizing the latest R&D and supplier insights in improving products already shipped.

As an example, these functions may be (at least partially) defined by (multi-dimensional) look-up-tables. Each lookup-table may be updated in the non-volatile memory without altering any other memory content (neither code nor any other stored data).

In various aspects, the functions L_{LD}(I_{LD},H), S(H), A₁(H), . . . , Aₖ(H) used to evaluate the current performance function may be not based on all historic data H, but just on the historic data Hₙ of the last operation interval n and their last values, e.g. S_n. In case of the sensitivity, as an example, the new sensitivity value may then be calculated as Sₙ₊₁=Sₙ−D_{S}(Hₙ), where D_{S} provides the amount of degradation during the last interval (e.g., the last 10 hours, as a numerical example). The current performance may be determined as follows,

$${Q}_{n + 1} ( {I}_{LD} , {H}_{n} ) = {L}_{LD , n + 1} * {S}_{n + 1} * {\prod }_{j = 1}^{k} {( {A}_{j , n + 1} )}^{a ( j )} \\ with \\ {L}_{LD , n + 1} = {L}_{LD , n} - {D}_{LD} ( {H}_{n} ) , \\ {S}_{n + 1} = {S}_{n} - {D}_{S} ( {H}_{n} ) , \\ {A}_{j , n + 1} = {A}_{j , n} - {D}_{Aj} ( {H}_{n} ) .$$

This approach may be less computational intensive and may require less memory for storing historic data. However, it may not be possible to upgrade degradation models (as proposed in the paragraph above).

So far it was assumed that a constant product performance was the most desired outcome. In various aspects, the set value of the product performance Qₘᵢₙ may not be a constant, but a function of (operation) time, realizing an intended product performance variation over time. For example, the set value may exhibit such a dependency,

$${Q}_{min} ( t ) = \{ \begin{matrix}{Q}_{o} , for t \leq {t}_{EW} \\ {Q}_{o} - b * ( t - {t}_{EW} ) , for {t}_{EW} < t \leq {t}_{EL} \\ {Q}_{o} - b * ( {t}_{EL} - {t}_{EW} ) , otherwise .\end{matrix}$$

where Qₒ may be the product performance at an initial time point (e.g., zero hours), b may be a constant factor with which the performance decreases over time after the operating time exceeds a predefined time period, e.g. the extended warranty period t_{EW}. The performance decline may stop when surpassing another predefined time point, e.g. the engineered lifetime t_{EL} (illustratively, the engineered life may be the designed product life) of the product.

The product performance at zero hours Qₒ may be “hard coded” in the program code, or automatically calculated by the control circuit of the LIDAR module. In the latter case the control circuit at the first power-up—or after the “burn in” in the factory, e.g. after 1 h, may calculate Qₒ, e.g. using equation (6) above. As an example, the calculation of Qₒ may be implemented in a function as part of the code. The function may calculates Qₒ (in case of a time-dependent Qₘᵢₙ according to the above scheme) or in the more general case the function may calculate the new (time-independent or time-dependent) Qₘᵢₙ. The automatic calculation and updating of Qₒ or Qₘᵢₙ through the respective function may be called at “zero” hours and every time any of the functions on the right-hand side in the equation (1) above are updated (e.g., including updating any data, such as changing a lookup-table that any of the functions on the right-hand side in equation (1) may access).

The automatic calculation of Qₒ provides various advantages, also from an R&D efficiency point of view (as Qₒ is not calculated “by hand”, nor is a (manual) update of Qₒ or a (manual) triggering of an revision process of the code to be provided) and from a product quality point of view (as omitting of the calculation and “hard coding” reduces the risk of error, e.g. human error). In order to ensure the automatic the calling, updating of the formulas/functions being part of formula (6) and/or their underlying data may be encapsulated by an API, and the API may automatically also call the respective update function to update Qₒ or Qₘᵢₙ right after performing the requested update and before acknowledging that the update has been performed.

In various aspects, in addition to being a function of operation time, Qₘᵢₙ may be a function of the historic data H. For example, the product may reduce its product performance in case it is operated out of specification. The “abuse” of the product may thereby result is a highly accelerated performance deterioration, which may have an “educational effect” on the user, and the product performance set value in such cases may slowly over time recover to the normal value and/or may be re-settable via one of the communication interfaces.

In the above example only a single internal variable, the laser diode current, has been considered (or available) as a measure of action to compensate component aging and achieving constant product performance, e.g. the constant range. In case of multiple internal variables (e.g., bias voltage of the photo detector in addition to the laser diode current) multiple performance criteria (e.g., constant range and constant light output, as examples) may be defined. Constant range may be preferable considering the module's primary goal of ranging, whereas constant light output may be preferable in order to keep the secondary goal of an advanced module, which may include communication to other vehicles, infrastructure, etc. via light, constant. By adjusting the laser diode current constant light output may be provided, and by adjusting the bias voltage aging of the receive path may be offset, and thereby keeping the ranging performance constant. In case there are more variables than performance criteria, constant performance (satisfying all performance criteria) may be achieved while minimizing product aging, e.g. minimizing the aging of the most critical components in such a way that the overall product life is being maximized under the assumption of continued product use as in the past. To solve this multi-dimensional optimization problem, known approaches may be provided, e.g. the method of Lagrange multipliers, Monte Carlo method, or even combination of both (which may provide a highly efficient method when trying to determine the global maximum with a high probability at relatively low computational cost).

In various aspects, smart derating functionalities may be provided, as described in FIG. 10A and FIG. 10B.

Derating functionalities may be typically used to protect components, systems, products, etc. from damage or extreme wear during operation under harsh operating conditions. Harsh operating conditions may include very low or very high temperatures, very low or very high input voltages, etc. In these harsh operating conditions, the product may be configured to automatically “throttle” itself. For example, in case of a traction system, the motor may not run at full speed and may not provide full torque even though it would under normal operating conditions.

The “Smart Derating” described herein may include derating functionalities where the amount of “throttling” (for a component of a LIDAR module, e.g. for one of the components 104) may be dependent on
(a) the remaining life (and/or the estimated aging) of the respective component, and/or
(b) the remaining life of the respective sub-system, and/or
(c) the remaining life of the entire product.

The amount of “throttling” may be assessed based on historic (lifetime/usage) data stored in the product. Illustratively, the one or more processors of the LIDAR module may be configured to determine an amount of throttling for an operation of a component of the LIDAR module. The one or more processors may be configured to determine the amount of throttling as a function of the aging data associated with that component.

The goal of the proposed Smart Derating is to provide best user satisfaction while still ensuring that the product does not fail within its warranty period. The Smart Derating may also provide that the product lasts at least until its extended warranty period, e.g. until the operating hours covered by the extended warranty period have been reached. Depending on the application, market environment, business models, business strategies, etc. there may be an additional change or additional changes in the “throttling behavior” if the actual product life exceeds the extended warranty period, the designed product life, or other predefined ages or aging conditions.

For reasons of improved forensics, at least two additional buckets may be provided for every derating functionality. A derating functionality may be understood as a “throttling condition”, e.g. high laser diode temperature. A group of components, e.g. an array of laser diodes, may be impacted by multiple throttling conditions. An example may be the power supply, which may be impacted by three throttling conditions: high input voltage, low input voltage, and high temperature. As stated, for each of the throttling conditions two additional buckets may be provided (e.g., two additional sub-portions in the one or more memory portions associated with a component).

The first bucket may be provided for counting the operating time in which the product was operated while derating was present due to this condition (e.g., high input voltage). The second bucket may be provided for counting the operating time in which the product was operated while derating was present and where due to Smart Derating less throttling was happening than without Smart Derating. Illustratively, the second bucket may be provided to keep track of accelerated aging of the respective component(s) due to the Smart Derating feature.

In case multiple throttling conditions for the same component or sub-system are met, then the most severe throttling may overwrite all the other (less conservative) throttling results, based on the other conditions. In case of Smart Derating the throttling may be less severe, but the concept remains unchanged.

The first time a derating functionality is activated (and a throttling happens due to a condition not met before) the LIDAR module may be configured to inform the superior (vehicle) control system about being operated under this new extreme condition (e.g., without necessarily requesting any action) by sending a respective message to the (vehicle) control system.

A second message (corresponding to a particular derating functionality) may be sent when for the first time the respective Smart Derating function gets activated. The throttling may be stronger than it would be for a brand new product under the same harsh operating condition, e.g. due to the remaining component life having fallen below a certain threshold level.

Illustratively, the one or more processors of the LIDAR module may be configured to determine the amount of throttling in accordance with an estimated remaining lifetime of the component and/or in accordance with an estimated remaining lifetime of the LIDAR module. As an example, the one or more processors may be configured to increase the amount of throttling for decreasing estimated remaining lifetime of the component

FIG. 10A and FIG. 10B each shows a respective graph 1000a, 1000b illustrating a smart derating functionality according to various aspects.

The graphs 1000a, 1000b may refer, as an exemplary scenario, to the case of a laser diode in a LIDAR module where the “throttling” is only impacting the maximum laser diode current. In case the commanded laser diode current is less than the maximum laser diode current (e.g., in case of a LIDAR system adapting the amplitude of the laser pulses may often be the case in a respective application) no “throttling” is happening even though the temperature of the laser diode may be quite high.

In the illustrated graph 1000a, the maximum current Iₘₐₓ (along the vertical axis 1004) may be dependent on the laser diode's temperature T (along the horizontal axis 1002).

As the laser diode temperature increases, the maximum laser diode current initially remain constant at the level 1006, I_{M}, until the derating temperature 1010, T_{DrH}, is reached. Then the maximum laser diode current may be linearly reduced as the temperature further increases, until the shutdown temperature 1012, T_{Sa}, is reached. For any temperature above the shutdown temperature no laser pulses are generated. As shown in the graph 1000a, the derating threshold temperature may vary between a low derating temperature 1014, T_{DrL}, and a high derating temperature 1010, T_{DrH}, and the shutdown temperature may vary between a low shutdown temperature 1012, T_{SdL}, and a high shutdown temperature 1016, T_{SdH}. The one extreme of the temperature-dependent derating is denoted as 1018 (illustratively, a line describing the derating), I_{maxL}(T), and the other extreme is denoted as 1020, I_{maxH}(T). As in case of any Smart Derating, the actual throttling between the two extremes may depend on the remaining life and/or the estimated aging. As an example, the throttling may include dependency of the remaining life of the respective component.

An example of a product with the outlined Smart Derating functionality as described herein is shown FIG. 10B (with time along the horizontal axis 1042, and lifetime along the vertical axis 1044). For sake of a simplified illustration it is assumed that in this exemplary (possibly unrealistic) case the laser diode is always at temperature T_{Ex}, e.g. the temperature at which the product is. From FIG. 10A it may be seen that for a laser diode temperature 1022, T_{Ex}, the maximum current may vary between a first level 1024 and a second level 1026, I_{Ex1} and I_{Ex2}. As shown in FIG. 10B the Smart Derating may initially lead to minimal “throttling” and the maximum diode current may be equal to the first level 1024, I_{Ex1}. Illustratively, for the product being quite new a high maximum current is allowed despite derating present at all times, as the component being at quite a high temperature T_{Ex}.

Due to the high maximum current, the component may age quite considerably, and the estimated remaining life t_{R}, initially starting out with a value of the engineering life 1028, T_{EL} (in other words, the designed product life), may be decreasing quite quickly. At time 1030, t_{Th}, the remaining life t_{R} may reach the threshold 1032, T_{Th}. This time-dependent threshold may ensure that a product (despite Smart Derating being active) may still reach a substantial lifetime. The event of the estimated remaining life t_{R} hitting the threshold T_{Th} may trigger the maximum current to get slowly reduced from the first level I_{Ex1} to the second level I_{Ex2} over a time duration of t_{D}. During this time period to the Smart Derating may vanish and the more stringent “conventional” derating takes over,

Iₘₐₓ(t)=I_{Ex1}−(I_{Ex1}−I_{Ex2})/t_{D}*(t−t_{Th}), for t_{Th}≤t≤t_{Th}+t_{D}.

The change happening slowly over the time period tp may ensure that no unexpected artifacts of the product will suddenly be witnessed in the application, which otherwise may lead to even unsafe situations caused by the product.

As shown in FIG. 10B, under the assumed condition of this constant and quite high temperature equaling T_{Ex}, and after reaching time 1030, t_{Th} the estimated remaining life t_{R}(t) may remain below the linearly decreasing threshold t_{Th}(t) at all times, and the Smart Derating never gets reactivated (which would lead to a fading from the conventional derating to the Smart Derating in another time period t_{D}) and the operation may remain throttled according to the conventional derating.

As time goes on, the product life may surpass the warranty time 1034, t_{W}, and later may surpass the extended warranty time 1036, t_{EW}. Beyond the extended warranty time, in some aspects, the parameters for the conventional derating (and their implications shown in FIG. 10B, as the product in the respective example may continue to operate with conventional derating present as mentioned earlier) as well as for the Smart Derating may slowly change over time period t_{D2}. As mentioned before numerous design options are conceivable depending on business model, etc. In some aspects, case B in FIG. 10B, the product will (e.g., in case only the considered component would determine product life) live even longer than in the case described above in which a dependency of the remaining lifetime of the respective component was considered (case A in FIG. 10B). In other aspects (case C in FIG. 10B), the estimated remaining life may decline with the same rate as it did with Smart Derating present in the beginning (here the parameters of the conventional derating may morph into the parameters initially used for the Smart Derating), and in case D in FIG. 10B the decline may be even steeper than in the very beginning.

In summary, the present description is related to various aspects that may be implemented in a LIDAR module (e.g., in the LIDAR module 100). The aspects described herein may provide various advantages, for example,
(A) A reduction of the total cost of ownership (TCO) may be provided.

A reduction of the initial cost for the product may be provided, since the product may not be overdesigned. A down-time may be reduced, as in case of the remaining life is less than the further-next (scheduled regular) service, then the product (or system/component/sub-system) may be replaced by a new one, before it failed. Ideally any maintenance may be provided during scheduled service times, so there should not be any unscheduled service necessary anymore. In addition, a total service cost may be reduced, as there may be less service, in particular unscheduled service, as the maintenance may be provided during the scheduled service.
(B) Constant customer satisfaction may be provided.

As a first aspect, the product may be configured such that it does not break unexpectedly. In addition, the user/service point/garage/dealer may be informed (by the product itself) how long the product will last and hence when to schedule the next maintenance, provided the usage intensity and circumstances are known (or assumed to not significantly differ from prior usage). Furthermore, the customer may enjoy and rely on constant product performance, e.g. constant range feature.
(C) Product usage insights may be provided

In case the collected data during product life “somehow” finds its way back to the manufacturer, then highly valuable insights from a data analytics point of view may be drawn for the manufacturer, including guidance for strategic product portfolio planning and R&D activities. The latter may include product development coping with the task of designing new products or designing product upgrades and/or cost-cut versions of the current product. There may be multiple ways on how the usage data may find its way back to the manufacturer. As an example, the product may be a connected product and constantly provide data (e.g., the monitoring data) back to the manufacturer. As another example, on a regular basis (e.g., at every service) the memory may be read out/the data provided to the service station via respective data communication and the data may be communicated back to the manufacturer. As another example, at the expected end of life, when the product is exchanged anyways, the memory may be read out and the data may end up at the manufacturer. The data read-out may be part of the product recycling process. As a further example, in case the product life ends prematurely, then customer service/customer complaint handling may include reading out the memory as described above, and the data may be examined even more closely in order to determine the root cause and in the end whether or not this case should be treated as a warranty case.

In case of automotive products the sharing the data (OEM to TIER 1 to LIDAR module manufacturer) is not really common. So even if the data could be read out in a more continuous way, the LIDAR module manufacturer may be certainly well advised to design its product in such a way that as much valuable life information is stored in the product allowing forensics in case the LIDAR module manufacturer gets confronted with “dead products” from the field, potentially accompanied by financial/legal threats like damage compensations from its customer (e.g., the TIER 1 or the OEM).

An advantage of this kind of data compared to data generated by R&D departments in respective lifetime tests or even simulations, may be that those products were used in the real world under real conditions, including “product abuse” and all relevant use cases including combination of potentially very different product use in unforeseen combinations over time, etc.
(D) New features may be enabled, such as Real-time Remaining-Life-Estimator, Product Monitoring, Smart Derating, Constant Range Feature, or more “constant general product performance” by adaptive control, e.g. constant range feature (similar to a constant lumen feature of LED lighting), “LIDAR Authentication” (e.g., using lifetime information to generate “truly” random numbers), and/or counterfeit product detection (e.g., using lifetime information for tracking whether multiple products with the same series number (or ID) are out in the field).

In the following, various aspects of this disclosure will be illustrated. The aspects may refer to the LIDAR module 100 described above.

Example 1 is a LIDAR module including: one or more processors configured to: determine an estimate of a remaining lifetime of the LIDAR module based on (stated in a different fashion, in accordance with, or as a function of) aging data representative of aging events associated with one or more components of the LIDAR module.

In example 2, the LIDAR module of example 1 may optionally further include that the one or more processors are further configured to provide a message indicative of the estimated remaining lifetime of the LIDAR module. In various aspects, the one or more processors may be further configured, additionally or alternatively, to provide a message indicative of the estimated remaining lifetime of the LIDAR module falling below a predefined threshold (e.g., 6 months, 1 month, or 1 week, as examples).

In example 3, the LIDAR module of example 1 or 2 may optionally further include that the remaining lifetime of the LIDAR module includes a remaining lifetime of the one or more components of the LIDAR module (e.g., of at least one component, or of a subset of components, or of each component), and that the message indicative of the estimated remaining lifetime of the LIDAR module includes an estimate of the remaining lifetime of at least one component of the one or more components.

In example 4, the LIDAR module of example 2 may optionally further include that the message includes a result or a dataset describing the remaining lifetime of the LIDAR module and/or of at least one component of the one or more components.

In example 5, the LIDAR module of any one of examples 1 to 4 may optionally further include that the one or more processors are configured to predict a failure of the LIDAR module based on the estimate of the remaining lifetime of the LIDAR module.

In example 6, the LIDAR module of example 5 may optionally further include that the failure of the LIDAR module includes a failure of at least one component of the one or more components.

In example 7, the LIDAR module of example 5 or 6 may optionally further include that the message includes an indication of the predicted failure of the LIDAR module.

In example 8, the LIDAR module of any one of examples 1 to 7 may optionally further include that at least one (e.g., each) component of the one or more components has one or more aging mechanisms associated therewith, and that the respective aging data associated with the at least one (e.g., each) component are representative of the aging events related to at least one (e.g., each) of the one or more aging mechanisms associated with that component.

In example 9, the LIDAR module of example 8 may optionally further include that the one or more processors are configured to estimate the remaining lifetime of the at least one component (e.g., of each component of the one or more components) based on the aging events related to at least one (e.g., each) of the one or more aging mechanisms associated with that component.

In example 10, the LIDAR module of example 8 or 9 may optionally further include that the one or more processors are configured to estimate the remaining lifetime of the at least one component (e.g., of each component of the one or more components) in accordance with a respective aging model for at least one (e.g., each) of the one or more aging mechanisms associated with that component.

In example 11, the LIDAR module of any one of examples 8 to 10 may optionally further include that the one or more processors are further configured to estimate a remaining lifetime of the at least one component (e.g., of each component of the one or more components, e.g. of each component of a subset of components) by estimating a respective partial remaining lifetime defined by each aging mechanism associated with that component, and selecting as remaining lifetime of the component the shortest partial remaining lifetime among the partial remaining lifetimes defined by the aging mechanisms associated with that component.

As an example the one or more processors may be further configured to estimate the remaining lifetime of the component based on a predefined lifetime of the component adjusted in accordance with the aging data associated with the component.

In example 12, the LIDAR module of example 11 may optionally further include that the one or more processors are configured to estimate the respective partial remaining lifetimes defined by each of the one or more aging mechanisms associated with that component based on the predefined lifetime of the component adjusted in accordance with the respective aging data related to the one or more aging mechanisms associated with that component.

In example 13, the LIDAR module of any one of examples 3 to 12 may optionally further include that the estimated remaining lifetime of a component of the one or more components includes at least one of: a first estimated remaining lifetime in case the component is operated under factory-defined operating conditions; a second estimated remaining lifetime in case the component is operated under user-defined operating conditions; and/or a third estimated remaining lifetime in case the component is operated under operating conditions as described by the aging data associated with the component.

In example 14, the LIDAR module of example 13 may optionally further include that the one or more processors are configured to estimate as remaining lifetime of the component the shortest remaining lifetime of the first remaining lifetime, the second remaining lifetime, and the third remaining lifetime.

In example 15, the LIDAR module of any one of examples 1 to 14 may optionally further include that the one or more processors are configured to predict a behavior of the remaining lifetime of a component as a function of an estimated remaining lifetime of the component and the aging data associated with the component.

In example 16, the LIDAR module of example 15 may optionally further include that the prediction includes extrapolating the behavior of the remaining lifetime as a function of a difference between the estimated remaining lifetime and an expected remaining lifetime, and that the expected remaining lifetime includes a remaining lifetime of the component in case the component had been operated under factory-defined operating conditions.

In example 17, the LIDAR module of any one of examples 1 to 16 may optionally further include that the one or more processors are configured to estimate the remaining lifetime of the LIDAR module by estimating for each component of a subset of the one or more components (in some aspects, for each component of the one or more components) a remaining lifetime of that component based on the aging data representative of aging events associated with that component, and selecting as remaining lifetime of the LIDAR module the remaining lifetime of the component having the shortest remaining lifetime among the components of the subset of the one or more components.

In example 18, the LIDAR module of any one of examples 2 to 17 may optionally further include that the LIDAR module includes one or more communication interfaces, and that the one or more processors are configured to transmit the message indicative of the estimated remaining lifetime of the LIDAR module and/or of the estimated remaining lifetime of a component of the one or more components via the one or more communication interfaces.

In example 19, the LIDAR module of example 18 may optionally further include that the one or more processors are configured to receive via the one or more communication interfaces a request for information on the remaining lifetime of the LIDAR module and/or of a component of the one or more components, and that the one or more processors are configured to transmit the estimated remaining lifetime of the LIDAR module and/or the estimated remaining lifetime of the component in response to the request.

In example 20, the LIDAR module of example 19 may optionally further include that the one or more processors are further configured to transmit, e.g. in response to the request, data representative of which component of the one or more components has the shortest estimated remaining lifetime.

In example 21, the LIDAR module of example 19 or 20 may optionally further include that the one or more processors are further configured to transmit, e.g. in response to the request, data representative of which aging mechanism associated with the component having the shortest estimated remaining lifetime defines the shortest partial remaining lifetime.

In example 22, the LIDAR module of any one of examples 18 to 21 may optionally further include that the one or more processors are further configured to receive, e.g. via the one or more communication interfaces, an update of one or more aging models associated with the aging mechanisms of the one or more components.

In example 23, the LIDAR module of any one of examples 18 to 22 may optionally further include that the one or more communication interfaces include at least one of a wired communication interface, a radio-based communication interface, and/or an optical communication interface.

In example 24, the LIDAR module of any one of examples 1 to 23 may optionally further include that the LIDAR module further includes a memory (e.g., one or more memory devices), and that each component of the one or more components has one or more memory portions associated therewith for storing the aging data associated with that component.

In example 25, the LIDAR module of example 24 may optionally further include that each memory portion associated with a component is related to a respective aging mechanism of the one or more aging mechanisms associated with that component.

In example 26, the LIDAR module of example 24 may optionally further include that at least one component has associated therewith a single memory portion, that the memory portion includes a plurality of sub-portions, each sub-portion being associated with a respective aging mechanism of the one or more aging mechanisms associated with the component, that each sub-portion includes a counter value, that the one or more processors are configured to receive an indication that an aging event associated with an aging mechanism of the component has occurred and to decrease the counter value of the respective sub-portion, and that the one or more processors are configured to estimate the remaining lifetime of the component based on the counter values of the sub-portions associated with the component.

In example 27, the LIDAR module of example 24 or 25 may optionally further include that each memory portion associated with a component includes a plurality of sub-portions, each sub-portion associated with a respective range of a value of a parameter associated with that component.

In example 28, the LIDAR module of example 27 may optionally further include that each sub-portion is associated with a respective threshold value for the parameter associated with the component.

In example 29, the LIDAR module of example 27 or 28 may optionally further include that a parameter associated with a component includes at least one of: a temperature of the component, a voltage provided at the component, a current provided at the component, an optical power passing through the component, and/or an acceleration experienced by the component.

In example 30, the LIDAR module of any one of examples 27 to 29 may optionally further include that the range of a value of a parameter associated with the component includes at least one of: a temperature range, a voltage range, a current range, an optical power range, and/or an acceleration range.

In example 31, the LIDAR module of any one of examples 27 to 30 may optionally further include that at least one sub-portion has a memory size in the range from 1 Byte to 8 Bytes.

In example 32, the LIDAR module of any one of examples 27 to 31 may optionally further include that at least one memory portion includes a first sub-portion having a first memory size and a second sub-portion having a second memory size, the first memory size being greater than the second memory size.

In example 33, the LIDAR module of example 32 may optionally further include that a probability of an aging event occurring at a parameter value in a first range associated with the first sub-portion is greater than a probability of an aging event occurring at a parameter value in a second range associated with the second sub-portion.

In example 34, the LIDAR module of any one of examples 27 to 33 may optionally further include that at least one memory portion includes a number of sub-portions in the range from 2 to 16, for example in the range from 4 to 8.

In example 35, the LIDAR module of example 24 or 25 may optionally further include that for at least one aging mechanism, at least one component has a plurality of memory portions associated therewith for storing the aging data associated with that aging mechanism.

In example 36, the LIDAR module of example 35 may optionally further include that a first memory portion of the plurality of memory portions is associated with a first range of a value of a first parameter associated with that component, and that a second memory portion of the plurality of memory portions is associated with a second range of a value of the first parameter associated with that component.

In example 37, the LIDAR module of any one of examples 24 to 36 may optionally further include that the one or more processors are further configured to receive an indication that an aging event associated with a component occurred, and are configured to record the aging event in a sub-portion associated with that component based on the parameter value at which the aging event occurred.

In example 38, the LIDAR module of any one of examples 24 to 37 may optionally further include that a sub-portion includes a counter value representing the number of aging events occurred at a parameter value falling in the range associated with the sub-portion.

In example 39, the LIDAR module of example 38 may optionally further include that the one or more processors are configured to modify (e.g., increase or decrease) the counter value of the sub-portion to record an aging event in the sub-portion.

In example 40, the LIDAR module of example 39 may optionally further include that the one or more processors are configured to, in case the one or more processors receive an indication that an aging event to be recorded in the sub-portion occurred, verify whether the counter value of the sub-portion has reached a threshold counter value, and record the aging event in the sub-portion in case the counter value has not reached the threshold counter value.

In example 41, the LIDAR module of example 40 may optionally further include that in case the counter value is equal to the threshold counter value, the one or more processors are configured not to modify the counter value of the sub-portion.

In example 42, the LIDAR module of example 40 or 41 may optionally further include that in case the counter value of the sub-portion is equal to the threshold counter value, the one or more processors are configured to record the aging event in another sub-portion, the other sub-portion being located in a second memory portion different from a first memory portion in which the sub-portion is located, the second memory portion being associated with the same component and the same aging mechanism as the first memory portion, the other sub-portion being associated with the same range of the value of the parameter as the sub-portion.

In example 43, the LIDAR module of example 42 may optionally further include that the second memory portion is located in a different memory area with respect to the first memory portion.

In example 44, the LIDAR module of example 42 may optionally further include that the second memory portion is located in a memory of a different type with respect to the first memory portion.

In example 45, the LIDAR module of example 44 may optionally further include that the first memory portion is located in a RAM memory, and the second memory portion is located in one of a EEPROM memory, a FLASH memory, or a hard-drive memory.

In example 46, the LIDAR module of any one of examples 22 to 45 may optionally further include that the one or more memory portions associated with a component form a first set of memory portions, and that the one or more processors are configured to assign a second set of one or more memory portions to the component (e.g., in response to a trigger event). Illustratively, the one or more memory portions associated with each component form a respective first set of memory portions, and the one or more processors may be configured to assign a second set of one or more memory portions to at least one (e.g., to each) component, e.g. in response to a trigger event.

In example 47, the LIDAR module of example 46 may optionally further include that the one or more processors are configured to assign a second set of one or more memory portions to the component in response to a trigger event, the trigger event including at least one of: a counter value of a sub-portion of the first set of memory portions reaching the threshold counter value; a predefined time point being reached; a predefined number of hours having elapsed since the assignment of a previous set of one or more memory portions; and/or the LIDAR module having operated for a predefined number of hours.

In various aspects, as soon as the new set of memory portions is created or assigned (e.g., as soon as the trigger event occurred), the data of the old set of memory portions may not be modified any more (and only the new journal will be used for any further recording).

In various aspects, the content of the old (first) set of memory portions may be copied to an archive.

In example 48, the LIDAR module of example 46 or 47 may optionally further include that the one or more processors are configured to record (e.g., to copy) the content of the first set of memory portions in a memory configured for a single write operation.

In example 49, the LIDAR module of example 48 may optionally further include that the memory includes one of a one time writable (OTP) memory, or a programmable read only memory (PROM).

In example 50, the LIDAR module of any one of examples 24 to 49 may optionally further include that each sub-portion has an adjustment factor associated therewith, the adjustment factor being dependent on the range associated with the sub-portion, and that the one or more processors are configured to estimate the remaining lifetime of a component based on the predefined lifetime of the component adjusted by using the counter value of each associated sub-portion weighted by the respective adjustment factor.

As an example, the remaining lifetime may be calculated as a difference between an expected overall lifetime of the component, and the summation of the counter values of the associated sub-portions weighted by the respective adjustment factor.

In example 51, the LIDAR module of example 50 may optionally further include that the memory of the LIDAR module stores a look-up table including the adjustment factors or the coefficients of the formulas to determine e adjustment factors of each sub-portion of the plurality of sub-portions associated with a component.

In example 52, the LIDAR module of any one of examples 1 to 51 may optionally further include that the aging data include global data related to aging events experienced by the LIDAR module, and individual data related to aging events experienced by the one or more components.

In example 53, the LIDAR module of example 52 may optionally further include that the aging events related to the global data are representative of at least one of: a number of power cycles of the LIDAR module; a number of operating hours of the LIDAR module; a temperature above or below a predefined temperature threshold of the LIDAR module; a predefined time has lapsed while the LIDAR module was at a temperature above or below a predefined temperature threshold; a period of time for which the temperature of the LIDAR module is above a predefined threshold temperature; a number of temperature cycles experienced by the LIDAR module; an acceleration above a predefined threshold experienced by the LIDAR module.

In example 54, the LIDAR module of any one of examples 1 to 53 may optionally further include that the LIDAR module includes a temperature sensor configured to detect a temperature of the LIDAR module.

In example 55, the LIDAR module of example 54 may optionally further include that the temperature sensor is attached to a housing of the LIDAR module.

In example 56, the LIDAR module of example 54 or 55 may optionally further include that the temperature sensor includes a thermistor or a diode.

In example 57, the LIDAR module of any one of examples 1 to 56 may optionally further include that the one or more processors are configured to determine a temperature of a component of the one or more components by using the temperature of the LIDAR module.

In example 58, the LIDAR module of example 52 may optionally further include that individual data related to aging events experienced by the one or more components represent at least one of: a time during which at least one component is operating; a temperature of at least one component during operation; a temperature of at least one component during storage; an input voltage provided to at least one component for operation; an input current provided to at least one component for operation; an optical power or an optical power density passing through at least one component; an acceleration experienced by at least one component during operation; and/or an acceleration experienced by at least one component during storage.

In example 59, the LIDAR module of any one of examples 52 to 58 may optionally further include that the one or more components of the LIDAR module include a light emission device, the light emission device including a light source and a driver circuit configured to drive the light source, and individual data related to aging events experienced by the light emission device represent at least one of: a time during which the light emission device is operating; a temperature of the light source; a number of emitted light pulses; a peak power of an emitted light pulse; a temperature of the driver circuit; a peak power of a driving signal provided by the driver circuit; and/or a number of driving signals provided by the driver circuit.

In example 60, the LIDAR module of example 59 may optionally further include that the light source includes a plurality of emitter pixels, and that the individual data related to aging events experienced by the light emission device represent at least one of: an individual temperature of at least one emitter pixel; a number of light pulses emitted by at least one emitter pixel; a peak power of a light pulse emitted by at least one emitter pixel.

In example 61, the LIDAR module of example 60 may optionally further include that the plurality of emitter pixels are or include a plurality of laser diodes.

In example 62, the LIDAR module of any one of examples 59 to 61 may optionally further include that the number of light pulses emitted by the light source are subsampled by using at least one of: a periodic non-synchronous timer; a periodic synchronous timer with continuously varying offset; a periodic synchronous timer with random time delay; a low accuracy clock; and/or a periodic synchronous timer with continuously varying offset.

In example 63, the LIDAR module of any one of examples 52 to 62 may optionally further include that the one or more components of the LIDAR module include a light detection device, the light detection device including a detector circuit, and individual data related to aging events experienced by the light detection device represent at least one of: a time during which the light detection device is operating; a temperature of the detector circuit; an amount of received light; a power of received light; and/or a bias voltage provided at the detector circuit.

In example 64, the LIDAR module of example 63 may optionally further include that the detector circuit includes a plurality of detector pixels, and that the individual data related to aging events experienced by the light detection device represent at least one of: an individual temperature of at least one detector pixel; a number of light pulses received by at least one detector pixel; a peak power of a light pulse received by at least one detector pixel.

In example 65, the LIDAR module of any one of examples 52 to 64 may optionally further include that the one or more components of the LIDAR module include one or more optical components, and that the individual data related to aging events experienced by the one or more optical components represent at least one of: a time during which the one or more optical components are operating; a temperature of at least one optical component; a zoom status of at least one optical component; a number of light pulses passing through at least one optical component; a number of scanning operations performed with at least one optical component; an acceleration experienced by at least one optical component; a mechanical stress experienced by at least one optical component and/or an optical power or an irradiation passing through at least one optical component.

In example 66, the LIDAR module of example 65 may optionally further include that the one or more optical components include a MEMS mirror, and that the individual data related to aging events experienced by the one or more optical components describe a number of scanning operations performed with the MEMS mirror.

In example 67, the LIDAR module of example 65 or 66 may optionally further include that the one or more optical components include a Liquid Crystal Polarization Grating, and that the individual data related to aging events experienced by the one or more optical components represent at least one of: an optical power of sunlight received at the Liquid Crystal Polarization Grating; a temperature of the liquid crystals of the Liquid Crystal Polarization Grating; and/or a number of switching cycles of the liquid crystals of the Liquid Crystal Polarization Grating.

In example 68, the LIDAR module of any one of examples 52 to 67 may optionally further include that the one or more components include a power supply circuit, and that the individual data related to aging events experienced by the power supply circuit represent at least one of: a time during which the power supply circuit is operating; a temperature of the power supply circuit; a number of power cycles of the power supply circuit; an input voltage or an input current of the power supply circuit; an output voltage or an output current of the power supply circuit; temperature cycles experienced by the power supply circuit; and/or an acceleration experienced by the power supply circuit.

In example 69, the LIDAR module of any one of examples 52 to 68 may optionally further include that the one or more components include a control circuit, and that the individual data related to aging events experienced by the control circuit represent at least one of: a time during which the control circuit is operating; a temperature of the control circuit; temperature cycles experienced by the control circuit; and/or an acceleration experienced by the control circuit.

In example 70, the LIDAR module of any one of examples 1 to 69 may optionally further include that the LIDAR module includes one or more sensors (also referred to herein as monitoring sensors) configured to sense one or more parameters associated with the one or more components.

In example 71, the LIDAR module of example 70 may optionally further include that the one or more sensors include at least one of: a timer, a light sensor, a temperature sensor, a voltage sensor, and/or an acceleration sensor.

In example 72, the LIDAR module of example 70 or 71 may optionally further include that the one or more sensors are configured to transmit sensor data to the one or more processors at periodic time intervals, and that the periodic time intervals are defined by a clock of the LIDAR module.

In example 73, the LIDAR module of example 72 may optionally further include that the clock is configured to operate independently of whether the LIDAR module is operating.

In example 74, the LIDAR module of example 72 or 73 may optionally further include that the clock is or includes a real time clock. For example, the real time clock may include a crystal clock and an energy source, e.g. a battery.

In example 75, the LIDAR module of any one of examples 70 to 74 may optionally further include that the one or more processors are further configured to receive sensor data from the one or more sensors, the sensor data being representative of at least one parameter associated with at least one component of the one or more components, and that the one or more processors are configured to determine a parameter value for that parameter based on an average of the received sensor data.

In example 76, the LIDAR module of example 75 may optionally further include that the one or more processors are configured to receive via the one or more communication interfaces a request for sensor data and to provide via the one or more communication interfaces the sensor data related to a parameter of at least one component in response to the request.

In example 77, the LIDAR module of any one of examples 1 to 76 may optionally further include that the LIDAR module is a solid state LIDAR module.

In example 78, the LIDAR module of any one of examples 1 to 77 may optionally further include that a memory of the LIDAR module stores data associated with each firmware version of the LIDAR module.

In example 79, the LIDAR module of example 78 may optionally further include that the data associated with a firmware version include the aging events occurred during the time in which that firmware version was running in the LIDAR module.

In example 80, the LIDAR module of any one of examples 1 to 79 may optionally further include that the one or more processors are configured to adjust one or more operational parameters of a component of the one or more components as a function of the aging data.

In example 81, the LIDAR module of example 80 may optionally further include that the one or more processors are further configured to adjust one or more operational parameters of a component of the one or more components as a function of an estimated remaining lifetime of the component.

In example 82, the LIDAR module of example 80 or 81 may optionally further include that the one or more processors are configured to adjust one or more operational parameters of the component based on a target performance for the component.

In example 83, the LIDAR module of any one of examples 1 to 82 may optionally further include that the one or more processors are configured to determine an amount of throttling for an operation of an component of the one or more components, and that the one or more processors are configured to determine the amount of throttling in accordance with the aging data associated with that component.

In example 84, the LIDAR module of example 83 may optionally further include that the one or more processors are configured to determine the amount of throttling as a function of an estimated remaining lifetime of the component and/or as a function of an estimated remaining lifetime of the LIDAR module.

In example 85, the LIDAR module of example 84 may optionally further include that the one or more processors are configured to increase the amount of throttling for decreasing estimated remaining lifetime of the component.

Example 86 is a method of estimating a remaining lifetime of a LIDAR module, the method including: estimating a remaining lifetime of the LIDAR module based on aging data representative of aging events associated with one or more components of the LIDAR module.

In example 87, the method of example 86 may optionally further include one, or some, or all the features of any one of examples 1 to 85, where appropriate.

Example 88 is a LIDAR module including a memory storing data representative of the occurrences of an event associated with an aging mechanism of a component of the LIDAR module.

In example 89, the LIDAR module of example 88 may optionally further include one, or some, or all the features of any one of examples 1 to 85, where appropriate.

Example 90 is a LIDAR module including: one or more processors configured to: receive an indication that an aging event associated with an component of the LIDAR module has occurred, the aging event being related to a first aging mechanism of one or more aging mechanisms associated with the component; update (e.g., increase or decrease) a counter value associated with the first aging mechanism; and estimate a remaining lifetime of the component based on the counter values associated with the one or more aging mechanisms associated with the component.

In example 91, the LIDAR module of example 90 may optionally further include one, or some, or all the features of any one of examples 1 to 85, where appropriate.

While various implementations have been particularly shown and described with reference to specific aspects, it should be understood by those skilled in the art that various changes in form and detail may be made therein without departing from the spirit and scope as defined by the appended claims. The scope is thus indicated by the appended claims and all changes which come within the meaning and range of equivalency of the claims are therefore intended to be embraced.

### LIST OF REFERENCE SIGNS

100 LIDAR module
102 One or more processors
104 One or more components
106 Control circuit
108 One or more memory devices
110 One or more communication interfaces
112 Message
114 Communication bus
116 Power distribution
118 Power supply
120 Clock
122 Emitted/received light
124 Light emission device
126 Light source
128 Light detection device
130 Detector circuit
132 One or more optical components
134 Emitted light
136 Received light
202 Coarse steering module
204 Fine steering module
206 Field of view
210 Liquid Crystal Polarization Grating
212 Glass substrate(s)
214 Electrode(s)
216 Liquid crystal layer
218-1 First direction
218-2 Second direction
218-3 Third direction
220 Voltage source
222 Alignment layer(s)
300 Memory portion
302 Memory sub-portions
302-1 First sub-portion
302-2 Second sub-portion
302-3 Third sub-portion
310 Memory portion
310-1 First memory portion
310-2 Second memory portion
310-3 Third memory portion
310-N N-th memory portion
310a First memory portion
310b Second memory portion
310c Third memory portion
310d Fourth memory portion
310e Fifth memory portion
310f Sixth memory portion
310g Memory portion
312 Memory sub-portions
312-1 First sub-portion
312-2 Second sub-portion
312-3 Third sub-portion
312-4 Fourth sub-portion
312-5 Fifth sub-portion
312-6 Sixth sub-portion
312-7 Seventh sub-portion
312-8 Eighth sub-portion
312-9 Ninth sub-portion
312-10 Tenth sub-portion
312-11 Eleventh sub-portion
312-12 Twelfth sub-portion
312-13 Thirteenth sub-portion
312-14 Fourteenth sub-portion
312-15 Fifteenth sub-portion
312-16 Sixteenth sub-portion
314 Memory address
320c Graph
320d Graph
322c Horizontal axis
322d Horizontal axis
324c Vertical axis
324d Vertical axis
326c Intervals
326d Intervals
328 Interval size
328-1 First interval size
328-2 Second interval size
328-3 Third interval size
410a First memory portion
410b Second memory portion
410c Third memory portion
410d Fourth memory portion
410e Fifth memory portion
410f Sixth memory portion
410g Seventh memory portion
410h Eighth memory portion
410i Ninth memory portion
410j Tenth memory portion
410k Eleventh memory portion
4101 Twelfth memory portion
412 Memory sub-portions
412-1 First sub-portion
412-2 Second sub-portion
412-3 Third sub-portion
412-4 Fourth sub-portion
412-5 Fifth sub-portion
412-6 Sixth sub-portion
412-7 Seventh sub-portion
412-8 Eighth sub-portion
412-9 Ninth sub-portion
412-10 Tenth sub-portion
412-11 Eleventh sub-portion
412-12 Twelfth sub-portion
412-13 Thirteenth sub-portion
412-14 Fourteenth sub-portion
412-15 Fifteenth sub-portion
412-16 Sixteenth sub-portion
412a Sub-portion
412b Other sub-portion
414 Memory address
500 Memory block
502a First journal
502b Second journal
502c Third journal
504 Memory address
510 Memory of a first type
512 Memory block
512-1 Memory block
512-2 Memory block
520 Memory of a second type
522 Memory block
524 Memory block
526 Memory block
550 Memory of a first type
552 Memory block
560 Memory of a second type
562 Memory block
570 Memory of a third type
572 Memory block
574 Memory block
600 Memory portion
602 Memory sub-portion(s)
604 Memory address
606-1 First column
606-2 Second column
606-3 Third column
606-4 Fourth column
710a First memory portion
710b Second memory portion
710c Third memory portion
710d Fourth memory portion
710e Fifth memory portion
710f Sixth memory portion
712 Memory sub-portions
712-1 First sub-portion
712-2 Second sub-portion
712-3 Third sub-portion
712-4 Fourth sub-portion
712-5 Fifth sub-portion
712-6 Sixth sub-portion
712-7 Seventh sub-portion
712-8 Eighth sub-portion
712-9 Ninth sub-portion
712-10 Tenth sub-portion
712-11 Eleventh sub-portion
712-12 Twelfth sub-portion
712-13 Thirteenth sub-portion
712-14 Fourteenth sub-portion
712-15 Fifteenth sub-portion
712-16 Sixteenth sub-portion
712a First level sub-portion
714 Memory address
720 Look-up table
722-1 First value
722-2 Second value
722-3 Third value
722-4 Fourth value
722-5 Fifth value
722-6 Sixth value
722-7 Seventh value
722-8 Eighth value
722-9 Ninth value
722-10 Tenth value
722-11 Eleventh value
722-12 Twelfth value
722-13 Thirteenth value
722-14 Fourteenth value
722-15 Fifteenth value
722-16 Sixteenth value
722a Value
724 Memory address
730a First memory portion
730b Second memory portion
730c Third memory portion
730d Fourth memory portion
732 Memory sub-portions
732-1 First sub-portion
732-2 Second sub-portion
732-3 Third sub-portion
732-4 Fourth sub-portion
732-5 Fifth sub-portion
732-6 Sixth sub-portion
732-7 Seventh sub-portion
732-8 Eighth sub-portion
732-9 Ninth sub-portion
732-10 Tenth sub-portion
732-11 Eleventh sub-portion
732-12 Twelfth sub-portion
732-13 Thirteenth sub-portion
732-14 Fourteenth sub-portion
732-15 Fifteenth sub-portion
732-16 Sixteenth sub-portion
732a Second level sub-portion
734 Memory address
802-1 First laser diode
802-2 Second laser diode
802-3 Third laser diode
802-4 Fourth laser diode
802-5 Fifth laser diode
802-6 Sixth laser diode
802-7 Seventh laser diode
802-8 Eighth laser diode
804-1 First event
804-2 Second event
806-1 First pixel
808-1 First image
808-N N-th image
820 Pixel duration
822 Image repetition duration
824 Timer period
900a Graph
900b Graph
900c Graph
900d Graph
902 Horizontal axis
904 Vertical axis
906 Starting value
908 End value
910 Remaining lifetime
912 Horizontal axis
914 Vertical axis
916 Predefined value
932 Horizontal axis
934 Vertical axis
936 Time point
938 Threshold value
940 Time point
1000a Graph
1000b Graph
1002 Horizontal axis
1004 Vertical axis
1006 Level
1010 High derating temperature
1012 Low shutdown temperature
1014 Low derating temperature
1016 High shutdown temperature
1018 Temperature-dependent derating
1020 Temperature-dependent derating
1022 Laser diode temperature
1024 First level
1026 Second level
1028 Engineered life
1030 Time point
1032 Threshold value
1034 Time point
1036 Time point
1042 Horizontal axis
1044 Vertical axis

What is claimed is:

1. A LIDAR module comprising:
a plurality of components; and
one or more processors configured to:
determine an estimate of a remaining lifetime of the LIDAR module as a function of individual aging data representative of individual aging events for each component of the plurality of components of the LIDAR module.

2. The LIDAR module according to claim 1,
wherein the one or more processors are further configured to provide a message indicative of the estimated remaining lifetime of the LIDAR module and/or a message indicative of the estimated remaining lifetime of the LIDAR module-falling below a predefined threshold.

3. The LIDAR module-according to claim 2,
wherein the remaining lifetime of the LIDAR module comprises a remaining lifetime of the plurality of components of the LIDAR module, and wherein the message indicative of the estimated remaining lifetime of the LIDAR module comprises an estimate of the remaining lifetime of at least one component of the plurality of components.

4. The LIDAR module according to claim 1,
wherein at least one component of the one or more components has one or more aging mechanisms associated therewith, and
wherein the respective individual aging data associated for the at least one component are representative of the aging events related to at least one of the one or more aging mechanisms associated with that component.

5. The LIDAR module according to claim 4,
wherein the one or more processors are configured to estimate a remaining lifetime of the at least one component by estimating a respective partial remaining lifetime defined by each aging mechanism associated with that component, and selecting as remaining lifetime of the component the shortest partial remaining lifetime among the partial remaining lifetimes defined by the aging mechanisms associated with that component.

6. The LIDAR module according to claim 1,
wherein the estimated remaining lifetime of a component of the plurality of components comprises at least one of:
a first estimated remaining lifetime in case the component is operated under factory defined operating conditions;
a second estimated remaining lifetime in case the component is operated under user-defined operating conditions; and/or
a third estimated remaining lifetime in case the component is operated under operating conditions as described by the individual aging data associated with the component.

7. The LIDAR module according to claim 6,
wherein the one or more processors are configured to estimate as remaining lifetime of the component the shortest remaining lifetime of the first remaining lifetime, the second remaining lifetime, and the third remaining lifetime.

8. The LIDAR module according to claim 1,
wherein the one or more processors are configured to estimate the remaining lifetime of the LIDAR module by estimating for each component of a subset of the plurality of components a remaining lifetime of that component as a function of the individual aging data representative of individual aging events associated with that component, and selecting as remaining lifetime of the LIDAR module the remaining lifetime of the component having the shortest remaining lifetime among the components of the subset of components.

9. The LIDAR module according to claim 1,
wherein the LIDAR (100) module further comprises a memory, and
wherein each component of the plurality of components has one or more memory portions associated therewith for storing the aging data associated with that component.

10. The LIDAR module according to claim 9,
wherein each memory portion associated with a component is related to a respective aging mechanism of the one or more aging mechanisms associated with that component.

11. The LIDAR module according to claim 9,
wherein each memory portion associated with a component comprises a plurality of sub-portions, each sub-portion being associated with a respective range of a value of a parameter associated with that component.

12. The LIDAR module according to claim 10,
wherein at least one component has associated therewith a single memory portion,
wherein the memory portion comprises a plurality of sub-portions, each sub-portion being associated with a respective aging mechanism of the one or more aging mechanisms associated with the component,
wherein each sub-portion comprises a counter value,
wherein the one or more processors are configured to receive an indication that an aging event associated with an aging mechanism of the component has occurred and to decrease the counter value of the respective sub-portion, and
wherein the one or more processors are configured to estimate the remaining lifetime of the component as a function of the counter values of the sub-portions associated with the component.

13. The LIDAR module according to claim 10,
wherein for at least one aging mechanism, at least one component has a plurality of memory portions associated therewith for storing the aging data associated with that aging mechanism.

14. The LIDAR module according to claim 11,
wherein the one or more processors are further configured to receive an indication that an aging event associated with a component of the components occurred, and are configured to record the aging event in a sub-portion associated with that component as a function of the parameter value at which the aging event occurred.

15. The LIDAR module-according to claim 9,
wherein the one or more memory portions associated with a component form a first set of memory portions, and that the one or more processors are configured to assign a second set of one or more memory portions to the component in response to a trigger event.

16. The LIDAR module according to claim 11,
wherein each sub-portion is associated with a respective threshold value for the parameter associated with the component.

17. The LIDAR module according to claim 9,
wherein the one or more processors are further configured to receive an indication that an aging event associated with a component occurred, and are configured to record the aging event in a sub-portion associated with that component based on the parameter value at which the aging event occurred.

18. The LIDAR module according to claim 11,
wherein at least one memory portion includes a first sub-portion having a first memory size and a second sub-portion having a second memory size, the first memory size being greater than the second memory size.

19. The LIDAR module according to claim 18,
wherein a probability of an aging event occurring at a parameter value in a first range associated with the first sub-portion is greater than a probability of an aging event occurring at a parameter value in a second range associated with the second sub-portion.

20. The LIDAR module according to claim 11,
wherein a parameter associated with a component includes two or more of: a temperature of the component, a voltage provided at the component, a current provided at the component, an optical power passing through the component, and/or an acceleration experienced by the component.
